(19) United States
(12) Patent Application Publication
(10) Pub. No.: US 2019/0081479 A1
(43) Pub. Date: Mar. 14, 2019

(54) CONFIGURATION SYSTEMS AND METHODS FOR POWER CONTROL SYSTEMS

(71) Applicant: Outback Power Technologies, Inc., Arlington, WA (US)

(72) Inventors: Brian James Faley, Mount Vernon, WA (US); Paul Gregory Dailey, Snohomish, WA (US); Iftekhar Hasan, Richardson, TX (US)

(21) Appl. No.: 16/128,237

(22) Filed: Sep. 11, 2018

Related U.S. Application Data
(60) Provisional application No. 62/557,619, filed on Sep. 12, 2017.
(60) Provisional application No. 62/557,048, filed on Sep. 11, 2017.

(51) Int. Cl. H02J 3/14; G06F 3/0484; G06F 3/0481; G06F 1/3203

(52) U.S. Cl. CPC H02J 3/14; G06F 1/3203; G06F 3/04817; G06F 3/0484

(57) ABSTRACT

A power supply system to be operatively connected to a grid, a load, and at least one auxiliary power node. The power supply system comprising at least one power control system comprising a device controller, a power integration system operatively connected to the at least one auxiliary power node, a power management board, and a user interface device operatively connected to the device controller. The device controller is configured to run software that displays a user interface on the user interface device that allows entry of configuration data associated with at least one of the grid, the load, and the at least one auxiliary power node and access to status data associated with at least one of the grid, the load, and the at least on auxiliary power node. The device controller controls operation of the power integration system and power management board using the configuration data.

### RELATED APPLICATIONS

This application (Attorney's Ref. No. P219520) claims benefit of U.S. Provisional Patent Application Ser. No. 62/557,619 filed Sep. 12, 2017, currently pending.

This application (Attorney's Ref. No. P219520) also claims benefit of U.S. Provisional Patent Application Ser. No. 62/557,048 filed Sep. 11, 2017, currently pending.

The contents of the related applications listed above are incorporated herein by reference.

### TECHNICAL FIELD

The present invention relates to systems and methods for the integration of auxiliary energy production systems, and more particularly, to an auxiliary power integration system for integrating auxiliary power sources to a power grid and/or to a load.

### BACKGROUND

Wind-powered turbine and photovoltaic (PV) array auxiliary power generation technologies are available at the consumer level. Power supply systems employing auxiliary power generation systems may further include power storage systems, such as batteries, to store energy for when wind and solar power is not available. Auxiliary power generation and storage systems are often non-standardized. As such, consumers are left without a simple, cost effective means for integrating consumer owned and operated power generation systems, consumer owned and operated energy storage systems, and/or the utility power grid.

Accordingly, the need exists for power supply systems and methods that facilitate the integration of auxiliary power systems, such as renewable energy generation technologies and energy storage technologies, with the utility power grid to supply power to a load. More specifically, the need exists for configuring and auxiliary power integration system for integrating auxiliary power sources to a power grid and/or to a load.

### SUMMARY

The present invention may be embodied as a power supply system operatively connected to a grid, a load, and at least one auxiliary power node, the power supply system comprising at least one power control system. The at least one power control system comprises a device controller, a power integration system, a power management board, and a user interface device. The power integration system is operatively connected to the at least one auxiliary power node. The user interface device is operatively connected to the device controller. The device controller is configured to run software that displays a user interface on the user interface device that allows entry of configuration data associated with at least one of the grid, the load, and the at least one auxiliary power node and access to status data associated with at least one of the grid, the load, and the at least on auxiliary power node. The device controller controls operation of the power integration system and power management board using the configuration data.

The present invention may also be embodied as a method of operatively connecting a grid, a load, and at least one auxiliary power node, the method comprising the following steps. At least one power control system is provided, each power control system comprises a device controller, a power integration system, a power management board, and a user interface device. The power integration system is operatively connected to the at least one auxiliary power node. The user interface device is operatively connected to the device controller. The device controller is configured to run software that causes the user interface device to display a user interface that allows entry of configuration data associated with at least one of the grid, the load, and the at least one auxiliary power node and access to status data associated with at least one of the grid, the load, and the at least on auxiliary power node. The device controller is caused to control operation of the power integration system and power management board using the configuration data.

The present invention may be embodied as a power supply system operatively connected to a grid, a load, and at least one auxiliary power node, the power supply system comprising a plurality of power control systems. Each of the plurality of power control systems comprises a device controller, a power integration system, a power management board, and a user interface device. The power integration system is operatively connected to the at least one auxiliary power node. The user interface device operatively connected to the device controller. The device controllers are configured to run software that displays a user interface on the user interface device operatively connected thereto that allows entry of configuration data associated with at least one of the grid, the load, and the at least one auxiliary power node for each of the plurality of power control systems, identification of one of the power control systems as a master power control system, identification of at least one of the power control systems as a slave power control system, storage in the master power control system configuration data associated with the at least one slave power control system, and access to status data associated with at least one of the grid, the load, and the at least on auxiliary power node. The device controllers of the plurality of power control systems control operation of the power integration system and power management board using the configuration data.

### BRIEF DESCRIPTION OF THE DRAWINGS

FIG. 1 is a block diagram of an example power supply system comprising one or more power control systems configured to integrate one or more auxiliary power sources with the grid and a load;

FIG. 2 is a combination block/circuit diagram illustrating an example power control system that may be used by the example power supply system;

FIG. 3 is a block diagram of an example power integration system that may be used as part of the example power control system;

FIG. 4 is a block diagram of a page layout overview of an example user interface that may be used with the example device control system;

FIG. 5A illustrates an example user interface associated the at least one power control system forming a part of the example power supply, the example user interface being depicted in a first configuration in FIG. 5a;

FIG. 5B illustrates the example user interface in a second configuration;

FIG. 5C illustrates the example user interface in a third configuration;

FIG. 5D illustrates the example user interface in a fourth configuration;

FIG. 6A illustrates an example screenshot of an example solar system webpage;

FIG. 6B illustrates an example solar system configuration webpage;

FIG. 6C illustrates an example solar system status webpage;

FIG. 7A illustrates an example grid webpage;

FIG. 7B illustrates an example grid configuration webpage;

FIG. 7C illustrates an example grid status webpage;

FIG. 8A illustrates an example load webpage;

FIG. 8B illustrates an example load configuration webpage;

FIG. 8C illustrates and example load status webpage;

FIG. 9A illustrates an example battery system webpage;

FIG. 9B illustrates an example battery system configuration webpage;

FIG. 9C illustrates and example battery system status webpage;

FIG. 10A illustrates an example generator system webpage;

FIG. 10B illustrates an example generator system configuration webpage;

FIG. 10C illustrates and example generator system status webpage;

FIG. 11 is a screenshot of an example power control system home screen webpage in a first configuration;

FIG. 12 is a screenshot of an example power control system home screen webpage in a second configuration;

FIG. 13 is a screenshot of an example power control system home screen webpage in a third configuration;

FIG. 14 is a screenshot of an example power control system home screen webpage in a fourth configuration;

FIG. 15 is a screenshot of an example power control system home screen webpage in a fifth configuration;

FIG. 16 is a screenshot of an example login webpage in a first configuration;

FIG. 17 is a screenshot of an example login webpage in a second configuration;

FIG. 18 is a screenshot of an example solar status webpage;

FIG. 19 is a screenshot of an example system components setup webpage;

FIG. 20 is a screenshot of an example solar configuration webpage in a first configuration;

FIG. 21 is a screenshot of an example solar configuration webpage in a second configuration;

FIG. 22 is a screenshot of an example solar configuration webpage in a third configuration;

FIG. 23 is a screenshot of an example grid configuration webpage in a first configuration;

FIG. 24 is a screenshot of an example grid configuration webpage in a second configuration;

FIG. 25 is a screenshot of an example grid configuration webpage in a third configuration;

FIG. 26 is a screenshot of an example grid configuration webpage in a fourth configuration;

FIG. 27 is a screenshot of an example grid configuration webpage in a fifth configuration;

FIG. 28 is a screenshot of an example grid configuration webpage in a sixth configuration;

FIG. 29 is a screenshot of an example grid configuration webpage in a seventh configuration;

FIG. 30 is a screenshot of an example grid configuration webpage in an eighth configuration;

FIG. 31 is a screenshot of an example grid configuration webpage in a ninth configuration;

FIG. 32 is a screenshot of an example grid configuration webpage in a tenth configuration;

FIG. 33 is a screenshot of an example grid configuration webpage in an eleventh configuration;

FIG. 34 is a screenshot of an example load configuration webpage in a first configuration;

FIG. 35 is a screenshot of an example load configuration webpage in a second configuration;

FIG. 36 is a screenshot of an example load configuration webpage in a third configuration;

FIG. 37 is a screenshot of an example load configuration webpage in a fourth configuration;

FIG. 38 is a screenshot of an example load configuration webpage in a fifth configuration;

FIG. 39 is a screenshot of an example battery configuration webpage in a first configuration;

FIG. 40 is a screenshot of an example battery series selection webpage;

FIG. 41 is a screenshot of an example battery configuration webpage in a second configuration;

FIG. 42 is a screenshot of an example battery model selection webpage;

FIG. 43 is a screenshot of an example battery configuration webpage in a third configuration;

FIG. 44 is a screenshot of an example battery configuration webpage in a fourth configuration;

FIG. 45 is a screenshot of an example battery configuration webpage in a fifth configuration;

FIG. 46 is a screenshot of an example battery configuration webpage in a sixth configuration;

FIG. 47 is a screenshot of an example battery configuration webpage in a seventh configuration;

FIG. 48 is a screenshot of an example battery configuration webpage in an eighth configuration;

FIG. 49 is a screenshot of an example generator configuration webpage in a first configuration;

FIG. 50 is a screenshot of an example generator configuration webpage in a second configuration;

FIG. 51 is a screenshot of an example generator configuration webpage in a third configuration;

FIG. 52 is a screenshot of an example generator configuration webpage in a fourth configuration;

FIG. 53 is a screenshot of an example generator configuration webpage in a fifth configuration;

FIG. 54 is a screenshot of an example generator configuration webpage in a sixth configuration;

FIG. 55 is a screenshot of an example generator configuration webpage in a seventh configuration;

FIG. 56 is a screenshot of an example system notification webpage in a first configuration;

FIG. 57 is a screenshot of an example system notification webpage in a second configuration;

FIG. 58 is a screenshot of an example power control system information webpage in a first configuration;

FIG. 59 is a screenshot of an example power control system system information webpage in a second configuration;

FIG. 60 is a screenshot of an example power control system system information webpage in a third configuration;

FIG. 61 is a screenshot of an example power control system basic settings webpage;

FIG. 62 is a screenshot of an example power control system Setup—CT Type webpage;

FIG. 63 is a screenshot of an example solar photovoltaic production webpage;

FIG. 64 is a screenshot of an example solar I-V curve webpage;

FIG. 65 is a screenshot of an example solar production graph in a day mode of display webpage;

FIG. 66 is a screenshot of an example solar production graph in a week mode of display webpage;

FIG. 67 is a screenshot of an example solar production graph in a month mode of display webpage;

FIG. 68 is a screenshot of an example solar production graph in a year mode of display webpage;

FIG. 69 is a screenshot of an example solar more information page in a first configuration;

FIG. 70 is a screenshot of an example solar more information page in a second configuration;

FIG. 71 is a screenshot of an example solar module specifications webpage;

FIG. 72 is a screenshot of an example solar array design webpage;

FIG. 73 is a screenshot of an example grid buy/sell information webpage;

FIG. 74 is a screenshot of an example grid buy/sell graph in a day mode of display webpage;

FIG. 75 is a screenshot of an example grid buy/sell graph in a week mode of display webpage;

FIG. 76 is a screenshot of an example grid buy/sell graph in a month mode of display webpage;

FIG. 77 is a screenshot of an example grid buy/sell graph in a year mode of display webpage;

FIG. 78 is a screenshot of an example grid voltage variance information webpage;

FIG. 79 is a screenshot of an example grid more information webpage;

FIG. 80 is a screenshot of an example grid AC Input Settings webpage;

FIG. 81 is a screenshot of an example grid Time of Use webpage;

FIG. 82 is a screenshot of an example grid time of use schedule webpage;

FIG. 83 is a screenshot of an example grid protection: profile webpage;

FIG. 84 is a screenshot of an example grid protection webpage in a first configuration;

FIG. 85a is a screenshot of an example grid protection webpage in a second configuration;

FIG. 86a is a screenshot of an example grid protection webpage in a third configuration;

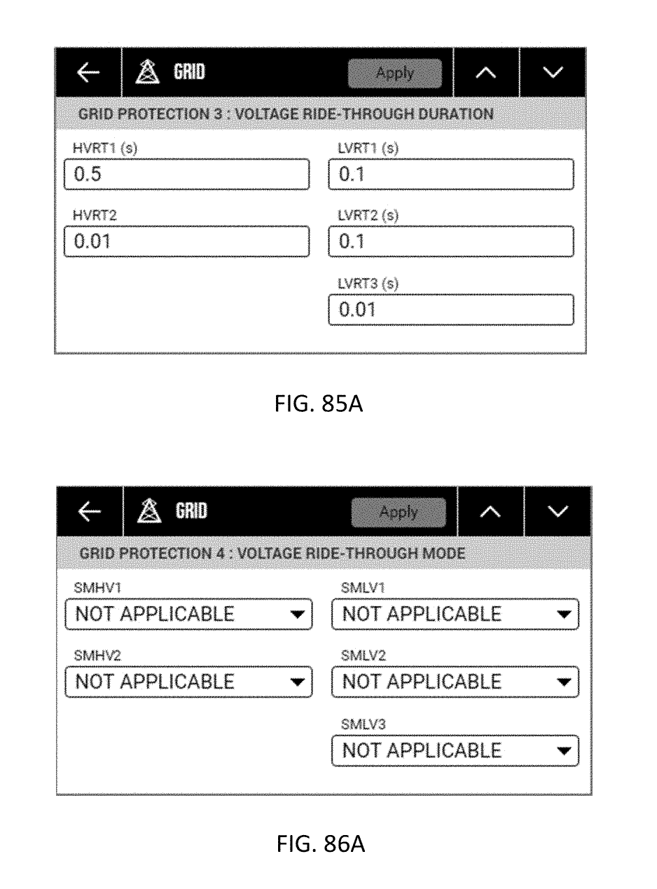

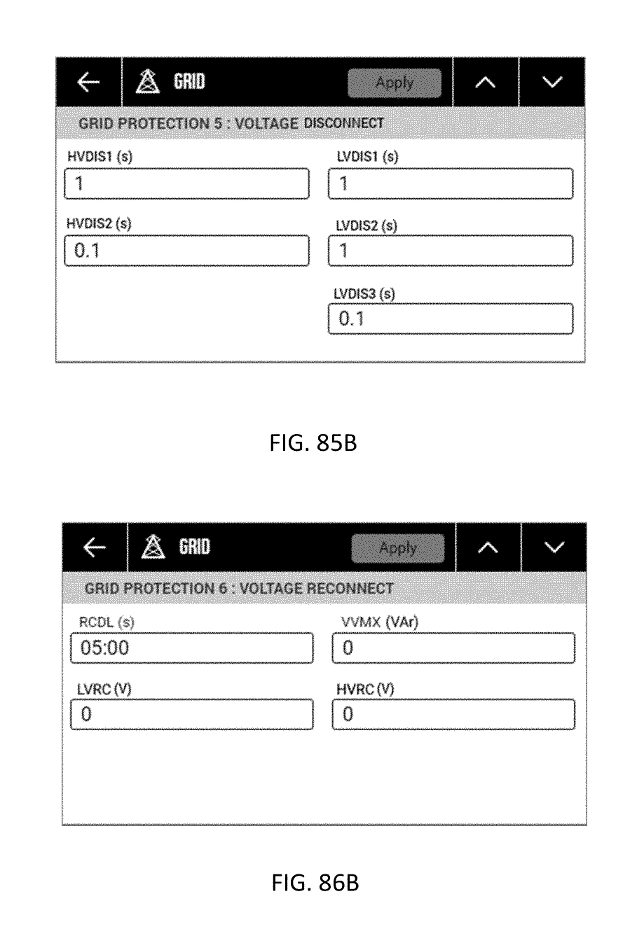

FIG. 85b is a screenshot of an example grid protection webpage in a fourth configuration;

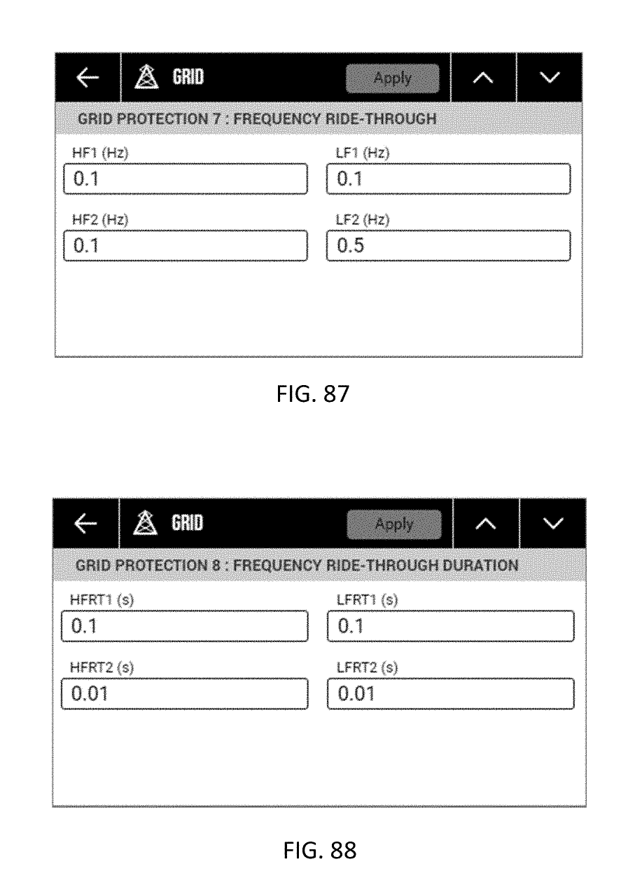

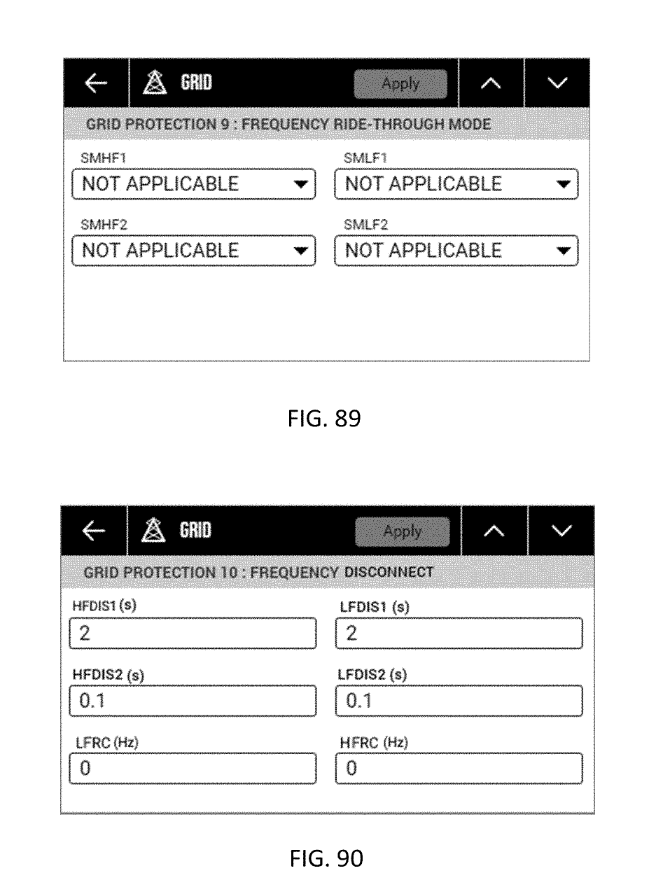

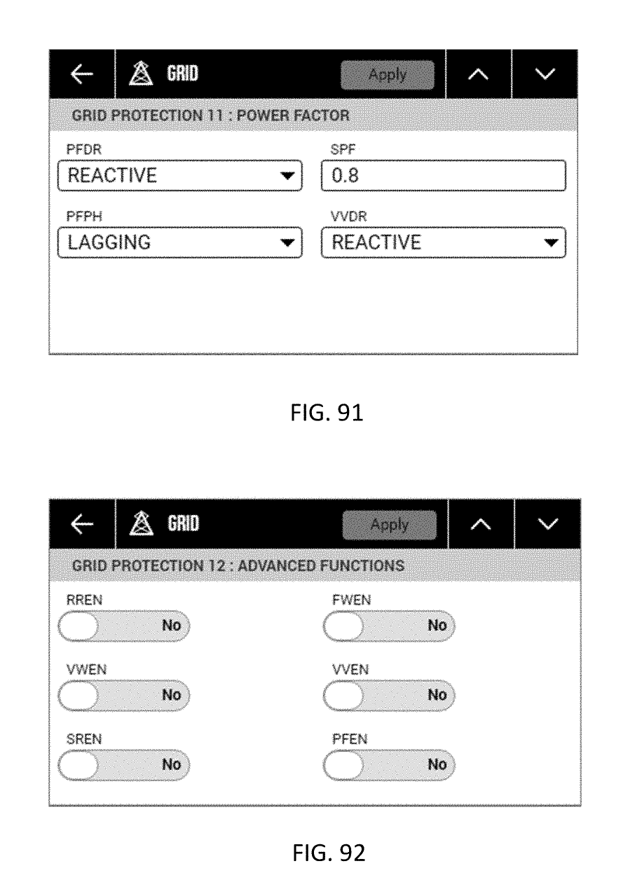

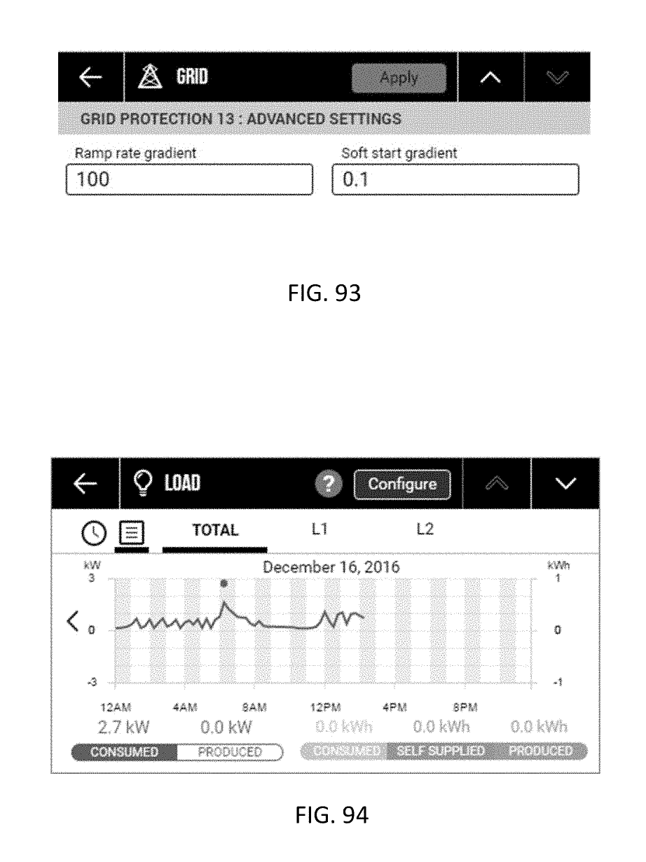

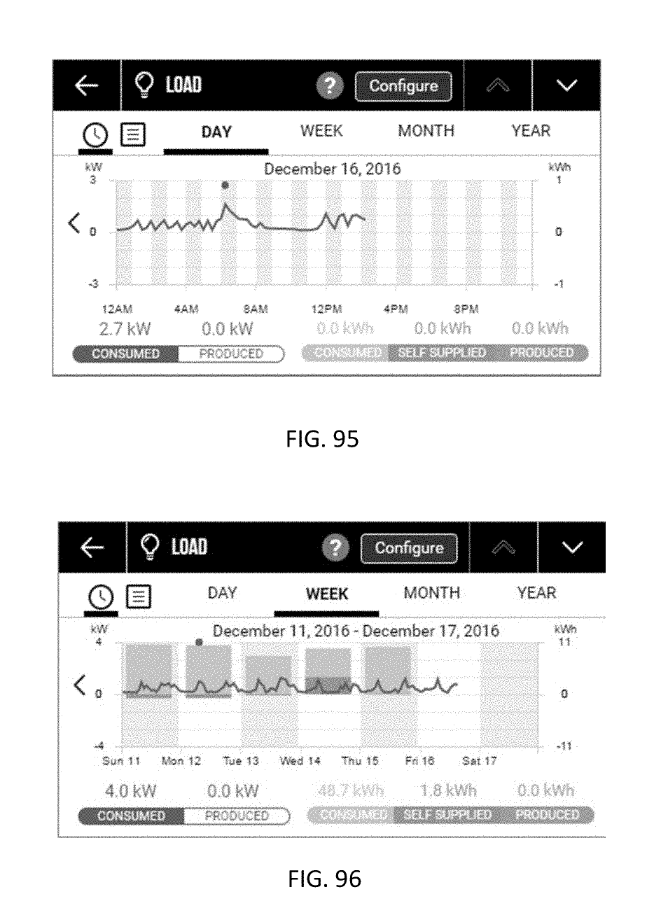

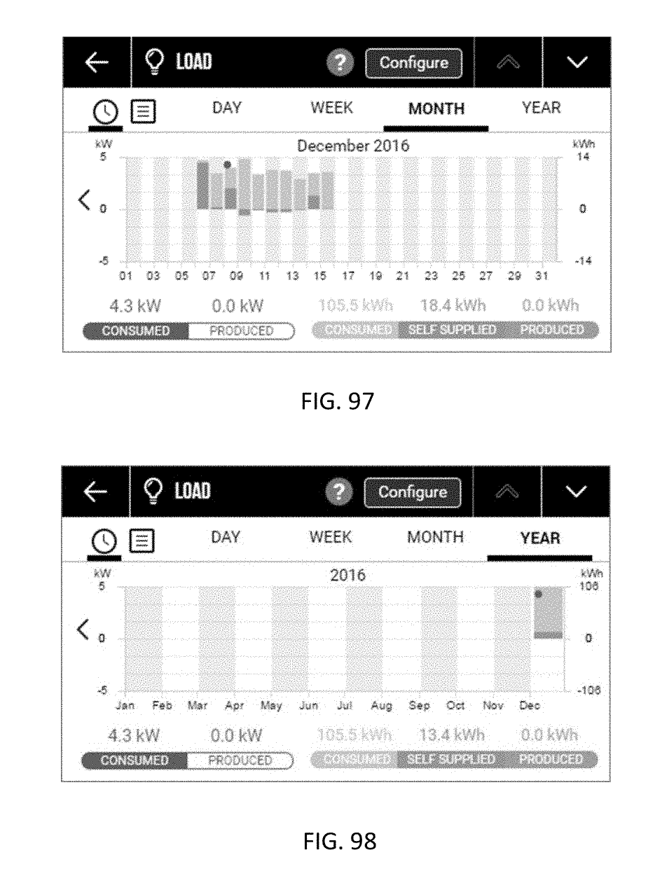

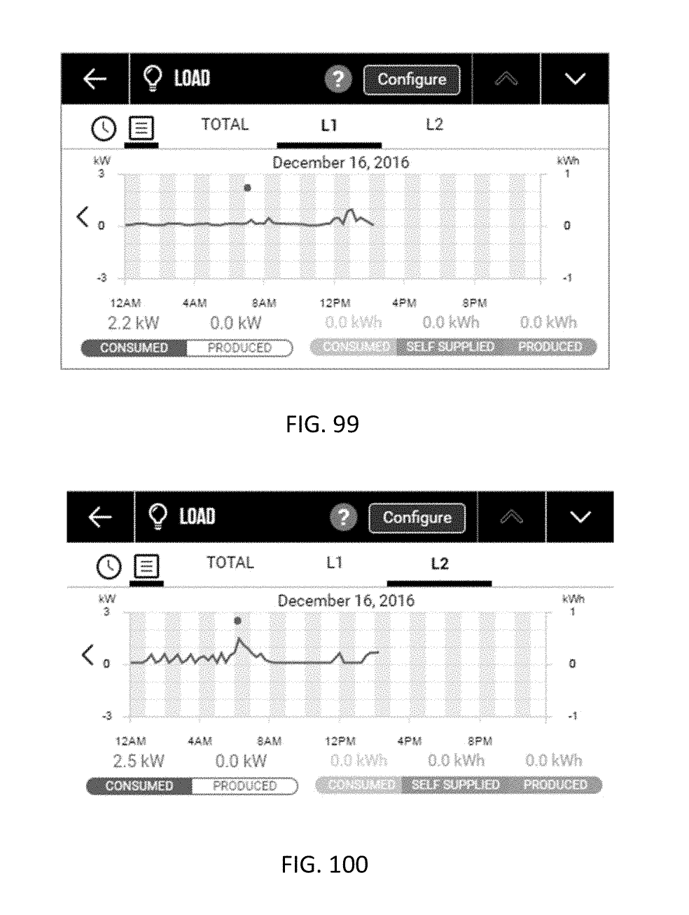

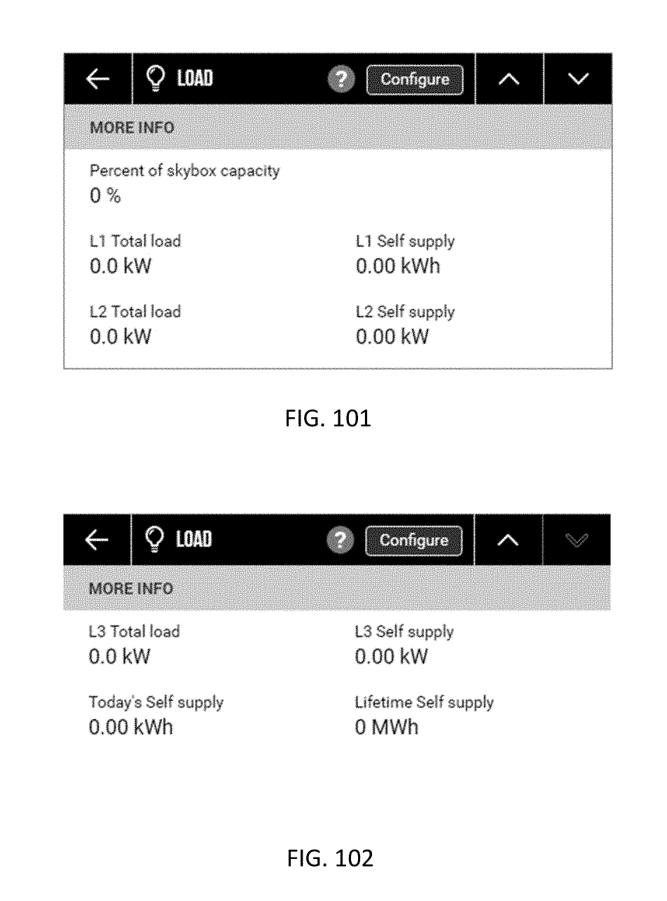

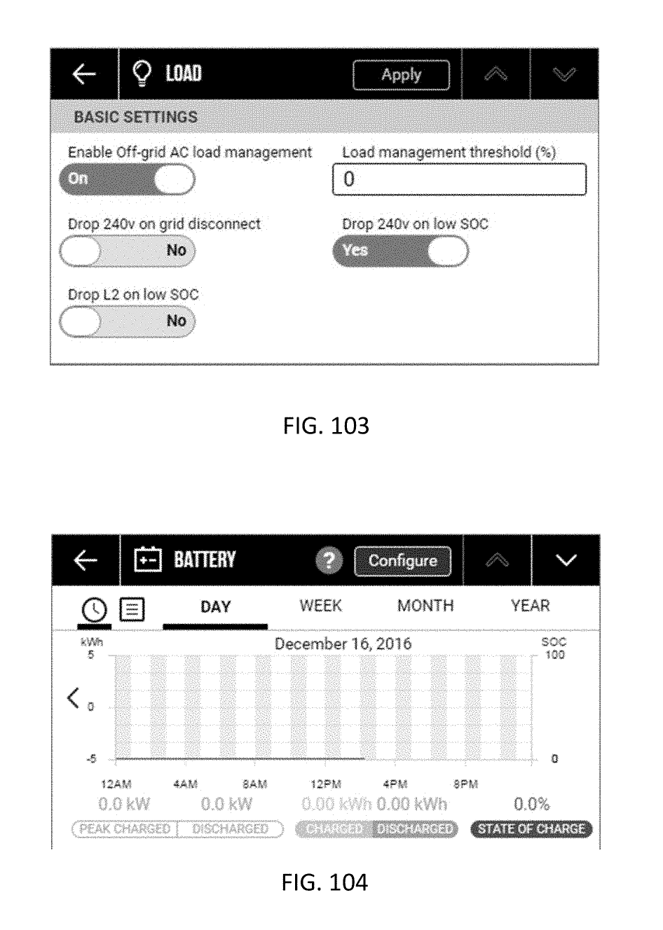

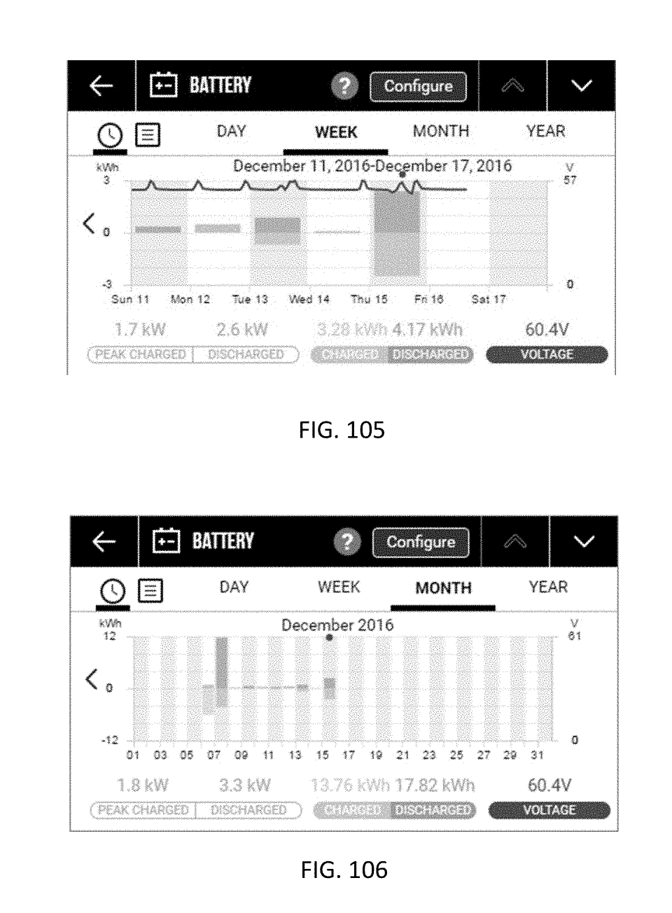

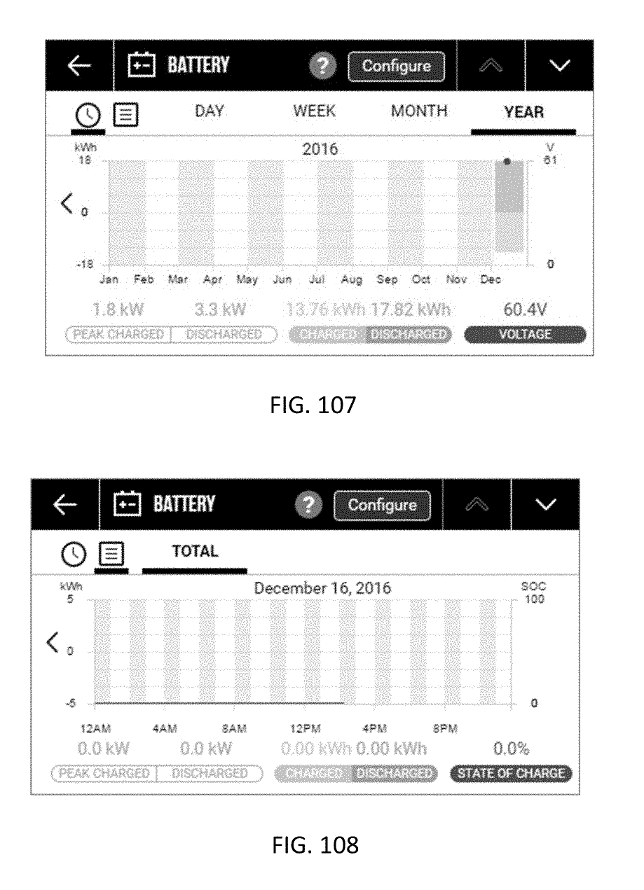

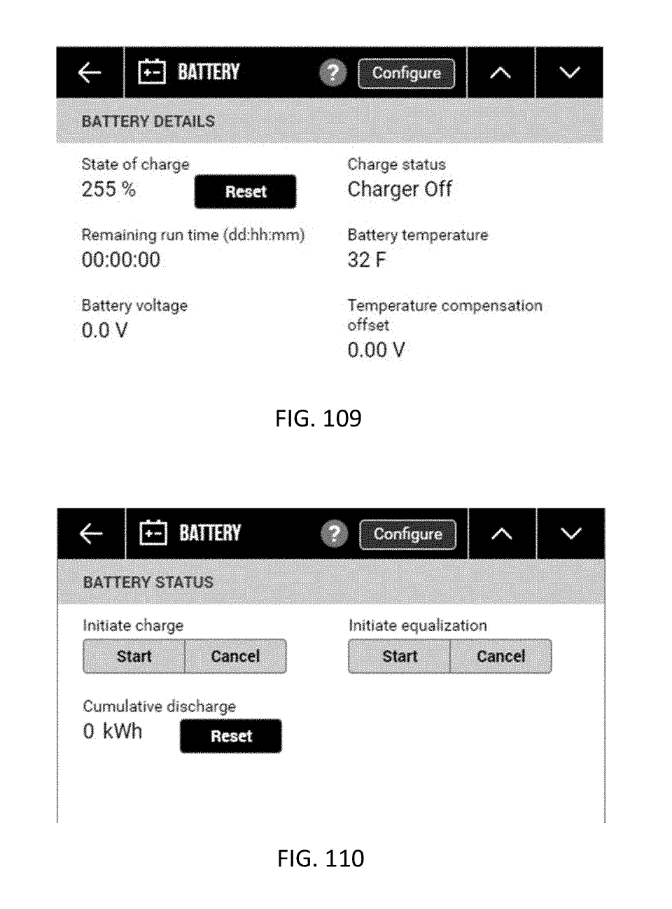

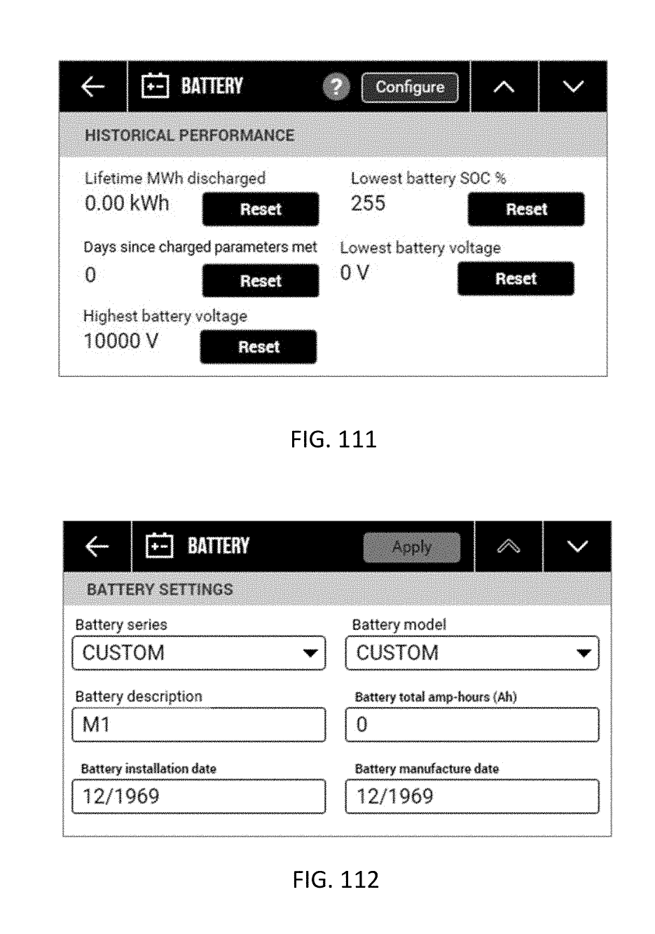

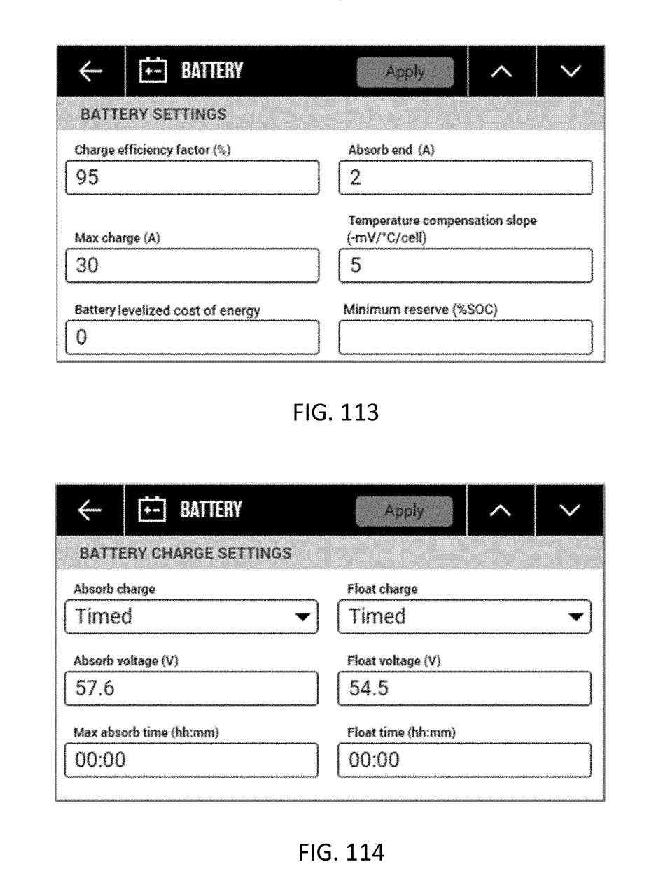

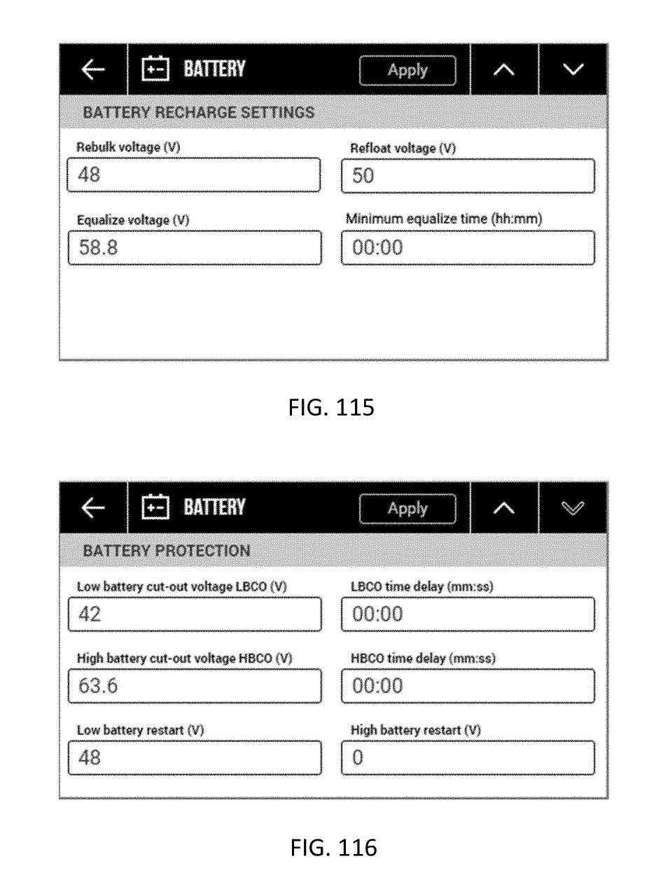

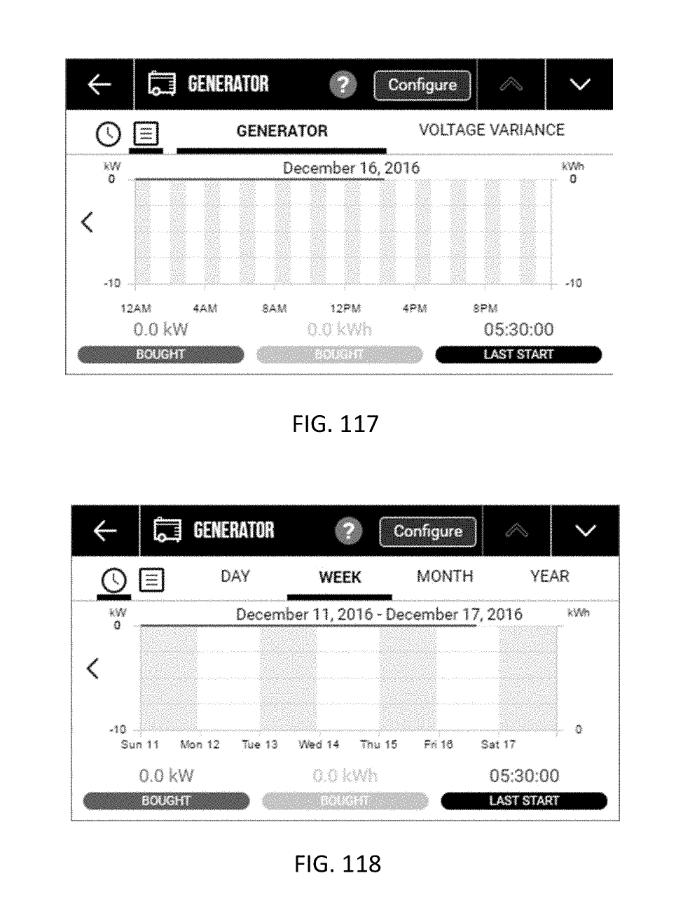

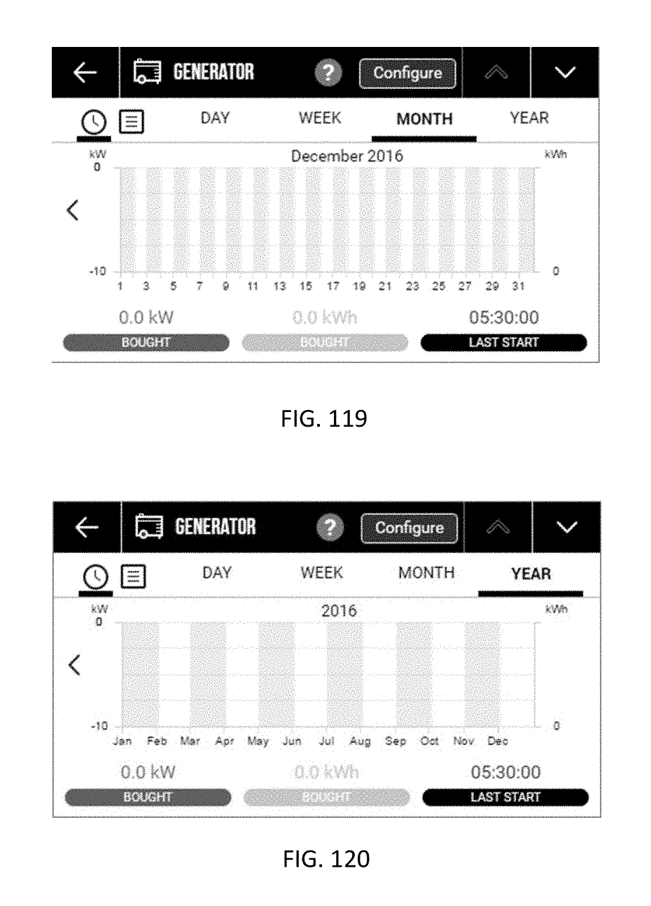

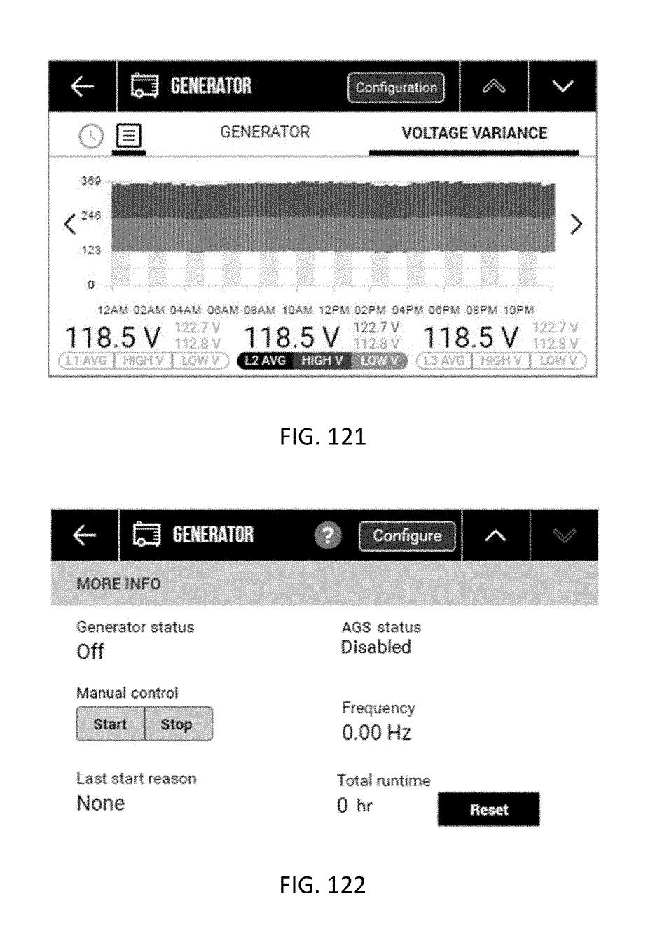

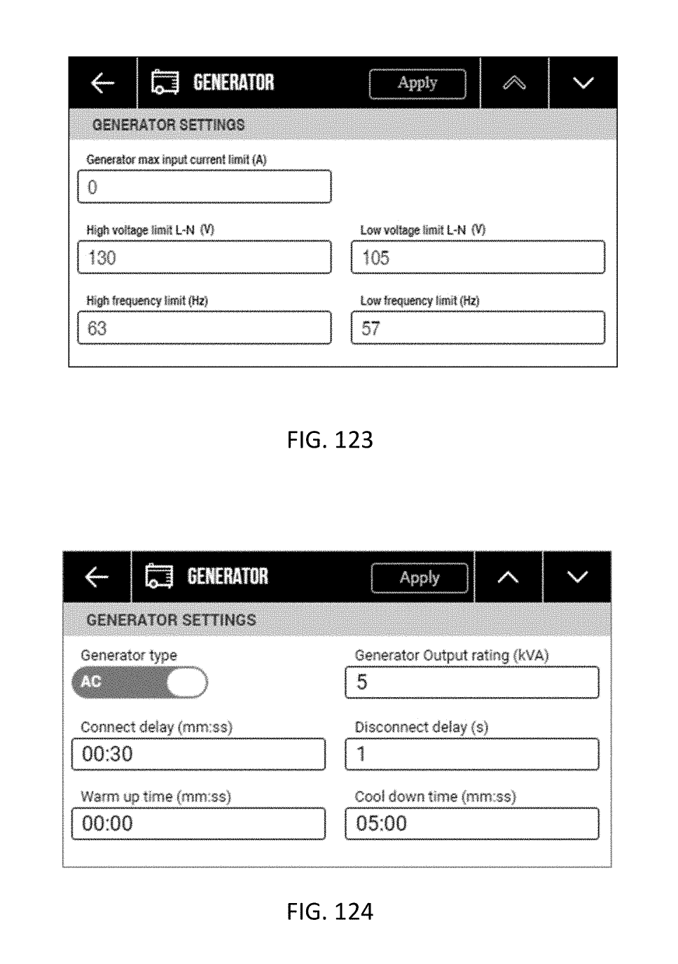

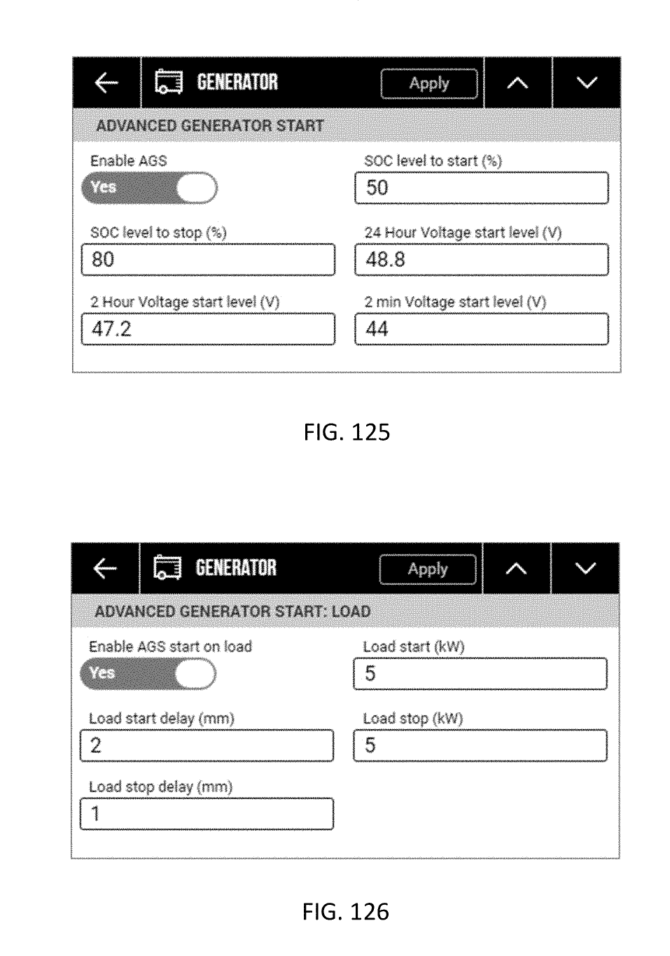

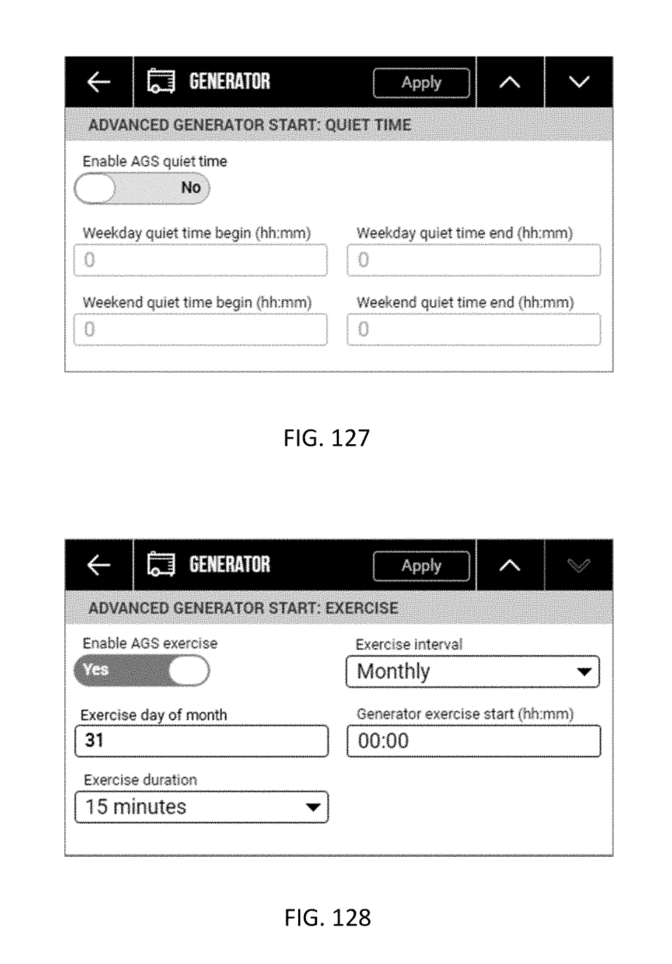

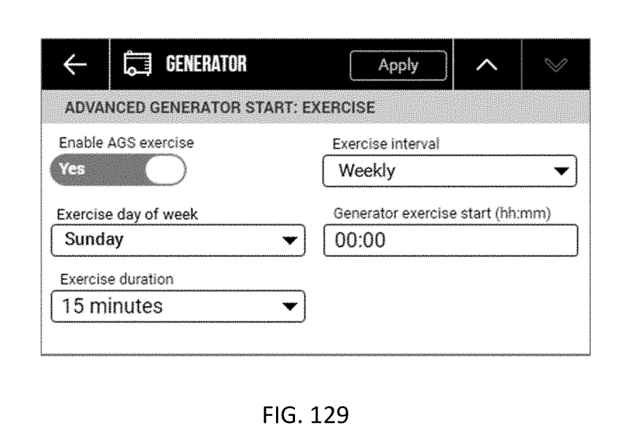

FIG. 86b is a screenshot of an example grid protection webpage in a fifth configuration;

FIG. 87 is a screenshot of an example grid protection webpage in a sixth configuration;

FIG. 88 is a screenshot of an example grid protection webpage in a seventh configuration;

FIG. 89 is a screenshot of an example grid protection webpage in an eighth configuration;

FIG. 90 is a screenshot of an example grid protection webpage in a ninth configuration;

FIG. 91 is a screenshot of an example grid protection webpage in a tenth configuration;

FIG. 92 is a screenshot of an example grid protection webpage in an eleventh configuration;

FIG. 93 is a screenshot of an example grid protection webpage in a twelfth configuration;

FIG. 94 is a screenshot of an example load information webpage;

FIG. 95 is a screenshot of an example load status chart in a day mode of display webpage;

FIG. 96 is a screenshot of an example load status chart in a week mode of display webpage;

FIG. 97 is a screenshot of an example load status chart in a month mode of display webpage;

FIG. 98 is a screenshot of an example load status chart in a year mode of display webpage;

FIG. 99 is a screenshot of an example load status webpage in a first configuration;

FIG. 100 is a screenshot of an example load status webpage in a second configuration;

FIG. 101 is a screenshot of an example load more info webpage in a first configuration;

FIG. 102 is a screenshot of an example load more info webpage in a second configuration;

FIG. 103 is a screenshot of an example load basic settings webpage;

FIG. 104 is a screenshot of an example graph displaying historical information related to the battery charge/discharge status in a day mode of display webpage;

FIG. 105 is a screenshot of an example graph displaying historical information related to the battery charge/discharge status in a week mode of display webpage;

FIG. 106 is a screenshot of an example graph displaying historical information related to the battery charge/discharge status in a month mode of display webpage;

FIG. 107 is a screenshot of an example graph displaying historical information related to the battery charge/discharge status in a year mode of display webpage;

FIG. 108 is a screenshot of an example battery charging;

FIG. 109 is a screenshot of an example battery details webpage;

FIG. 110 is a screenshot of an example battery status webpage;

FIG. 111 is a screenshot of an example battery historical performance webpage;

FIG. 112 is a screenshot of an example battery battery settings webpage in a first configuration;

FIG. 113 is a screenshot of an example battery battery settings webpage in a second configuration;

FIG. 114 is a screenshot of an example battery battery charge settings;

FIG. 115 is a screenshot of an example battey battery recharge settings webpage;

FIG. 116 is a screenshot of an example battery battery protection webpage;

FIG. 117 is a screenshot of an example graph displaying historical information related to the kilowatt hour amounts produced by an attached generator in a day mode of display webpage;

FIG. 118 is a screenshot of an example graph displaying historical information related to the kilowatt hour amounts produced by an attached generator in a week mode of display webpage;

FIG. 119 is a screenshot of an example graph displaying historical information related to the kilowatt hour amounts produced by an attached generator in a month mode of display webpage;

FIG. 120 is a screenshot of an example graph displaying historical information related to the kilowatt hour amounts produced by an attached generator in a year mode of display webpage;

FIG. 121 is a screenshot of an example generator voltage variance webpage;

FIG. 122 is a screenshot of an example generator more info webpage;

FIG. 123 is a screenshot of an example generator generator settings webpage in a first configuration;

FIG. 124 is a screenshot of an example generator generator settings webpage in a second configuration;

FIG. 125 is a screenshot of an example generator advanced generator start webpage;

FIG. 126 is a screenshot of an example generator advanced generator start: load webpage;

FIG. 127 is a screenshot of an example advanced generator start: quiet time webpage;

FIG. 128 is a screen shot of an example advanced generator start: exercise webpage in a first configuration; and

FIG. 129 is a screenshot of an example advanced generator start: exercise webpage in a second configuration.

### DETAILED DESCRIPTION

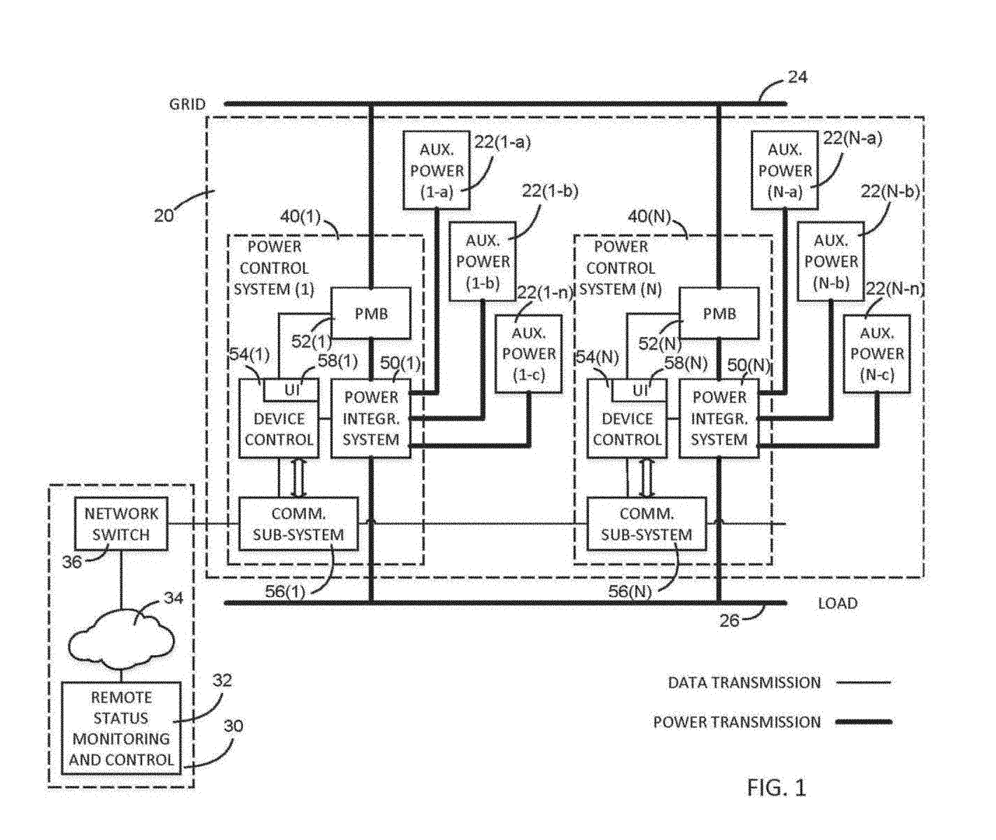

Referring initially to FIG. 1 of the drawing, depicted therein is an example power supply system 20 constructed in accordance with, and embodying, the principles of the present invention. The example power supply system 20 is operatively connected to at least one auxiliary power system 22, a utility power grid 24, and a load 26. The example power supply system 20 is further operatively connected to a communications system 30 comprising a remote status monitoring and control system 32, a communications system 34, and a network switch 36. The auxiliary power nodes 22, grid 24, load 26, remote status monitoring and control system 32, communications system 34, and network switch 36 are not necessarily part of the present invention and will be described herein only to that extent necessary for a complete understanding of the present invention.

The example power supply system 20 comprises at least one power control system 40, and each power control system 40 is operatively connected to at least one of the auxiliary power nodes 22. A power supply system of the present invention may have as few as a single power control system 40 or, theoretically, an unlimited number of the power control systems 40. The number of power control systems 40 is generally related to the number and type of auxiliary power nodes 22 supported by the example power supply system 20.

FIG. 1 further illustrates that each of the example power control system(s) 40 comprises a power integration system 50, a power management board 52, a device control system 54, and a communications sub-system 56. In addition, each of the device control systems 54 comprises user interface hardware 58.

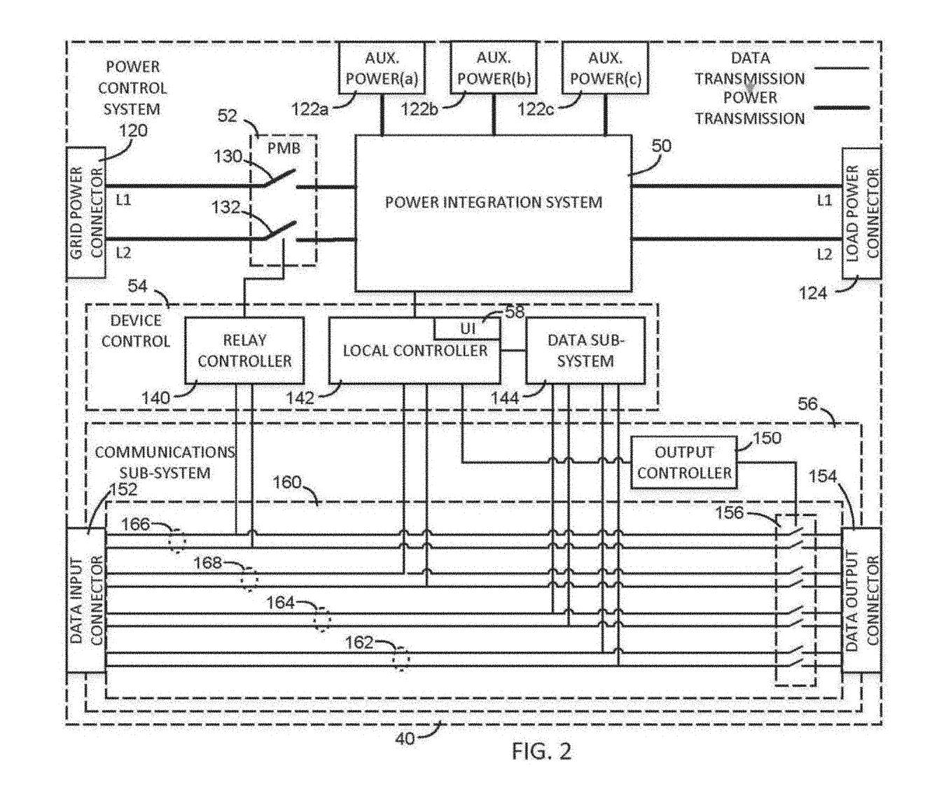

Turning now to FIG. 2 of the drawing, depicted therein are the details of the example power control system 40 that may be used as part of a power supply system of the present invention. The example power integration system 50 of the example power control system 40 defines a grid power connector 120, three auxiliary power connectors 122a, 122b, and 122c, and a load power connector 124. The example power control system 40 depicted in FIG. 2 is thus capable of accommodating up to three of the auxiliary power sources 122.

The example power management board 52 of the example power control system 40 comprises first and second relays 130 and 132. The example device control system 54 of the example power control system 40 comprises a relay controller 140, a local controller 142, a data sub-system 144, and a local memory 146. The example local controller 142 is operatively connected to or incorporates the user interface hardware 58 of the example device control system 54. The example communications sub-system 56 of the example power control system 40 comprises an output controller 150, a data input connector 152, and a data output connector 154.

The example local controller 142 is or may comprise a processor configured to run software capable of performing the configuration, data collection, and operational logic described herein. One example of the local controller 142 may be a Linux system running one or more software daemons, with a master daemon controlling the overall operational logic of the power control system 40. The example local memory 146 is operatively connected to or forms a part of the local controller 142 such that data such as configuration data, operating parameters, and status data associated with the example device control system 54 can be stored by the local controller 142 in the local memory 146 and accessed through the communications sub-system 56 and/or user interface 58.

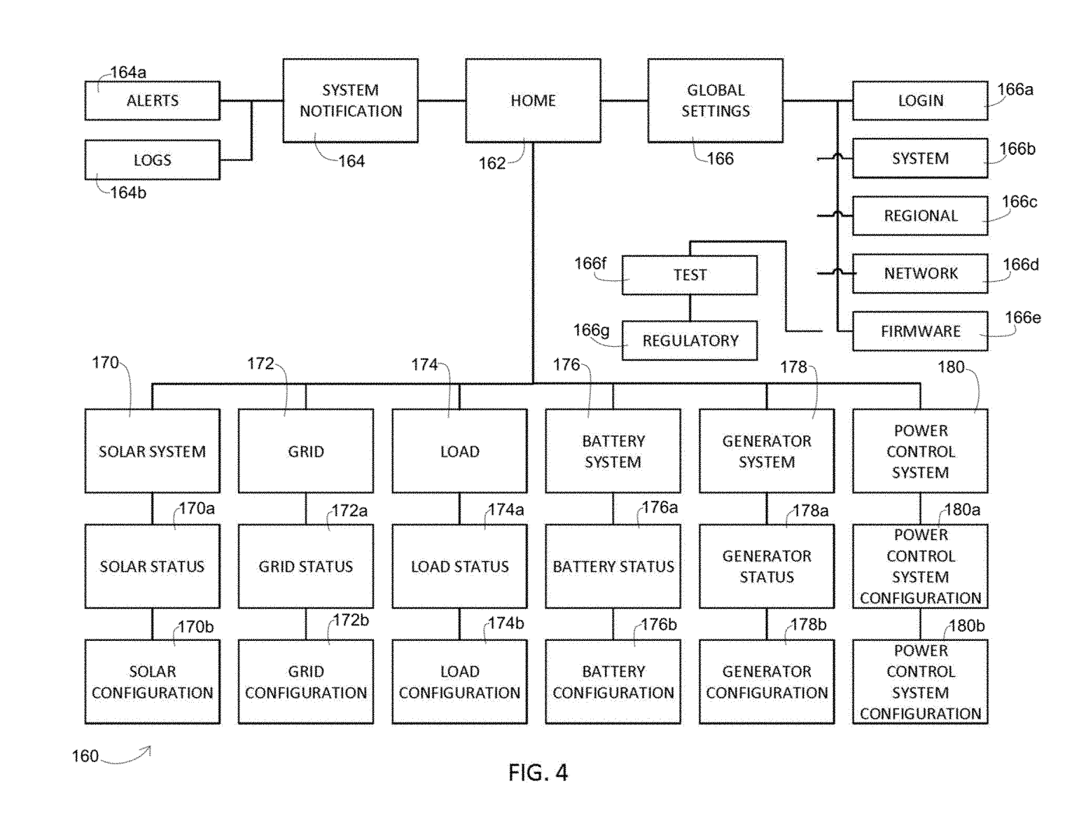

FIG. 4 illustrates a page layout overview of an example user interface 160 that may be used to set, access, and/or change configuration data, operating parameters, and status data associated with the example device control system(s) 54. In particular, the example local controller 142 is configured to display the user interface 160 using the user interface hardware 58 as will be described in further detail below. The example user interface 160 is configured to be implemented as a web site accessible, by referencing a uniform resource locator (URL), over a public internet protocol (IP) network, such as the Internet, or a private local area network (LAN). The example user interface 160 thus may be accessed by a remote computing device such as the remote status monitoring and control system 32. Remote access to the example user interface may thus be wired or wireless devices containing hardware allowing access to and interaction with the example user interface 160 through the communication network 34, network switch 36, and communications sub-system(s) 56.

The device controller 54 of each of the power control systems 40 is capable of generating the example user interface 160. When the power supply 20 comprises a single power control system 40, the device controller 54 of that power control system 40, referred to as a lone device controller 54, generates the example user interface 160. The lone device controller 54 allows entry of configuration data through the example user interface 160, stores the configuration data, generates status data, and stores the status data. A local user with access to the example user interface hardware 58 associated with the lone device controller 54 or a remote user with access to the remote status monitoring and control system 32 can view and change configuration data and view status data through the user interface 160.

The power supply system 20 may comprises a plurality (two or more) of the power control systems 40. The power control systems 40 may be identical to each other, or some of the power control systems 40 may have only a subset of the features of one or more of the other power control systems. In the example power supply system 20, the power control systems 40 are identical to each other.

When the power supply system 20 comprises multiple power control systems 40, one of the power control systems 40 is identified as a master power control system 40 and the other power control system(s) 40 is/are identified as a slave power control system 40. In the case of multiple power control systems 40, the device controller 54 of the master power control system 40, referred to herein as the master device controller 54, generates the example user interface 160. The device controllers 54 of any slave power control system 40 are referred to herein as a slave device controller 54. The master device controller 54 allows entry of configuration data through the example user interface 160, stores the configuration data, generates status data, and stores the status data. A local user with access to the example user interface hardware 58 associated with the master device controller 54 or a remote user with access to the remote status monitoring and control system 32 can view and change configuration data and view status data through the user interface 160.

To facilitate proper coordination among power control systems 40 of a power supply system 20 comprising a plurality of the power control systems 40, the master device controller 54 allows entry and storage of what will be referred to herein as master configuration data. The master configuration data ensures the integrity of any configuration data necessary for proper coordination of any one or all of the multiple power control systems 40. The master device controller 54 further collects and stores what will be referred to herein as master status data and aggregate status data. Master status data includes any status data necessary for proper coordination among the plurality of power control systems 40. Aggregate status data includes data derived or calculated from at least some of the status data associated with a plurality of the power control systems 40. The master device controller 54 may further store local configuration data and at least a portion of any local status data associated with any slave power control system 40. The master device controller 54 thus maintains a copy of all configuration and status data necessary for operation of one or more of the power control systems 40 forming the power supply 20.

Slave device controllers 54 similarly are or contain computing devices capable of accessing the user interface 160 generated by the master device controller 54. Subject to security limitations (e.g., user levels and passwords), any slave device controller 54 may be used to view and alter at least some of the master configuration data, master status data, and aggregate status data, but the slave device controllers 54 do not need store master configuration data, master status data, and aggregate status data locally. While one or more slave device controllers 54 may locally store master configuration data, master status data, and aggregate status data, in the example power control system 40, any master configuration data, master status data, and aggregate status data locally stored by a slave device controller 54 is for backup or security purposes and is not used to coordinate the operation of the power control systems 40 during normal operation of the power supply system 20.

The slave device controllers 54 may store local configuration data and/or generate and store local status data. Local configuration data and local status data may be used to control operation of a particular slave power control system 40. Such local configuration data and local status data is typically not directly used to coordinate operation of the plurality of power control systems 40.

The master device controller 54 will generate aggregate status data by polling the local status data stored by any slave device controller(s) 54 and performing any required mathematical operations appropriate for generating such aggregate status data. The local status data associated with the master device controller 54 will typically be included in the aggregate status data.

As depicted in FIG. 4, the example user interface 160 defines a home page 162, a system notification page(s) 164, and a global settings page(s) 166. The system notification page(s) 164 allows access to an alert page(s) 164a and a log page(s) 164b. The global settings page(s) 166 allows access to a login page(s) 166a, a system settings page(s) 166b, a regional settings page(s) 166c, a network settings page(s) 166d, a firmware settings page(s) 166e, a test page(s) 166f, and a regulatory page(s) 166g.

The web site page(s)s 164a and 164b correspond to or define web page(s) that allow access to alerts and logs, respectively, associated with warning or fault conditions to be viewed. The web site page(s)s 166a, 166b, 166c, 166d, and 166e correspond to or define web page(s) that allow the global settings associated with a particular power supply system 20 to be set. The test and regulatory page(s)s 166f and 166g correspond to or define web page(s) that allow entry and viewing of status data associated with testing functions and functions required by regulation, respectively.

The example user interface 160 further defines a solar system page(s) 170, a grid page(s) 172, a load page(s) 174, a battery system page(s) 176, a generator system page(s) 178, and a power control system page(s) 180. The solar system page(s) 170 further allows access to a solar status page(s) 170a and a solar configuration page(s) 170b. The grid page(s) 172 allows access to a grid status page(s) 172a and a grid configuration page(s) 172b. The load page(s) 174 allows access to a load status page(s) 174a and a load configuration page(s) 174b. The battery system page(s) 176 allows access to a battery status page(s) 176a and a battery configuration page(s) 176b. The generator page(s) 178 allows access to a generator status page(s) 178a and a generator configuration page(s) 178b. The power control system page(s) 180 allows access to a power control system status page(s) 180a and a power control system configuration page(s) 180b.

The status pages 170a, 172a, 174a, 176a, and 178a correspond to or define web page(s) that allow a user to view any status data associated with operation of and coordination among the auxiliary power system(s) 22 associated with each of the power supply system(s) 40. The configuration pages 170b, 172b, 174b, 176b, and 178b correspond to or define web page(s) that allow a user to enter and/or view any configuration data required for proper operation of and coordination among the auxiliary power system(s) 22 associated with each of the power supply system(s) 40. The status page(s) 180a and configuration page(s) 180b allow the user to view status data and view and/or alter configuration data associated with each power control system 40.

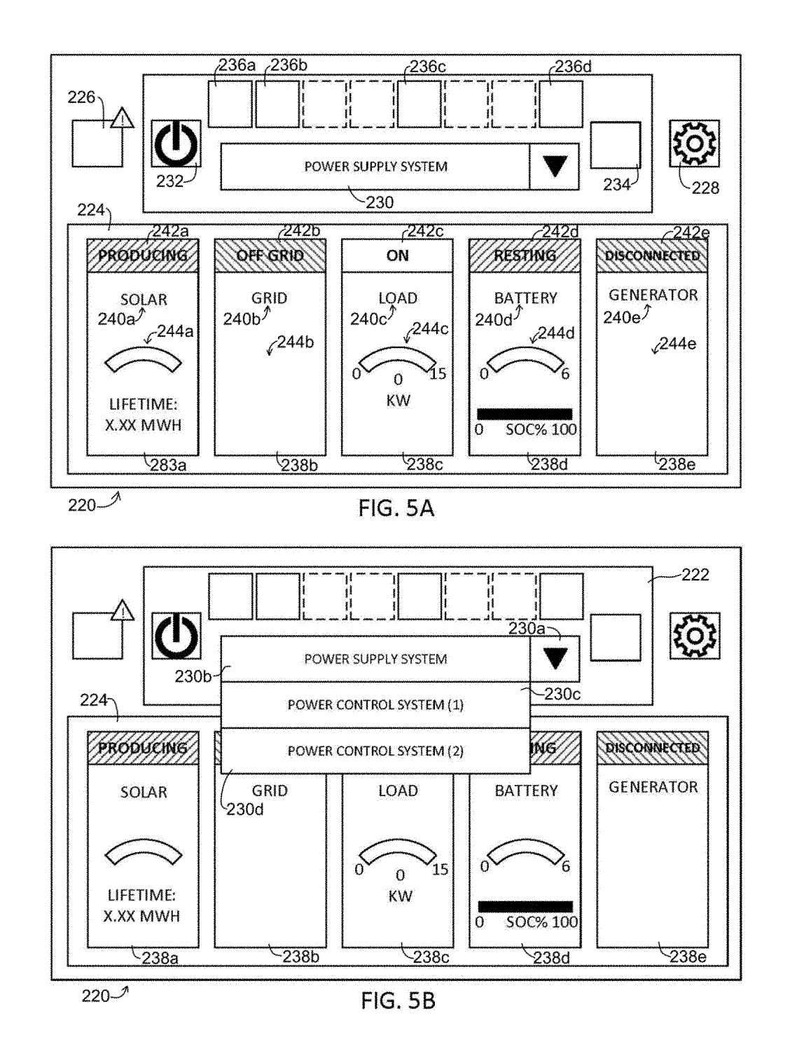

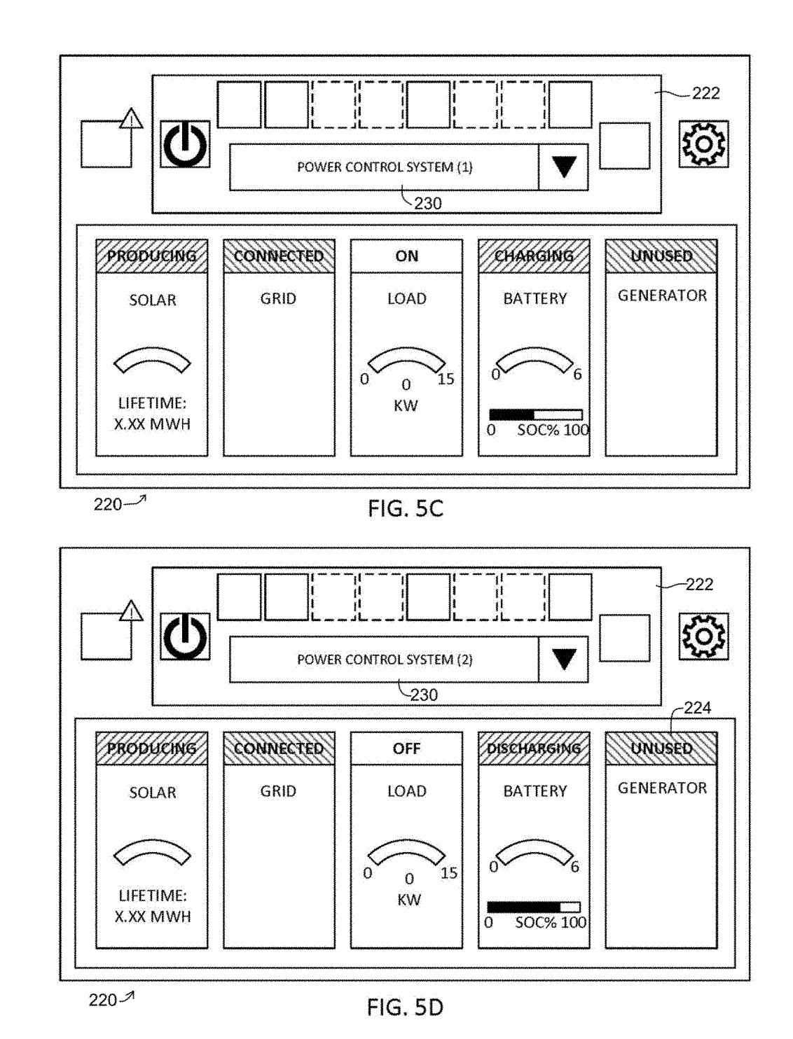

Referring now to FIGS. 5A-D of the drawing, an example of a home page 220 that may be used as the example home page 162 will initially be described. The example home page 220 defines a main control region 222, a status region 224, a notification region 226, and a settings region 228. The example main control region 222 includes a main selection element 230, a power control element 232, a cabinet status element 234, and a plurality of system status elements 236. The example power status region 224 comprises a plurality of power status sub-regions 238. Each power status sub-region 238 comprises an identification section 240, a status section 242, and a data section 244.

The example home page 220 defines five of the power status sub-regions 238a, 238b, 238c, 238d, and 238e. In particular, the example sub-region 238a is associated with the first auxiliary power system 22a, the example sub-region 238b is associated with the grid 24, the example sub-region 238c is associated with the load 26, the example sub-region 238d is associated with the second auxiliary power system 22b, and the example sub-region 238e is associated with the third auxiliary power system 22c.

As shown by a comparison of FIGS. 5A and 5B, the example main selection element 230 is a dropdown box. When the user touches the arrow 230a of the example main selection element 230, the user is presented with three choices: a power supply system choice 230b, a power control system (1) choice 230c, and a power control system (2) choice 230d. The main selection element 230 thus allows the user to select the data to be displayed in the status region 224 of the home page 220. Selecting the power supply system choice 230b displays status data associated with the entire power supply system 20. Selecting the power supply system choice 230c displays status data associated with a first of two power control systems 40 as shown in FIG. 5C, while selecting the power supply system choice 230d displays status data associated with a second of two power control systems 40 as shown in FIG. 5C. The main selection element 230 thus allows the example home page 220 to be reconfigured as necessary to view data associated with either of two power control systems 40 or aggregate data associated with the power supply system 20 incorporating the two power supply systems 40.

In the example home page 220, selecting (by clicking or touching) any of the power status sub-regions 238a, 238b, 238c, 238d, or 238e brings up the solar system page(s) 170, grid page(s) 172, load page(s) 174, battery system page(s) 176, generator system page(s) 178, or power control system page(s) 180 associated with the selected power status sub-regions 238a, 238b, 238c, 238d, or 238e. The solar system page(s) 170, grid page(s) 172, load page(s) 174, battery system page(s) 176, generator system page(s) 178, or power control system page(s) 180 allow selection of the status pages 170a, 172a, 174a, 176a, 178a, or 180a or the configuration pages 170b, 172b, 174b, 176b, 178b, or 180b.

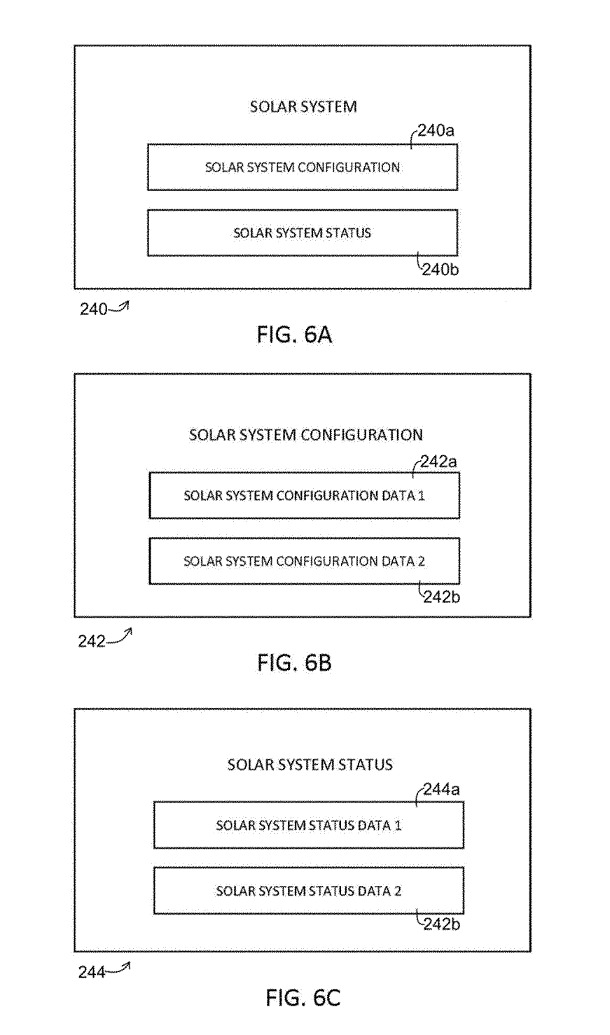

FIGS. 6A, 6B, and 6C depict a solar system page 240, a solar system configuration page 242, and a solar system status page 244, respectively. The solar system page 240 defines a solar system configuration button 240a and a solar system status button 240b. The solar system configuration page 242 displays first and second solar configuration data fields 242a and 242b that display and allow alteration of solar configuration data. The solar system status page 244 displays first and second solar status data fields 244a and 244b that display solar system status data. Solar status data may be alpha-numeric, graphical, icons, or combinations thereof.

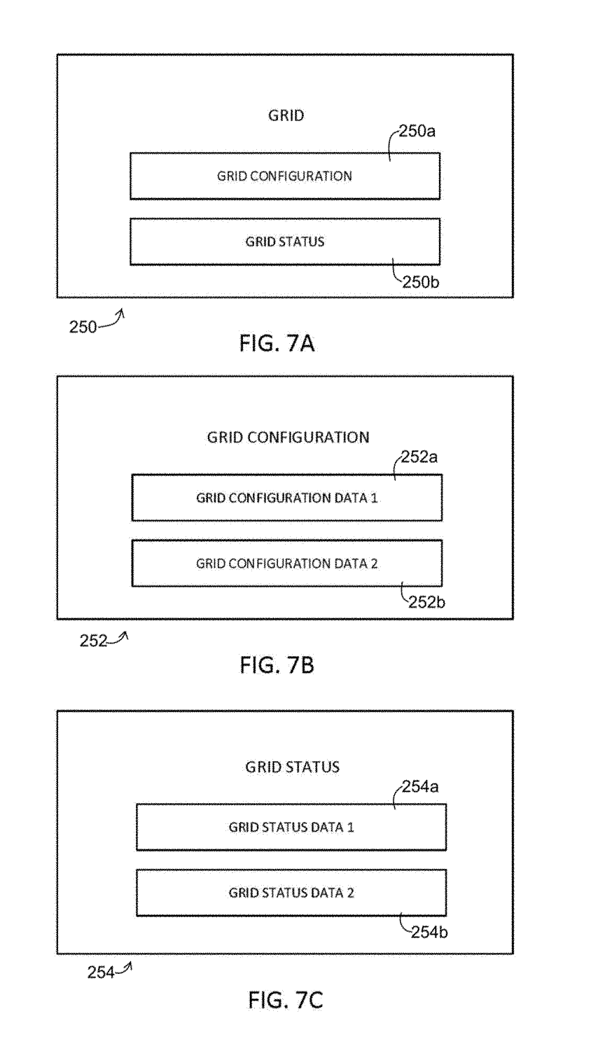

FIGS. 7A, 7B, and 7C depict a grid page 250, a grid configuration page 252, and a grid status page 254, respectively. The grid page 250 defines a grid configuration button 250a and a grid status button 250b. The grid configuration page 252 displays first and second grid configuration data fields 252a and 252b that display and allow alteration of grid configuration data. The grid status page 254 displays first and second grid status data fields 254a and 254b that display grid status data. Grid status data may be alpha-numeric, graphical, icons, or combinations thereof.

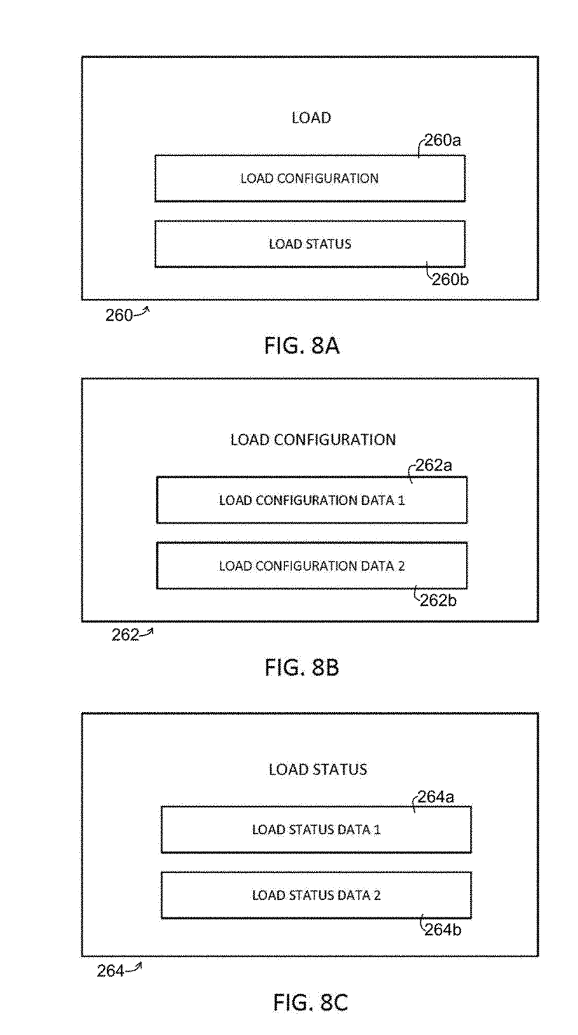

FIGS. 8A, 8B, and 8C depict a load page 260, a load configuration page 262, and a load status page 264, respectively. The load page 260 defines a load configuration button 260a and a load status button 260b. The load configuration page 262 displays first and second load configuration data fields 262a and 262b that display and allow alteration of load configuration data. The load status page 264 displays first and second load status data fields 264a and 264b that display load status data. Load status data may be alpha-numeric, graphical, icons, or combinations thereof.

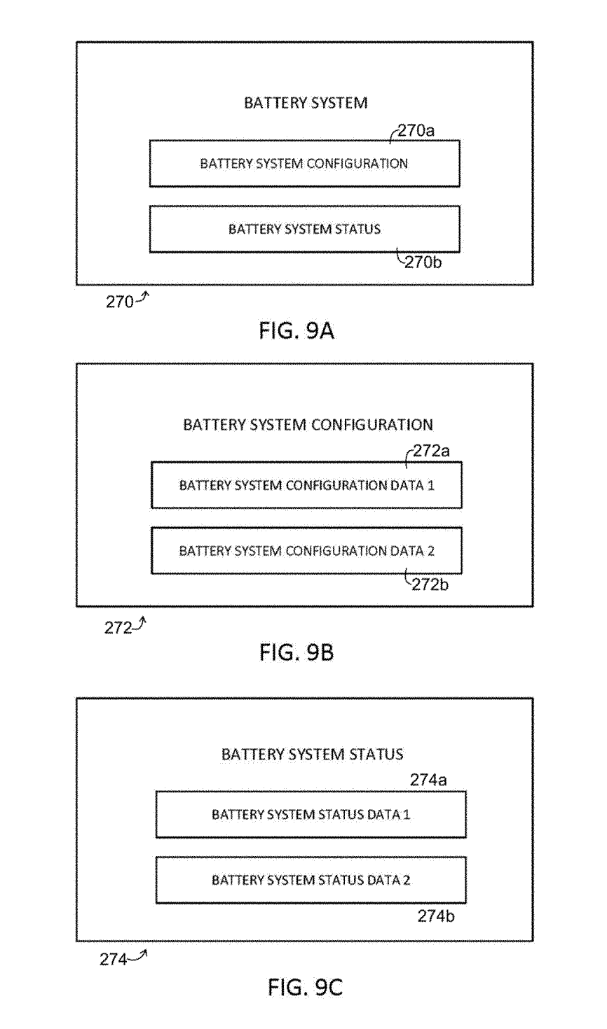

FIGS. 9A, 9B, and 9C depict a battery system page 270, a battery system configuration page 272, and a battery system status page 274, respectively. The battery system page 270 defines a battery system configuration button 270a and a battery system status button 270b. The battery system configuration page 272 displays first and second battery system configuration data fields 272a and 272b that display and allow alteration of battery system configuration data. The battery system status page 274 displays first and second battery system status data fields 274a and 274b that display battery system status data. Battery system status data may be alpha-numeric, graphical, icons, or combinations thereof.

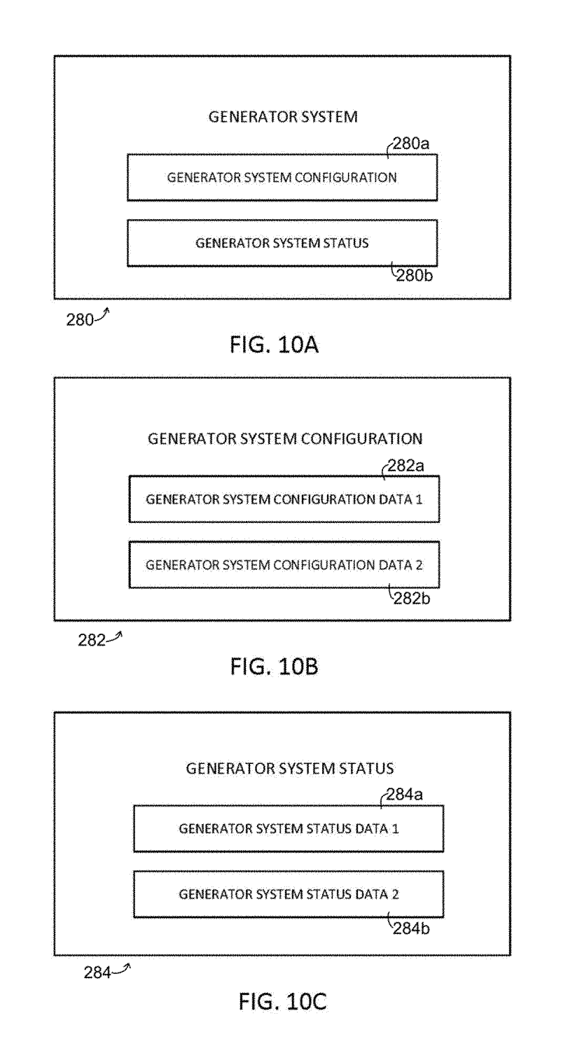

FIGS. 10A, 10B, and 10C depict a generator system page 280, a generator system configuration page 282, and a generator system status page 284, respectively. The generator system page 280 defines a generator system configuration button 280a and a generator system status button 280b. The generator system configuration page 282 displays first and second generator system configuration data fields 282a and 282b that display and allow alteration of generator system configuration data. The generator system status page 284 displays first and second generator system status data fields 284a and 284b that display generator system status data. Generator system status data may be alpha-numeric, graphical, icons, or combinations thereof.

With the foregoing general understanding of the present invention in mind, details of example implementation of the example power supply system 20, the power control system(s) 40, the power integration system(s) 50, and the user interface 160 will now be described in further detail.

As generally discussed above, the example power supply system 20 depicted in FIG. 1 may comprise one or more of the power control systems 40, and suffixes “1” and “n” are used in FIG. 1 in connection with the reference characters “40”, “50”, “52”, “54”, “56”, and “58” to identify individual examples of the same type of element. Further, each of the power control system 40 may be connected to one or more of the auxiliary power nodes 22, and the suffixes (1-a), (1-b), (1-n) are used in FIG. 1 to represent the auxiliary power supplies 22 associated with the power control system 40-1 and the suffixes (N-a), (N-b), and (N-n) are used in FIG. 1 to represent the auxiliary power supplies 22 associated with the power control system 40-N. The limitation on the number of power control systems 40 associated with each power supply 20 and/or auxiliary power nodes 22 associated with each power control system 40 is, theoretically, unlimited, but practical considerations may effective limit either of these elements 40 or 22 to a predetermined number of at least 1. In the example depicted in FIGS. 1-3, the example power control system 40 may be associated with up to five of the auxiliary power nodes 22.

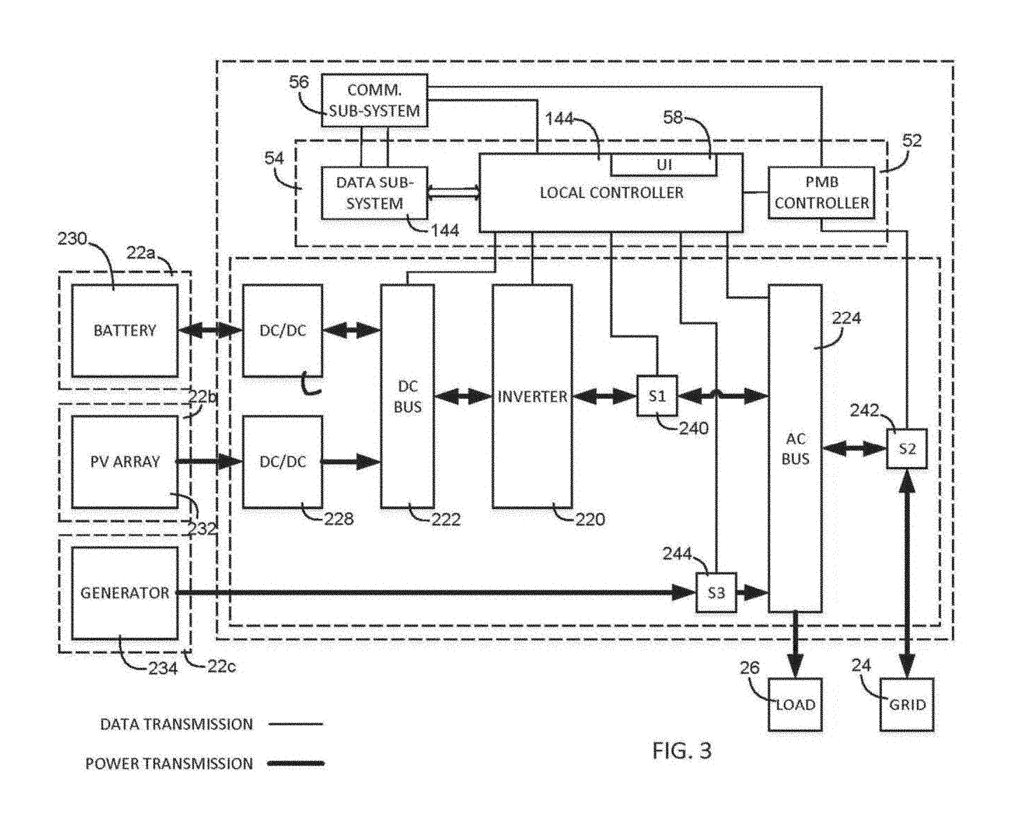

As shown in FIGS. 2 and 3, each power integration system 50 defines a plurality of power nodes 22 and is configured to operate in at least one operating mode. In at least one operating mode, at least one input power signal is input to the power integration system 50 through at least one power node 22. For any given power integration system 50, the input power signal may be a utility power signal from the grid 24 or an auxiliary power signal from the auxiliary power system 22 associated with the given power integration system 50. Further, each power integration system 50 generates an output power signal based on one or more input power signals. The output power signal may be applied to the grid 24, to the load 26, and/or to an energy storage device forming the auxiliary power system 22 associated with that given power integration system 50.

In a power supply system 20 comprising a single auxiliary power system 22 and a single power control system 40 that is not connected to the remote status monitoring and control system 32, the operating mode of the power integration system 50 may be controlled completely within the power control system 40 using the power integration system 50, the power management board 52, the device control system 54, and the user interface 58. Accordingly, when a single power control system 40 is present, that power control system 40 is capable of operating in a stand-alone manner. In this context, the device control system 54 stores parameters that are used by the power control system 40 operating in the stand-alone mode.

In a power supply system 20 comprising multiple auxiliary power nodes 22 and multiple power control systems 40, the mode in which the plurality (two or more) power integration systems 50 operate is coordinated among the plurality of power control systems 40 using the power management boards 52, the device control systems 54, and the communications sub-systems 56 of the plurality of power control system 50. When multiple power control systems 40 are present as shown in the example power supply system 20, the operation of those power control systems 40 is coordinated using the communications sub-systems 56. In this scenario, one of the power control systems 40 will be identified as a master power control system as generally described above, and the remaining power control systems 40 are identified as slave power control systems. The master power control system 40, and in the example power control system 40 the master device control system 54 associated therewith, will control at least some functions of the slave power control systems 40.

The example communications sub-system 56 allows communication among the master and slave power control systems 40 and, optionally, between any given power control systems 40 and the local status monitoring and control system 28 and/or the remote status monitoring and control system 32. The example communications sub-system 56 is configured to communicate status monitoring and control data with the power integration system 50 and device control data with the device control system 54. The status monitoring and control data is used to perform routine, non-time critical functions such as determining status of the power integration system 50 and any auxiliary power system 22 associated therewith. The device control data is used to perform time critical functions such as coordinating operating mode changes among the plurality of power control systems 40.

The example power supply system 20 thus facilitates the integration of auxiliary power nodes 22 to define a power system configuration appropriate for the particular configuration of hardware forming the example power supply system 20. Further, the exact nature of the hardware selected to form the example power supply system 20 need not be known in advance.

FIG. 2 shows that the example communications sub-system 56 further comprises a cable assembly 320 that extends between the data input connector 152 and the data output connector 154. The example cable assembly 320 comprises a first conductor pair 322, a second conductor pair 324, a third conductor pair 326, and a fourth conductor pair 328. The first and second conductor pairs 322 and 324 are connected to the data sub-system 144 of the device control system 54. In the example communications sub-system 56, the first and second conductor pairs 322 and 324 form transmit and receive cables of an ethernet based communications system, but other standard or non-standard communications systems may be used in addition to or instead of an ethernet based communications system. The third conductor pair 326 is further operatively connected to the relay controller 140. The fourth conductor pair 328 is further operatively connected directly to the local controller 142.

The communications system implemented using the first and second data pairs 322 and 324 is capable of transmitting status monitoring and control information, and in particular is capable of data associated with non-time critical functions carried out by the power control system 40. The third and fourth conductor pairs 326 and 328 carry device control data used for time critical functions carried out by the power control system 40. The third and fourth conductor pairs 326 and 328 thus allow time critical functions to be coordinated and implemented in real time or near real time.

The output controller 150 controls the output switch array 156 to connect the data output connector 154 to or disconnect the data output connector 154 from the data sub-system 144, the relay controller 140, the local controller 142, and the data input connector 152. In particular, when the local controller 142 determines that the output data connector 154 of a given power control system 40 is connected to the input data connector 152 of another of plurality of power control systems 40, the output switch array 156 is configured to be in a closed configuration. When a given power control system 40 is the only power control system 40 of the power supply system 30 or is the last power control system 40 of a plurality of power control systems 40, the output controller 150 is controlled to open the switches forming the switch array 156 to disconnect the data output connector 154 from the data sub-system 144, the relay controller 140, the local controller 142, and the data input connector 152. When the output data connector 154 of a given power control system 40 is connected to the input data connector 152 of another of a plurality of power control systems 40 forming the power supply system 30, data may be carried between any of the plurality of control systems 40.

Turning now to FIG. 3 of the drawing, an example power integration system 50 that may be used by the example power control system 40 will now be described in further detail. The example power integration system 50 depicted in FIG. 3 comprises an inverter 420, a DC bus 422, an AC bus 424, a first DC/DC converter 426, and a second DC/DC converter 428. The example power integration system 50 depicted in FIG. 3 forms a part of an example power control system 40 that supports first and second DC auxiliary power nodes 22a and 22b and an AC auxiliary power source 22c. The example first DC auxiliary power source 22a is formed by a battery 430, the example second DC auxiliary power source 22b is formed by a photovoltaic array 432, and the example AC auxiliary power source 22c is formed by a generator 434.

The inverter 420 is operatively connected between the DC bus 422 and the AC bus 424. The first DC/DC converter 426 is operatively connected between the battery 430 and the DC bus 422. The second DC/DC converter 428 is operatively connected between the PV array 432 and the DC bus 422.

The example power integration system 50 additionally comprises a first mode control switch 440, a second mode control switch 442, and a third mode control switch 444. The first mode control switch 440 is connected between the inverter 420 and the AC bus 424. The relays forming a part of the power management board 52 form the second mode control switch 442. The third mode control switch 444 is connected between the generator 434 and the AC bus 424.

The local controller 142 of the example power supply system 40 depicted in FIG. 3 is operatively connected to the inverter 420, the DC bus 422, and the AC bus 424 to sense a status of the inverter 420 and voltages on the buses 422 and 424. The example local controller 142 is further arranged to control operation of the inverter 420 and mode control switches 440, 442, and 444 to control the operating mode of the power supply system 40 and power integration system 50 forming a part thereof.

The example integration system 50 may be configured to handle up to three of the auxiliary power nodes 22a, 22b, and 22c as shown in FIG. 3. However, the integration system 50 may integrate any one or any combination of two of the auxiliary power nodes 22a, 22b, and 22c.

In any configuration, the local controller 142 is capable of sensing a DC voltage on the DC bus 422 and an AC voltage on the AC bus 424. Voltage data representing these DC and AC voltages can be stored in the local memory 146 and used for control of the example integration system 50. This voltage data, along with data representing other status information such as the state of the first, second, and third mode control switches 440, 442, and 444 (e.g., power management switches 130 and 132), can also be stored in the local memory 146 by the local controller 142 as status data. Such status data can be later downloaded from local memory 146 through the local controller 142 and/or transmitted to the local status monitoring and control system 28 and/or the remote status monitoring control system 32 if the example power supply system 20 is connected to the communications system 30 as depicted in FIG. 1. In particular, any of the configuration data or status data stored by the local controller 142 can be accessed, altered, and/or viewed using the user interface 160 running accessible to any of the local controllers 142 or the remote status monitoring and control system 32 as generally described above.

The example local controller 142 may be configured such that the local controller 142 controls the PMB controller 140, the inverter 420, and the mode control switches 440, 442, and 444 such that the integration system 50 changes operating modes in a timely and coordinated fashion within the context of the overall power supply system 20.

Additionally, if the local controller 142 of the master power control system 40 determines that the utility power signal on the AC bus 424 thereof is outside of predetermined parameters, the local controller 142 of that master power control system 40 directs the PMB controllers 140 and local controllers 142 of any slave power control systems 40 to direct the local controllers 142 of those slave power control systems 40 to switch to an operating mode in which the AC power signal is generated by one or more of the auxiliary power nodes 22. This switch over may be accomplished by, for example, communicating zero-crossing information such that the change from utility mode to standby mode is coordinated among the various power control systems 40. The local controller 142 of the master power control system 40 of any given power supply system 20 thus is capable of communicating directly and in real time, or relatively directly and in near real time, through the dedicated third and fourth conductor pairs 326 and 328 rather than using the data sub-system 144. Accordingly, operation of the example power supply system 20 is not adversely affected by any delays introduced by the communications system used to implement that data sub-system 144.

The example user interface hardware 58 may be any appropriate hardware, such as a touch screen, display screen, keyboard, mouse, or the like, for communicating information to and receiving information from a user. In this context, the local status monitoring and control system 28 will further define or define a user interface system that allows users with physical access to the example power supply system 20 to control (e.g., configure) and/or monitor the status of the power supply system 20 and any power control systems 40 forming a part thereof, any auxiliary power nodes 22 connected thereto, and any grid 24 and/or load 26 to which the power supply system 20 is connected.

The remote status monitoring and control system 32 may be used to facilitate configuration of the example power supply system 20 and of the power control systems 40 forming a part thereof from a remote location and/or from a portable device that is not physically connected to the example power supply system 20 such as a smart phone or tablet. The remote status monitoring and control system 32 will typically comprise or be connected to a user interface device (not shown) such as a touch screen, display screen, keyboard, mouse, or the like. In this context, the remote status monitoring and control system 32 will further define or define a user interface system that allows users without physical access to the example power supply system 20 to control (e.g., configure) and/or monitor the status of the power supply system 20 and any power control systems 40 forming a part thereof, any auxiliary power nodes 22 connected thereto, and any grid 24 and/or load 26 to which the power supply system 20 is connected. The remote status monitoring and control system 32 may provide the same, greater, or lesser functionality to the user than the local status monitoring and control system 28 depending on factors such as user identity, safety, privacy, and security.

The operating modes of any individual power integration system 50, any individual power control system 40, or the power supply system 20 in its entirety will depend on factors such as the specifics of the hardware forming a given power supply system 20 and/or parameters determined by the local status monitoring and control system 28 and/or remote status monitoring and control system 32. For example, the status monitoring and control systems 28 or 32 may be configured to alter the operating mode of any one or more power control systems 40 forming the power control system 20 based on the market price of electrical power at a particular point in time. For example, the power supply system 20 may be configured to sell power, including stored power, back to the electrical power utility when the spot price is high and to purchase power from the electrical power utility when the spot price is low. As another example, when the spot price of electrical power is high, the power supply system 20 may be configured to use generated and/or stored power rather than purchase electrical power so long as possible. As yet another example, the power supply system 20 may be configured to store power when the spot price is low and sell the stored power to the utility only after the spot price increases.

A power supply system 20 of the present invention can easily be configured to switch among any such modes as allowed by the specific hardware configuration defined by a particular implementation of that particular power supply system 20.

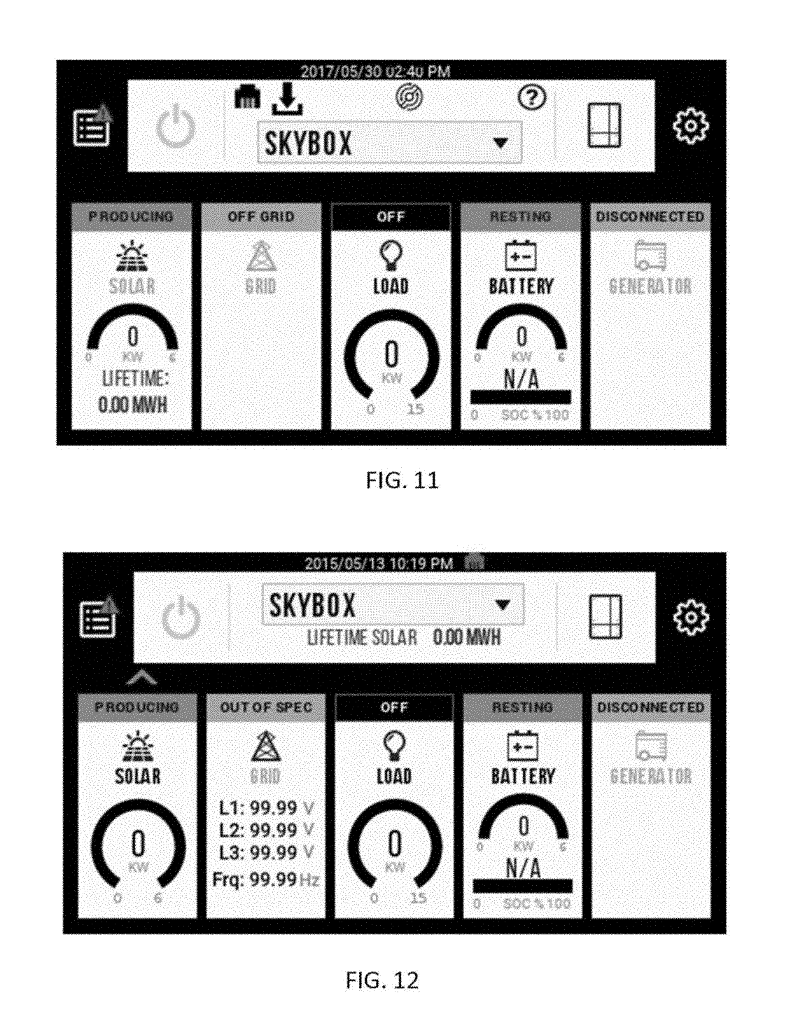

Turning now to FIGS. 11-128, a detailed example of a detailed example of the user interface system 160 will now be described.

### A. User Profiles and User Goals

This section describes the various types of users of the power control system 20 and how the example user interface system 160 may be configured to allow appropriate access to the configuration and/or operating parameters of the power control system 20. The example user interface 160 may be referred to below as “UI” or “the UI”. The term “SkyBox” may be used below to refer to a power control system 40 of a power supply of the present invention.

Typically, the power control system 20 has the following types of user profiles: Public; Owner; Installer; and Administrator. Each user profile, apart from Public, has an associated password. Additionally, users of the power supply system 20 typically operate in one of the following environments: Residential installation (e.g., homeowner has system installed on house); commercial installation; and/or microgrid.

Each Profile on the system has a defined set of permissions. A List of Possible User Profile Permissions that an account can have is set forth below. For each secondary item in the list, the selection is mutually exclusive. Account authentication should be designed in such a way that the permissions associated with a particular user profile may be changed.

List of Possible User Profile Permissions:
Status:
   Read Only: Can view all status information.
Action Buttons:
   Limited:
      Start Generator
      Stop Generator
      Inverter On
      Inverter Off
   Full: Can perform any action.
   Note: Full permission is mutually exclusive with limited permissions. We may want to define limited permissions by specifically stating which actions are available, instead of treating it as a set.
Configuration:
   Read Only: Can view all configuration information.
   Read/Write (Limited): Can only change minor settings in Global Configuration. Cannot change system specific configuration. Cannot load or save configuration.
   Read/Write (Extended): Set everything except manually changing grid interconnection parameters and cannot see or access TEST tab in global configuration.
   Read/Write (ALL): Can change everything. Can see and use the TEST tab in global configuration.
Fault Popups:
   Read Only
   Clear
Log
   Read Only: Can only view the log items.
   Read/Write: Can mark log items as read.
Ability to change passwords:
   Each account has the ability to change the password of the account underneath it
   However, Public never has a password associated with it.
   Any profile above public has access to change the Remote User Login password.
Ability to install firmware updates
   Can only be installed by a local user. Cannot be installed remotely.

The list of all permissions assigned to various account types may be default as set forth in the List of Assigned Profile Permission below.

List of Assigned Profile Permissions

1. Public
This is considered the default for not being logged in.
Has the ability to view all status screens (Read Only)
Has the ability to view all configuration information. (Read Only)
Has the ability to use the Start/Stop Generator action and the Inverter On/Off action.
Has the ability to clear all faults on the system.
Has the ability to view logs and alerts (Read Only). Cannot mark as having been read.
Cannot change any passwords.

2. Owner
Can do all of the above.
Read/Write (Limited) Configuration access
   Has access to all action buttons on the status screens
Can also mark logs and alerts as having been read (acknowledged)
Can change the password for the “Owner” level account.
Can enable Remote User Login and change the Remote Login password.
Can install firmware updates.

3. Installer
Can do all of the above.
Has Read/Write (Extended) access to Configuration screens and action buttons
   Has access to the grid interconnection parameter selection via drop-down menu, but cannot edit individual grid interconnection settings.
   Can use Wizard
   Can save configuration to USB
Can change the password for the “Owner” and “Installer” level account.

4. Administrator
Can do all of the above
Has Read/Write (ALL) access to Configuration screens and action buttons.
   Can set individual grid interconnection parameter values.
   Can see the “TEST” tab in global configuration.
Can change the password for the “Owner”, “Installer”, and “Administrator” level account.

As generally discussed above, the example user interface 160 is configured to allow remote login. Remote Login is intended to provide increased security specifically for systems that allow access of the UI through a local area network or wireless network. The following Remote Login Method provides a method to authenticate users connecting via remote methods.

Remote Login Method:
1. An Owner, Installer, or Administrator user profile can decide to enable remote login user security, and if enabled assign a unique remote login password.
   a. Remote login password are suggested to follow the recommendation displayed in the Information Dialog Remote Password Advisory message.
2. If enabled, a public remote user would be required to login using the remote login password before they could go to the home screen.
   a. Once logged in, they would have same profiles and responsibilities we share today for public users (including the ability to further log in as Owner, Installer, or Administrator).
   b. Remote login would time out according to the Security lockout timer during periods of inactivity.
   c. Remote login would also end upon closing the browser window.
3. Remote Login can be enabled/disabled through the Global settings.
4. The Remote login password can also be viewed and changed through the Global settings.
5. Profiles and permission remain the same for the public user defined in section 3.1.

### B. General Principles of Example User Interface 160

As generally described above, the example user interface 160 can be accessed from multiple devices including: GUI touchscreen on power control system 40 (e.g., small resistive touch LCD); mobile phone/tablet connected using the communications system 30, or computer using the communications system 30.

To enhance user comfort, the example user interface 160 should comprise standard user interface elements such as buttons (active or disabled), text labels, data fields, touchscreen keyboard, scroll arrows, and the like. The example user interface system 160 further operates in one of a view mode, an edit mode, and a user input mode. View mode is the standard mode. While in View mode a user can only observe values, but cannot change them. In Edit mode, the user can edit values by interacting with various UI input elements.

When in View Mode input elements like text boxes, dropdowns, and toggle switches should not be visible. Only the value should be shown. When in Edit mode fields should have the appropriate input element around them indicating that they can be changed. For regular fields this is a text box; for a dropdown field it's a dropdown selection; for a binary choice toggle it's a button with a slider. In the example user interface 160, the user must press ‘Edit’ before being allowed to change any fields by entering Edit Mode.

Logic flow when changing between View and Edit modes will proceed as follows:
1. Navigate to screen with editable fields. User is in View Mode and cannot change values.
2. An edit button will appear at the top of the screen.
3. The user must press the edit button.
   a. If they have sufficient permissions, they are now in Edit Mode and allowed to change values.
   b. If they do not have sufficient permissions, they are redirected to a login screen. Upon successful login they are returned to the previous page in Edit Mode.
4. If a user navigates away from a page and comes back, they shall be in View Mode.

These requirements do not apply to the Wizard, which by design requires user input and should be presented entirely in Edit Mode. Examples of screens provided herein are intended to show screen content and layout only. They are not intended to document the View Mode to Edit Mode process unless otherwise stated.

### C. Detailed Description of Example User Interface 160

This section defines detailed user interface designs for an example configured for a generic power control system 40, and any specific variable values, minimum, maximum, or range is for illustrative purposes only.

The example user interface uses what is referred to herein as a “base screen” as a container for more complicated UI elements with which a user may interact. A base screen can present one screen from a page at a time. Much like sliding a magnifying glass or viewport over a piece of paper, each screen has a fixed width and height, but a page can be made up of any number of screens. In general, a user navigates between pages by following links and between screens by scrolling up and down.

The example user interface 160 employs the following types of user interface elements: buttons, numeric/text input, password input, dropdown input, toggle input, multiple choice, dialog boxes and pop-ups, toasts, information dialog, warning dialog, error dialog, fault dialog, help tool-tips, page layout overviews, screen templates, and the like.

### 1. Home Screen

As generally discussed above, the example user interface 160 described herein employs a home screen as shown in FIG. 11. The example home screen of FIG. 11 provides a high-level overview of major system components and serves as the top-level page for the navigation structure of the user interface 160.

To provide meaningful information “at a glance”, as shown in the drawing FIG. 11, the home screen employs the following color scheme to indicate status information: Green—system or component is in use and functioning normally; Black—system or component is turned off and awaiting manual activation; Gray—system or component is not available or not present; Yellow—system or component is operating in an alternate mode or state from that denoted by green; Red—system or component is returning a fault and cannot be activated until the fault is corrected.

The example home screen depicted in FIG. 11 comprises six major groups of functionality. The most prominent group contains the five status tiles for each system component. The next largest group contains the icon status area and the SkyBox selection dropdown. The SkyBox power button on the left and inverter button on the right make up the last part of the white upper tile. Finally, the global settings button and notification button are on the upper right and upper left parts of the screen respectively.

The Solar Tile of the example home page of FIG. 11 is interactive and operates as follows:
Description: The solar tile panel provides a quick overview of solar power being harvested in real time.
Behavior: Tapping any part of the tile navigates to the [Solar Status] screen.
DAL Modes (pv_status):
   NONE: The system setup does not include a PV array and one has not been detected
      Text Displayed: “NONE”
      Banner Color: Gray
      Arrow: None
   PRODUCING: PV power is available and being used.
      Text Displayed: “PRODUCING”
      Banner Color: Green
      Arrow: Upwards Arrow
      Horseshoe Range: 0 kW to 5 kW
   WAITING: Array has power, but is not being used by other components of the system.
      Text Displayed: “WAITING”
      Banner Color: Green
      Arrow: None
   SLEEPING: PV array has no output.
      Text Displayed: “SLEEPING”
      Banner Color: Gray
      Arrow: None
   FAULT: The array is in a fault condition, which must be cleared before proceeding
      Text Displayed: “FAULT”
      Banner Color: Red
      Arrow: None
   SWEEPING: System Controller is performing an array sweep
      Text Displayed: “SWEEPING”
      Banner Color: Yellow
      Arrow: None
   TESTING: Ground Fault, Arc Fault, or Impedance detection test are running.
      Text Displayed: “TESTING”
      Banner Color: Yellow
      Arrow: None
Total Solar Production
   Description: Represents the total lifetime accumulated solar energy the device has harvested.
   Units: MWh
Appearance
   Icon is black if solar input is configured as present.
   Icon is gray if solar input is not present.

The Grid Tile of the example home page of FIG. 11 is also interactive an operates as follows:
Description: The grid tile provides a quick overview of power being bought from, or sold to the grid.
Behavior: Tapping any part of the tile navigates to the [Grid Status] screen. Some modes have a timer, which counts time remaining before transitioning to another mode.
DAL Modes (grid_status)
   OFF_GRID: Grid is disconnected.
      Text Displayed: “OFF GRID”
      Banner Color: Gray
      Arrow: None
   OUT_OF_SPEC: Source is outside the grid protection parameter boundaries
      Text Displayed: “OUT OF SPEC”
      Banner Color: Gray
      Arrow: None
      Extra Behavior: Show L1/L2/L3 voltage and Frequency.
   WAITING_TO_CONNECT: Source is within input range but has not met connection timer
      Text Displayed: “WAITING”
      Banner Color: Green
      Arrow: None
      Extra Behavior: Show timer
   GRID_ZERO:
      Text Displayed: “ZEROING”
      Banner Color: Green
      Arrow: None
   DROPPED: Grid is available and not being used (intentionally not connected).
      Text Displayed: “DROPPED”
      Banner Color: Gray
      Arrow: None
   CONNECTED: Connected to the grid. UI must determine if it should show buying, selling, or connected state based on the sign of power.
      Connected (−100 W [−0.09 kW] to 100 W [0.09 kW])
         Text Displayed: “CONNECTED”
         Banner Color: Green
      Buying (Negative Power):
         Text Displayed: “BUYING”
         Banner Color: Yellow
         Arrow: Upwards
         Horseshoe Range: 0 kW to 10 kW
      Selling (Positive Power):
         Text Displayed: “SELLING”
         Banner Color: Green
         Arrow: Downwards
         Horseshoe Range: 0 kW to 5 kW
Appearance
   Icon is black if grid input is configured as present.
   Icon is grey if grid input is not present.

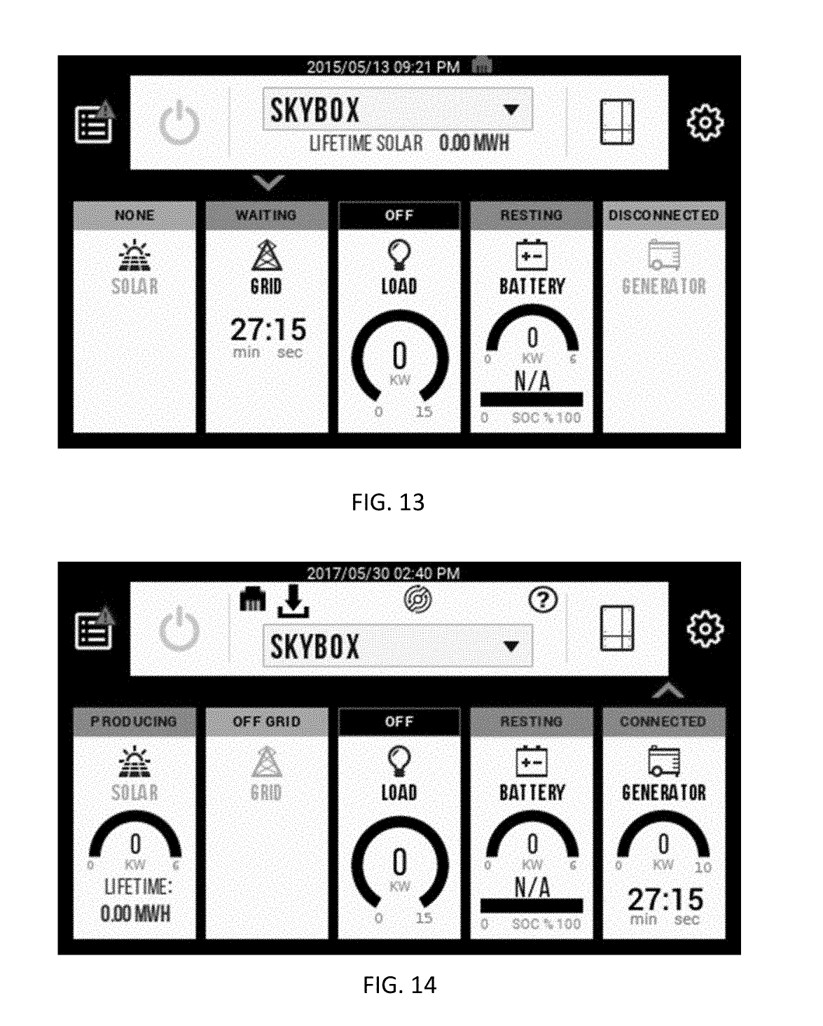

As examples, FIG. 12 illustrates the Grid Tile when the voltages associated therewith are out of specification, and FIG. 13 illustrates the Grid Tile when the source is within input range but the connection timer has not been met.

The Load Tile of the example home page of FIG. 11 is also interactive and operates as follows.
Description: The load tile provides a quick overview of power being used to sustain any currently running loads.
Behavior: Tapping any part of the tile navigates to the [Load Status] screen.
DAL Modes (load_status):
   OFF: Loads are not being powered, SkyBox is off.
      Text Displayed: “OFF”
      Banner Color: Black (white text)
      Arrow: None
   POWERED: Loads are being powered by Skybox
      Text Displayed: “POWERING”
      Banner Color: Green
      Arrow: Downwards
      Horseshoe Range: 0 kW to 10 kW
   SUPPORT: Loads are being supported by SkyBox and the grid to not exceed the Grid support kW threshold setting.
      Text Displayed: “SUPPORTING”
      Banner Color: Green
      Arrow: Downwards
      Horseshoe Range: 0 kW to 10 kW
   PASS_THROUGH: Loads are being powered by the AC Source.
      Text Displayed: “PASS THRU”
      Banner Color: Yellow
      Arrow: Downwards
      Horseshoe Range: 0 kW to 10 kW
   AC_COUPLE: The SkyBox is being powered through the load port.
      Text Displayed: “AC COUPLING”
      Banner Color: Yellow
      Arrow: Upwards
      Horseshoe Range: 0 kW to 5 kW
Appearance
   Icon is black if load input is configured as present.
   Icon is grey if load input is not present.

The Battery Tile of the example home page of FIG. 11 is also interactive and operates as follows.
Description: The battery tile provides a quick overview of power to and from an attached battery as well as the battery state of charge.
Behavior: Tapping any part of the tile navigates to the [Battery Status] screen.
DAL Modes (battery_voltage):
   battery_voltage=BATT_VOLTAGE_NA: No battery is available or connected to the unit.
      Text Displayed: “-”
      Banner Color: Grey
      Arrow: None
   battery_voltage !=BATT_VOLTAGE_NA: Battery is connected to the unit. UI must use the power reading to determine battery state.
      Charging (Negative): Power is being pushed to the battery.
         Text Displayed: “CHARGING”
         Banner Color: Green
         Arrow: Downwards
         Horseshoe Range: 0 to 5 kW
      Discharging (Positive): Power is being drawn from the battery
         Text Displayed: “DISCHARGING”
         Banner Color: Yellow
         Arrow: Upwards
         Horseshoe Range: 0 kW to 5 kW
      Resting: The battery is in a resting state when the power is −100 W [−0.09 kW] to 100 W [0.09 kW]. If the battery meets the resting state criteria, power will round to zero when shown.
         Text Displayed: “RESTING”
         Banner Color: Green
         Arrow: None
Appearance
   Icon is black if battery input is configured as present.
   Icon is grey if battery input is not present.

The Generator Tile of the example home page of FIG. 11 is interactive and operates as follows.

2. Generator Tile
Description: The generator tile provides a quick overview of an attached generator's status and power production.
Behavior:
   Tapping any part of the tile navigates to the [Generator Status] screen.
   The horseshoe showing kW power from the generator should only be shown when the generator's state is CONNECTED.
   Some modes have a timer, which counts time remaining or how long the generator has been connected.
DAL Modes (generator_status):
   OFF: Generator is powered down and disconnected.
      Text Displayed: “DISCONNECTED”
      Banner Color: Gray
      Arrow: None
   STARTING: Generator is online and preparing to start.
      Text Displayed: “STARTING”
      Banner Color: Yellow
      Arrow: None
   WARMUP: Generator is on and going through a warmup cycle.
      Text Displayed: “WARMING UP”
      Banner Color: Yellow
      Arrow: None
      Extra Behavior: Show timer
   EXERCISING: Generator is running due to exercise timer, but the relay is not closed.
      Text Displayed: “EXERCISING”
      Banner Color: Yellow
      Arrow: None
      Extra Behavior: Show timer
   COOLDOWN: Relay open, generator is preparing to shut down.
      Text Displayed: “COOLING DOWN”
      Banner Color: Yellow
      Arrow: None
      Extra Behavior: Show timer
   CONNECTED: Generator is running and the relay is closed. Power can be drawn from the generator.
      Text Displayed: “CONNECTED”
      Banner Color: Green
      Arrow: Upwards
      Horseshoe Range: 0 kW to 10 kW
      Extra Behavior: Show timer and KW meter
   WAITING_TO_CONNECT: Source is within input range but has not met connection timer.
      Text Displayed: “WAITING”
      Banner Color: Green
      Arrow: None
      Extra Behavior: Show timer
   OUT OF SPEC: Waiting for the voltage/frequency to reach acceptable levels.
      Text Displayed: “OUT OF SPEC”
      Banner Color: Yellow
      Arrow: None
      Extra Behavior: Show L1/L2/L3 voltages and frequency
Appearance
   Icon is black if generator input is configured as present.
   Icon is grey if generator input is not present.

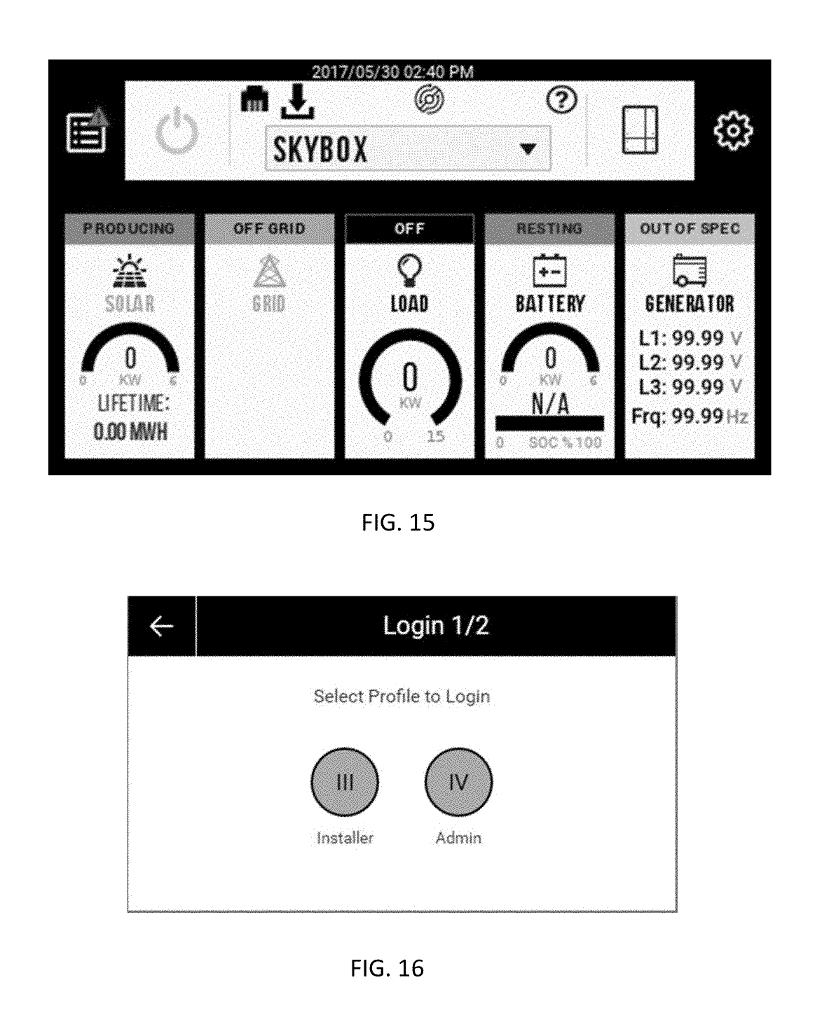

As examples, FIG. 14 illustrates the Generator Tile when connected, and FIG. 15 illustrates the Generator Tile when the voltages associated therewith are out of specification.

The example home page of FIG. 11 contains a System Notification Button that behaves as follows.
Description: The system notification button acts as a status indicator for any unread notifications.
Behavior:
   Navigation: Tapping the button will navigate to the System Notification screen.
   Unread Messages: If there are any unread messages, a symbol indicating the message category is shown covering the top-left portion of the System Notification Button. The icon used is the most severe unread message category.

The example home page of FIG. 11 contains a SkyBox Button (associated with the overall power control system 40) that behaves as follows.
Description: The SkyBox button acts as a navigational link to the SkyBox Status screen.
Behavior: Tapping the button navigates to the [Inverter Status] screen.

The example user interface contains a Settings Button that behaves as follows.
Description: The settings button acts as a navigational link to the global settings screen.
Behavior: Tapping the button navigates to the [Global Settings] screen.

The example home page of FIG. 11 further comprises an Icon Status Area that contains a number of status icons and is described below.
Description: Contains space for eight icons which indicate status as well as the help icon that can be used to get more information about other elements on the home screen.
Icons:
   Network Connection Status:
      Description: An icon that shows if the unit has network connectivity, type of network connectivity, and status of that connection.
      Behavior: Tapping the icon navigates to Network Settings 1: ‘Internet Connection’ Components
      Requirement:
         Good connection (icon)
         Limited connectivity (Yellow triangle over icon)
         No connection (Red X over icon)
   Firmware Update Available:
      Description: If shown, indicates that a newer version of firmware is available for download, or ready to be installed.
      Behavior: Tapping the icon navigates to Firmware Settings 1: ‘Firmware Updates
   OPTICS RE Connection Status:
      Description: If shown, indicates that OPTICS RE is enabled and working properly, or OPTICS RE is enabled, but has encountered an error.
      Behavior: Tapping the OPTICS RE icon navigates to Network Settings 4: OPTICS RE enrollment
   Help Icon:
      Description: Tapping the icon performs the features detailed in Help tool-tips.

The example home page of FIG. 11 further comprises a Current SkyBox dropdown selection that notifies the user which of a plurality of power control system 40 is being displayed and allows the user to switch among various power control systems 40.
Description: In a multi-SkyBox system this dropdown selection represents the currently viewed SkyBox unit.
   Dropdown: Tapping the button presents a dropdown list that allows a user to view a specific SkyBox unit or a general overview of all of them. In a single unit system, the dropdown should be disabled.
   Default should be specific to one single unit and reference the user specified system name, which defaults to “SkyBox”.

3. SkyBox On/OFF/Reset
Description: only one state will be enabled at a given time. Black circle indicates SkyBox OFF state, Green will represent ON state and Red will indicate the system is in a faulted state.
   ON State: Green color, when you push the button, SkyBox will turn off and the button will change to OFF state.
   OFF State: Black color, when you push the button SkyBox will turn on and the button will change to ON state.
   Partial Operation: Yellow color, when you push the button the user will be directed to the Inverter Fault Status page. This state is designated by the Inverter Reset and Off buttons being set to enabled at the same time
   Fault State: Red color, when you push the button SkyBox will attempt to clear all present faults and restart. If successful at clearing the faults and restarting, the button will change to the ON state.
   Disabled State: Grey color, pushing the button has no effect. This happens when the system controller determines that the system is in limbo mode because of various software or hardware communication issues. Details about the failure should be available in the alerts & logs screen. Service by a technician may be required to restore operation.

2. User Login

If a user attempts to access a setting or screen which requires permissions not granted to their current active profile, they should be given the opportunity to log in to the appropriate profile which has those permissions. This screen allows a user to login to a different profile with appropriate permissions so they can access restricted components. The login screen will only appear if access to particular components of the system has been restricted.

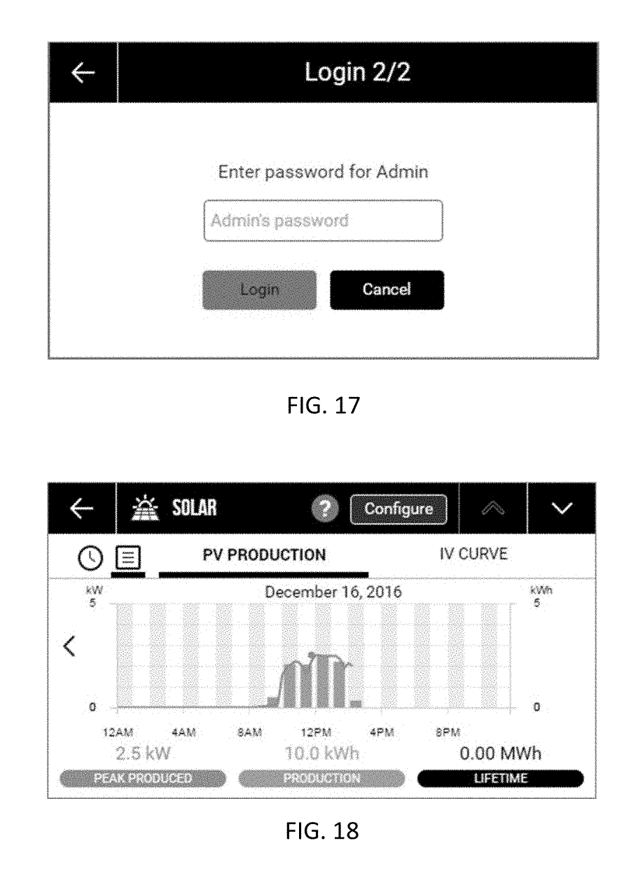

The user login screen of the example user interface system of FIG. 11 has two screens. A Profile Selection Screen as shown in FIG. 16, and a Login Screen as shown in FIG. 17. If a user is already logged in, but they do not have permission to access a particular feature, the login screen will appear. The only active options will be ones that have permission to perform that action. The other options will not be shown.

Depicted in FIG. 18 is an Automated User Login Scenario: Solar Status. A user using the Public Profile navigates to Solar Status by tapping the Solar Tile on the Home Screen. At the top of the screen, a Configure button is displayed on the Navigation Bar. When pressed, the Configure button will change pages to the Solar Configuration screen. When the user attempts to enter Edit Mode by pressing the Edit button they will be shown a login screen, allowing them to select the appropriate profile and login as required as described above. Once the password is entered successfully, the user is logged in to their chosen profile and moved to the page they were trying to access in Edit Mode.

Only one user is allowed to edit configuration at a time—subsequent users should be notified that the requested fields are not available for the moment while the first is editing. Resolution of multiple users may be resolved as follows.
1. Edit mode is entered by pressing the “Edit” or “Configure” button that appears in the upper banner of the screen.
2. If one user is currently in Edit mode, the Edit/Configure buttons on all other active sessions shall change to read “In Use”
3. At a minimum, UI should allow only one user to be in an edit mode at a time. However, if it is possible it would be preferred if the UI could allow multiple concurrent sessions to be in edit mode, as long as they are in separate areas. In other words, one user could be allowed to make changes in the Battery tab if another user is making changes in the Grid tab.
4. If multiple users attempt to enter edit mode simultaneously, the users shall be prioritized in the following order:
   1. Physical device
   2. Another Skybox connected on the same LAN
   3. A computer or device connected on the same LAN
   4. SunSpec
   5. Optics

### 3. Setup Wizard

The example user interface 160 implemented by the example power control system 40 may employ a Setup Wizard may function as follows.
The first time the wizard is run, the user has Administrator privileges without having to ask for them to log in. They are automatically an Administrator as long as they remain in the Wizard.
If the wizard is run again, the user must log in at the Installer level or above, before they are allowed to go through the questions.
If the user runs through the Wizard as an Installer, they cannot change the password for the Administrator account. Users can only change passwords for their own level or lower levels.
Owner level does not have permission to run the Wizard.

The Setup Wizard will identify the language preferred by the user and allow the user to load existing settings saved during a previous session using a USB drive. If the user does not have access to existing settings, the user is then prompted by the Setup Wizard to set Display Settings, Internet Settings (if available), and verify whether a firmware update may be required and a USB drive with a valid update package has been inserted into the system. The Setup Wizard then allows the user to input Regional Settings.

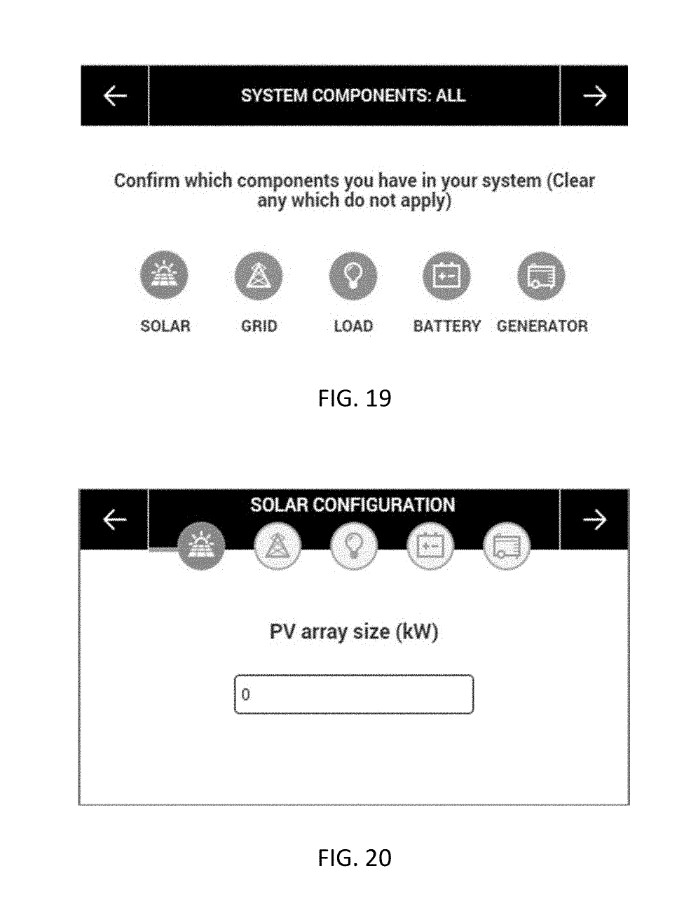

The Setup Wizard next allows the user to identify which components have been connected to the power control system(s) 40 as shown in FIG. 19. In FIG. 19, all selections are active by default (green with white lines) when the screen first loads. When an item is selected, the fill color turns grey and the icon lines become black. If an item is inactive when the user proceeds to the next screen, the questions relating to that entire section are skipped. If an item is active, then the questions for that section are shown. The user cannot proceed to the next screen unless at least two items are active.

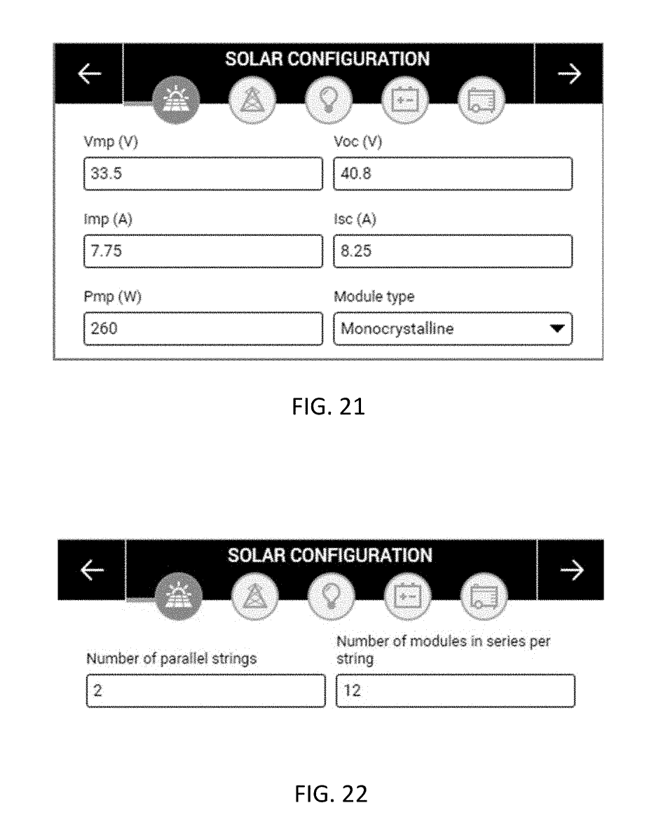

An example of Setup Wizard configuration pages allowing the configuration of the power control system 40 for a particular solar system is depicted in FIGS. 20, 21, and 22. The details of the function of the solar system configuration web pages depicted in FIGS. 20-22 will be explained in further detail below.

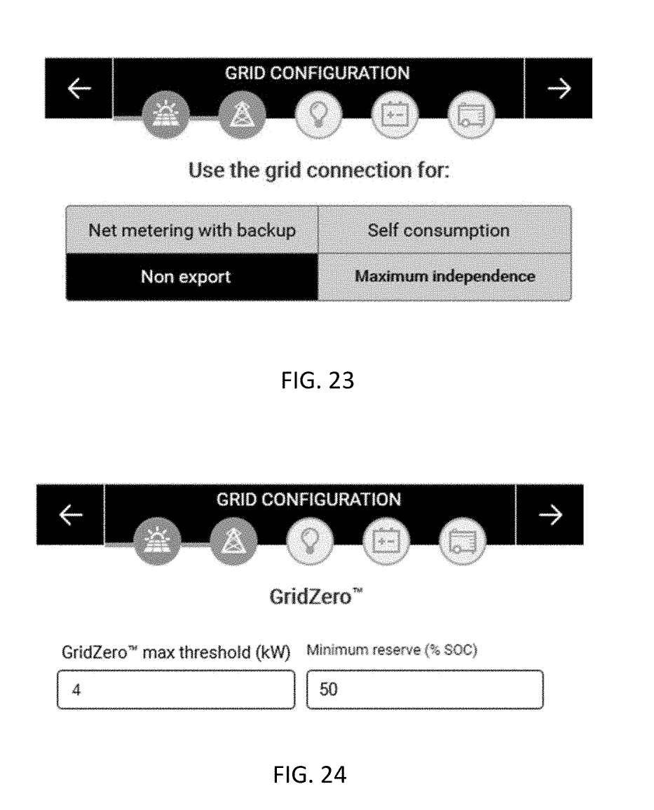

An example of Setup Wizard configuration pages allowing the configuration of the power control system 40 for a particular grid environment is depicted in FIGS. 23-33.

FIG. 23 allows the user to define the nature of the grid connection and operates as follows.

1. Operation:
Only one of the four buttons may be enabled at a time.
One of the four must be selected if they have grid.
“Non export” should be default.
If user selects a new button, the previously selected option should be deselected.

A. Net Metering with Backup:
Description: This selection maximizes energy harvest, has unrestrained selling of power to the utility, and batteries are primarily reserved for backup.
Behavior: PV is harvested and provided to loads and sold to the utility. Batteries are primarily reserved for backup. If the cost of utility energy varies, the batteries may be discharged during time periods where the cost of utility power is greater than the cost of battery power.

B. Self Consumption:
Description: This selection minimizes use of grid energy but excess generation is allowed to be sold to the utility in preference to going open-circuit. This application is typically used in regions where the cost of utility power is greater than the reimbursed rate for energy sold.
   i. If selected, display a follow-on screen (FIG. 28) with these inputs:
      GridZero™ max threshold (kW)
      Minimum reserve (% SOC)
Behavior: Skybox operates in parallel with grid, and will modulate output to displace grid power wherever possible with battery and PV power, up to the GridZero max threshold and down to the Minimum reserve (% SOC). Batteries are cycled. Once batteries are recharged and if all loads are met, SkyBox may export excess energy.

C. Non Export
Description: This selection maximizes Self supply, but power is not allowed to be exported;
   i. If selected, display a follow-on screen (FIG. 28) with these inputs:
      GridZero™ max threshold (kW)
      Minimum reserve (% SOC)
Behavior: SkyBox operates in parallel with grid, and will modulate output to displace grid power wherever possible with battery and PV power, up to the GridZero max threshold and down to the Minimum reserve (% SOC). Once batteries are recharged and all loads are met, the array may be open circuited to prevent excess generation.

D. Maximum Independence:
Description: This selection maximizes Independence.
Behavior: Skybox attempts to remain off-grid wherever possible. If the system is overtaxed or battery is depleted, Skybox will connect to grid and/or generator, transfer loads over to the AC source and recharge batteries from allowed sources. This mode does not export power to grid.

FIG. 24 illustrates a Setup Wizard screen that allows the user to set max threshold and minimum reserve (% SOC) for the power control system 40.

1. Attribute label: GridZero™ max threshold (kW):
Description: sets the boundary thresholds for GridZero™ operation to offset grid consumption
Behavior: If user selects either Self consumption or Non export as grid use, then present this screen

2. Minimum reserve (% SOC)
Description:—
Default: 50%

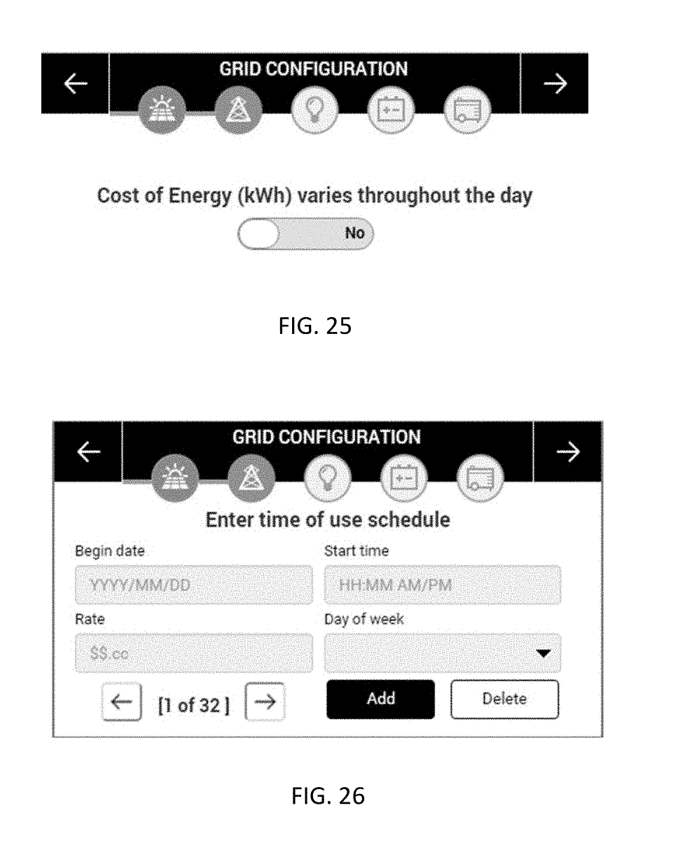

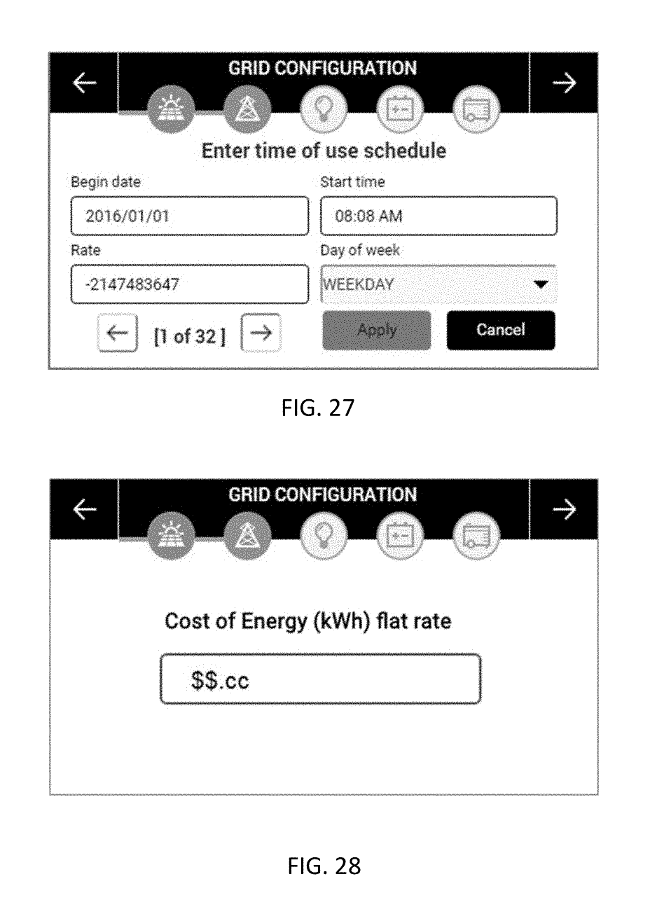

FIG. 25 allows the user to identify whether the cost of energy varies throughout the day. If yes, the system displays a schedule screen as shown in FIG. 27. If no, the system displays a flat rate screen as shown in FIG. 28.

The example Time of Use Schedule screen of FIG. 27 functions as follows.
a. There are two modes of behavior “View Mode” and “Edit Mode”.
   i. View Mode: The user has access to the options “Add” and “Delete” and can use the arrow keys to navigate between Time of Use schedules. The user can edit the four fields by selecting them. The user is in View Mode as long as the form is pristine and none of the fields have been edited.
   ii. Edit Mode: The user enters Edit Mode by changing an existing field, or adding a new schedule entry. The user has access to the options “Apply” and “Cancel”. The user cannot use the arrow buttons to navigate between schedule entries. The user must save their changes by pressing “Apply” or discard them by pressing “Cancel”.
      1. If the user attempts to exit the ToU schedule wizard, and they have unsaved changes, a warning dialog box should appear stating “Do you want to discard unsaved changes?”, with two options “Yes” and “No”. Selecting “No” will return the user to the schedule screen. Selecting “Yes” will exit the user from the ToU entry wizard.
b. If no schedule entries exist, the user is in view mode and the only available option is “Add”.
   Attribute Label 1: Begin date
a. Description: User input to set the beginning date of a rate schedule time block. The rate schedule time block is ended by the beginning of the next time block.
   Input: Day and Month to begin the schedule block.
   Day and Month order is displayed according to customer Regionalization preference (MM/DD or DD/MM).
b. Default Value:
   First instance: 01/01
   After Add another: Retain previous Begin date
c. Range:
   DD=01-31
   MM=01, 02, 03 . . .
d. Units:
   DD=Days
   MM=Months, as two number expression
e. Validation: This can be any valid date. The user does not have to enter them in order.
f. Behavior: Once customer completes the first tier and creates an additional tier using the Add another action button, the current Begin date should be retained as the default for the next tier screen
g. NOTE: a typical TOU schedule may have two Winter tiers (Peak, Off-peak) which begin in the Fall and remain in effect until the following Spring, and three Summer tiers (Peak, Off-peak, Mid-peak) through the summer months
   Attribute Label 2: Start time
a. Description: User input to set the beginning of a rate schedule time block. The rate schedule time block is ended by the start of the next time block
   Input: Time of day to begin the schedule block, in hours and minutes.
   Time is displayed according to customer Regionalization preference.
Default Value: 00:00
b. Range:
   12:00 AM-11:59 PM
      i. If user preference set to 12-hour clock
   00:00-23:59
      i. If user presence set to 24-hour clock
c. Units: Hours: Minutes.
d. Validation: This can be any time with a valid format.
e. Attribute Label 3: Day of week
a. Description: Drop-down User input to select which days of the week to apply this time interval
b. Default Value:
   a. Weekday (first instance)
   b. Previous selection (new tier screens)
c. Range:
   Weekday
   Weekend
   Daily
d. Units: Drop down selection
e. Behavior:
   If user selects Weekday, the TOU interval applies to all weekdays (MTWThF).
   If user selects Weekend, the TOU interval applies to Saturday and Sunday

### Attribute Label 4: Rate

a. Description: User input to set the value of a rate schedule block. The rate is the retail cost of energy during that time block
   Rate is displayed according to customer Regionalization preference (selected currency)
b. Default Value: 00.00
c. Range:
         $$=0-99
   Cc=0-99
d. Units: Determined by Customer regionalization preference.
   Typically, Dollars and cents, Euros
e. Behavior:
   When the value of Rate is greater than the value of the Battery $/kWh (IE, grid power is more expensive than battery power) Skybox shall give preference to self supply (GridZero™), powering loads from PV and battery up to the GridZero™ max threshold (kW) and down to the Minimum reserve (% SOC)
   When the value if Rate is less than or equal the value of the battery $/kWh, Skybox shall give preference to Selling excess PV production.
      Attribute Label 5: Add [action button]
a. Description: Action button for User input to create a new Time of Use schedule tier
b. Behavior:
   When selected, Skybox UI shall create and present a new ToU schedule page for inputting the next time block.
   The new page will start in Edit Mode. If the user selects “Cancel” without saving the new ToU schedule entry, then the entry will be discarded and the previous entry should be shown in View Mode. If the user selects “Apply” they should transition to View Mode for this record after it is saved to disk.
   Each new ToU schedule page shall increment the Y value
   The current Begin date should be retained as the default for the next tier screen.
      Attribute Label 6: Delete [action button]
a. Description: Action button for User to delete the current ToU schedule that is being viewed.
b. Behavior:
   When selected, Skybox UI shall delete the current ToU schedule.
   The screen should revert to View Mode and show the previous schedule if it exists, or the next schedule if no previous schedules exist. If no other schedules exist a screen with [0 of 0] should be shown with the only enabled option being “Add”.
   Each deleted ToU schedule page shall decrement the aggregate Y value

### Attribute Label 7: [X of Y]

a. Description: Counter to show the current viewed Time of use schedule tier
   X=the currently visible ToU tier
   Y=the total number of ToU tiers
b. Default Value: [0 of 0]
c. Range:
   0-32

### Units: Integer

d. Behavior:
   The value 0 is reserved for when no ToU schedule entries exist. In this situation [0 of 0] should be displayed and the only option available to the user is “Add”. When the user creates the first schedule it should switch to [1 of 1]. It is not possible to navigate to record 0 with the arrow keys.
   As user navigates through each ToU schedule tier page, the X value shall show the current page number
   The Y value shall show the total number of user created ToU schedule tier pages
   Maximum range of 32 schedule tiers is set to coordinate with SunSpec maximum #
      Attribute Label 8: Previous Arrow [<-] [action button]
a. Description: Button to navigate to the previous ToU schedule
b. Behavior:
   When pressed navigates to the previous ToU schedule in the list. The X value which indicates the current screen will update appropriately.
   If the user is on the first entry this action will wrap around to the last.
   If no entries exist this button is disabled.
   If the user is in Edit Mode, this is disabled.
      Attribute Label 9: Next Arrow [−>] [action button]
a. Description: Button to navigate to the next ToU schedule
b. Behavior:
   When pressed navigates to the next ToU schedule in the list. The X value which indicates the current screen will update appropriately.
   If the user is on the last entry this action will wrap around to the first.
   If no entries exist this button is disabled.
   If the user is in Edit Mode, this is disabled.
      Attribute Label 10: Apply [action button]
c. Description: Action button for User to save an edited ToU schedule.
d. Behavior:
   When selected, Skybox will save the ToU schedule to disk.
   After the data is saved the user should be returned to View Mode for the current record.
      Attribute Label 11: Cancel [action button]
c. Description: Action button allowing User to discard the current changes for the ToU schedule that is being viewed.
d. Behavior:
   When selected, Skybox shall ignore any changes done to the schedule.
   If the schedule was a new schedule created with the “Add” button, then SkyBox should return to the previous record in View Mode if one exists.
   If an existing schedule was being edited, those changes should be discarded and the user should be returned to View Mode for the schedule they are viewing.

In FIG. 28, the user enters a flat rate for cost of energy. When the value of Rate is greater than the value of the Battery $/kWh (IE, grid power is more expensive than battery power), the system may give preference to self supply (GridZero™), powering loads from PV and battery up to the GridZero™ max threshold (kW) and down to the Minimum reserve (% SOC). When the value of Rate is less than or equal the value of the battery $/kWh, Skybox shall give preference to Selling excess PV production.

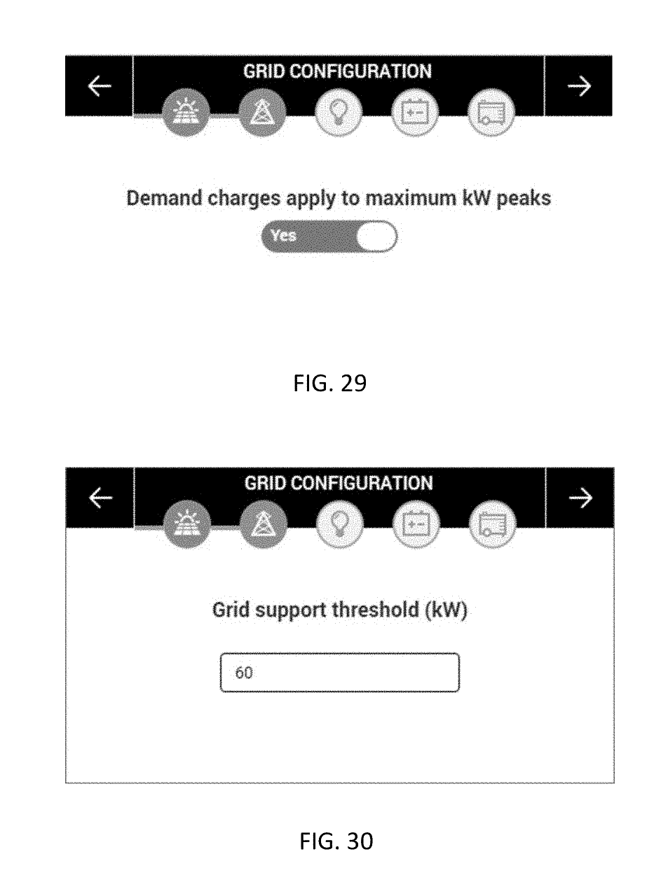

FIGS. 29 and 30 illustrate Demand charge reduction screens. FIG. 29 allows the user to determine whether demand charges apply to maximum kW peaks. If yes, the batteries may be discharged to support loads that exceed a given threshold in order to reduce utility demand charges. If Yes is selected in FIG. 29, a follow-on screen is displayed allowing the user to set a Grid support threshold value (kW) as shown in FIG. 30.

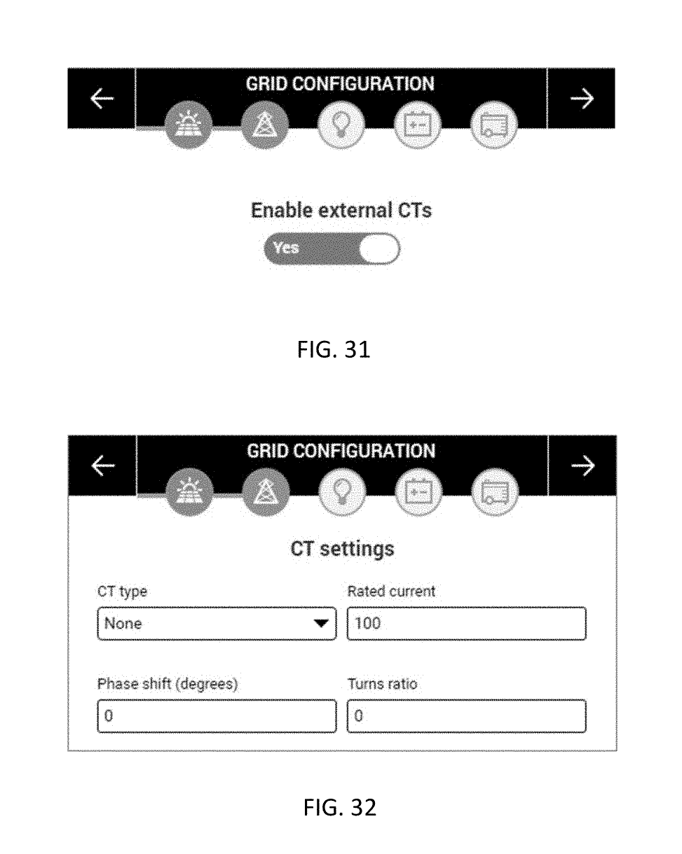

FIGS. 31 and 32 depict Grid Connection Demand Cap screens that may be displayed by the Setup Wizard. In FIG. 31, the user is allowed to enable external CT, and, if external CT is enabled, FIG. 32 allows the user to enter CT settings.

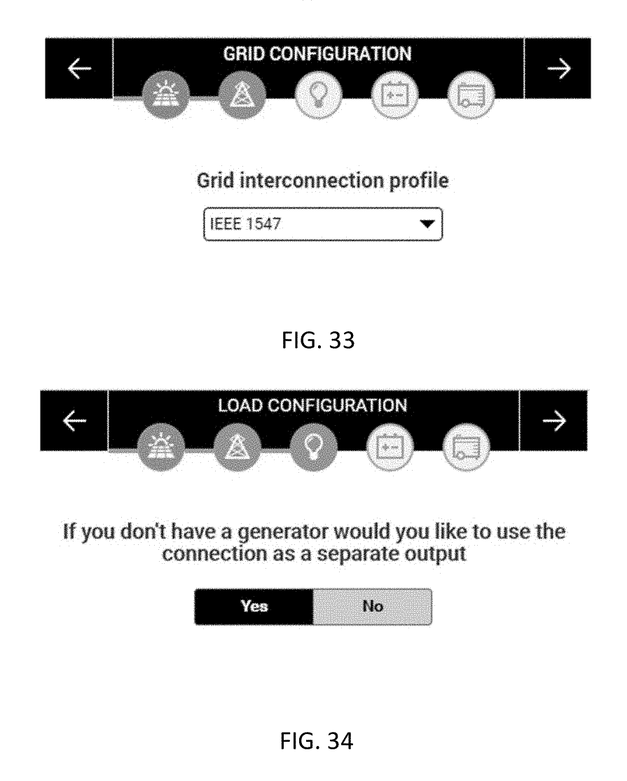

FIG. 33 illustrates a Grid Interconnection Profile that allows the user to select a grid interconnection profile such as IEEE 1547, HECO1, HECO2, CA Rule 21, AS4777, and VDE410. Any selection made here should be mapped to the configuration screen. Selecting a standard should auto populate the grid interconnection fields with the associated default value

FIGS. 34-38 illustrate user interface screens that allow the user to configure the interaction of the power control system 40 with the load 26. The page depicted in FIG. 34 is displayed only if a generator is not selected. If no generator is connected to the power control system 40, the output node 22 normally associated with a generator is reassigned to be a controllable load output. In particular, the fifth power node or electrical connection of the example power control system 40 can be reassigned to be an output which can be energized or de-energized independently of the primary output. In this case, FIG. 34 allows the user to use the generator connection as a separate, controllable output. If the user answers Yes, the generator tile on the home screen is changed to represent a controllable load and to display load oriented settings in status and configuration.

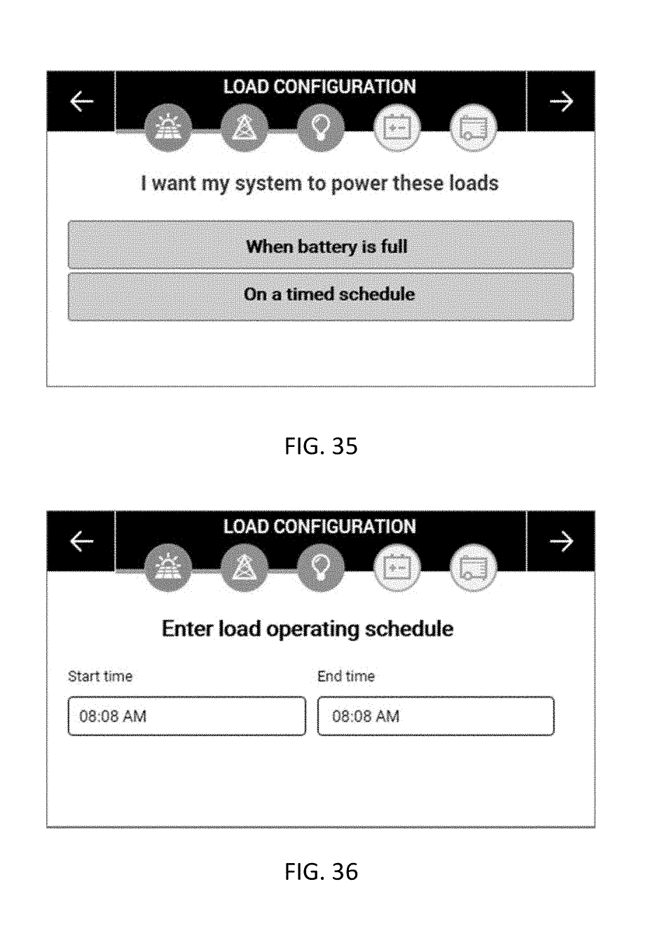

Accordingly, FIGS. 35 and 36 are displayed only if the generator connection is used as an output. FIG. 35 determines when the output defined by the generator connection is used to supply power to the loads connected thereto, and, if a timed schedule is selected, FIG. 36 allows the user to determine the load operating schedule.

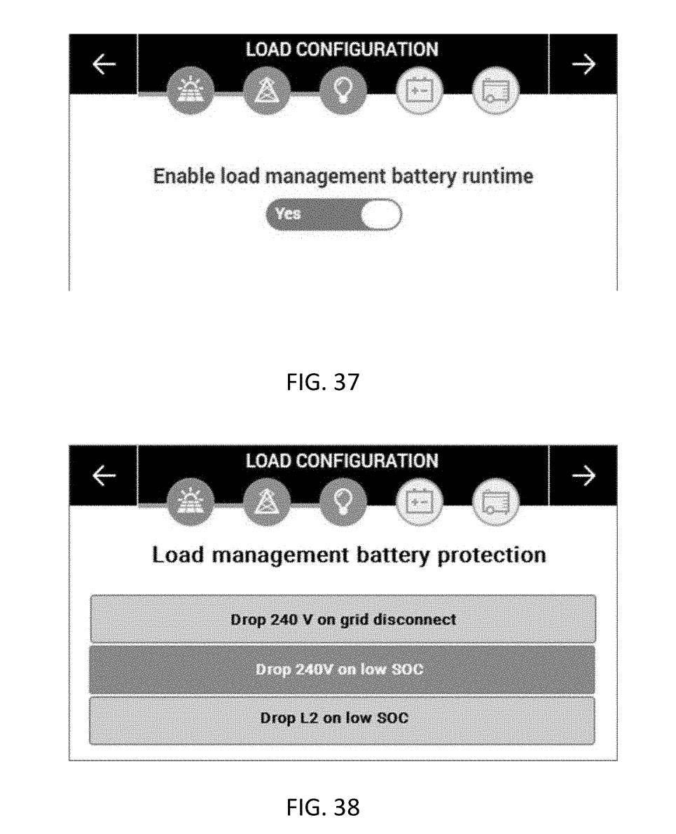

If the generator connection is not used as an output and a generator is connected thereto, the load configuration pages depicted in FIGS. 37 and 38 are displayed to the user. FIG. 37 allows the user to enable load management battery runtime, while FIG. 38 allows the user to define how to implement load management battery protection.

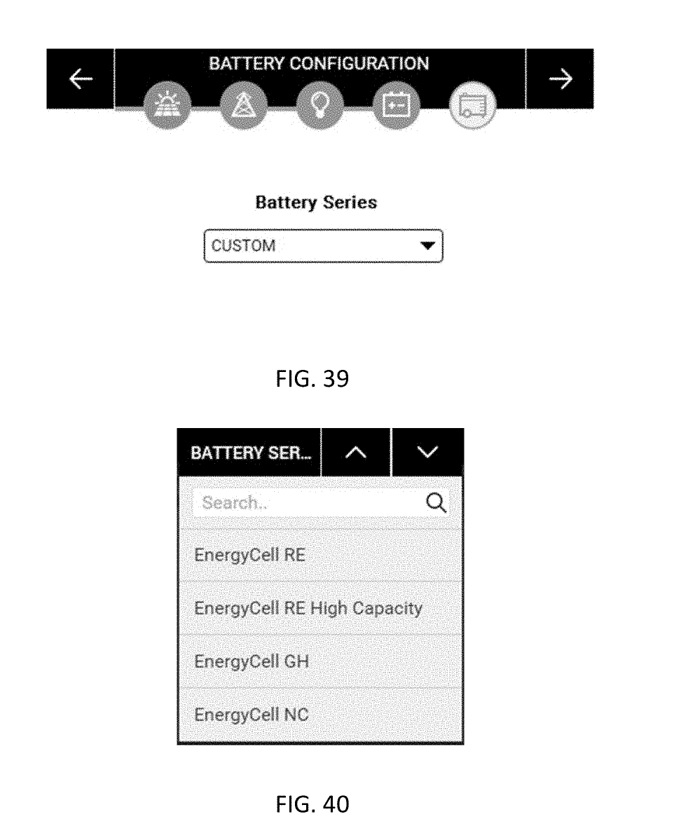

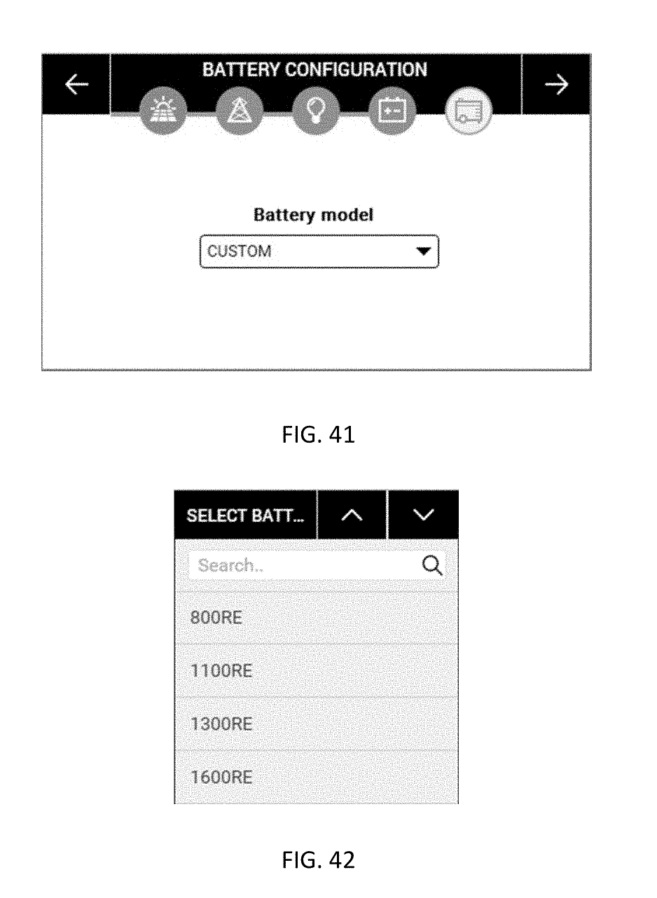

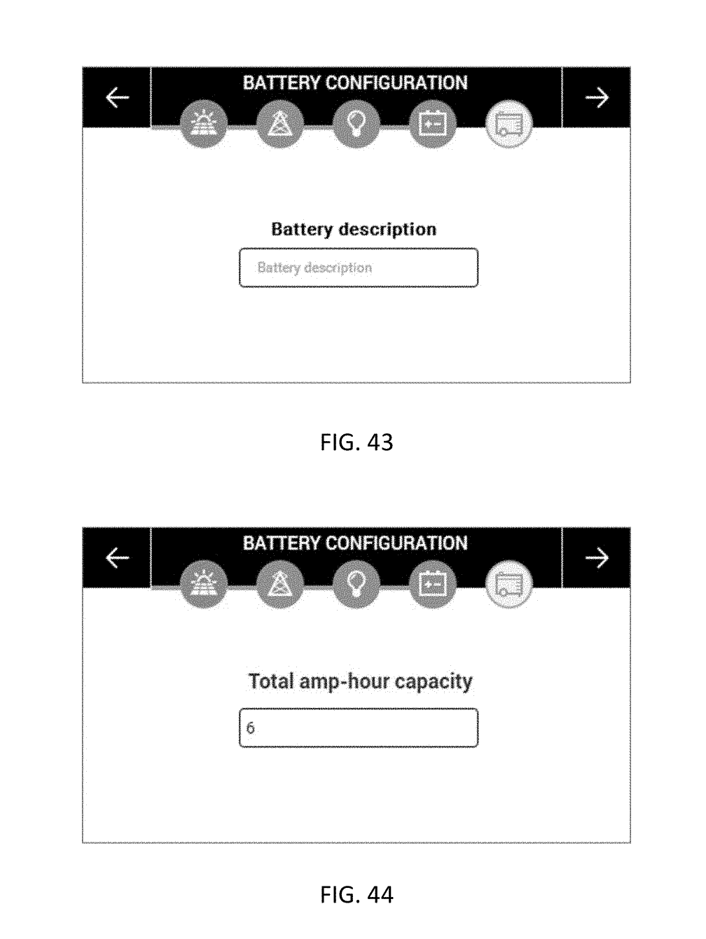

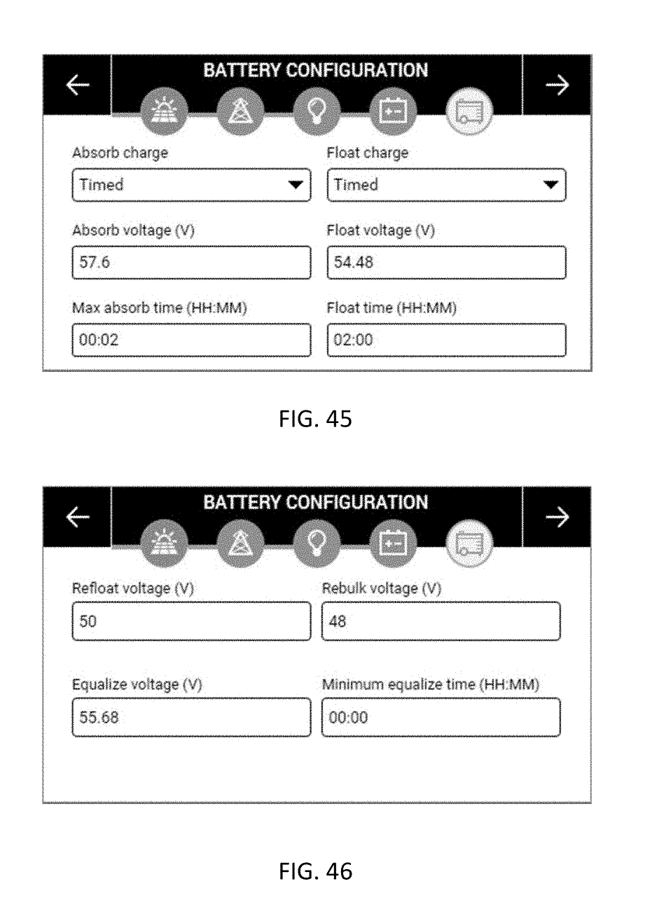

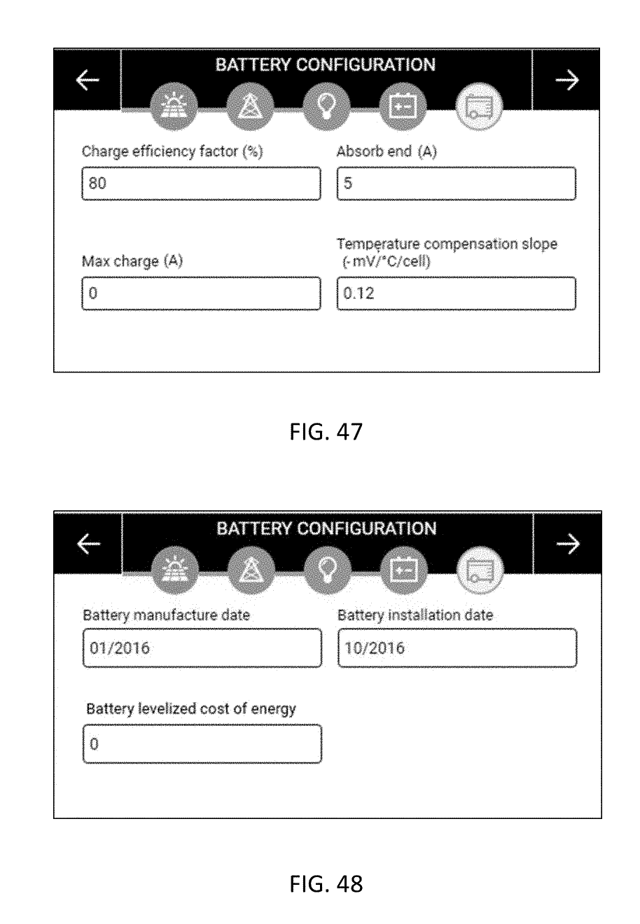

FIGS. 39-48 illustrate screens displayed by the Setup Wizard to allow configuration of the power control system 40 for a particular battery system connected thereto. The details of the function of the battery system configuration web pages depicted in FIGS. 39-48 will be explained in further detail below.

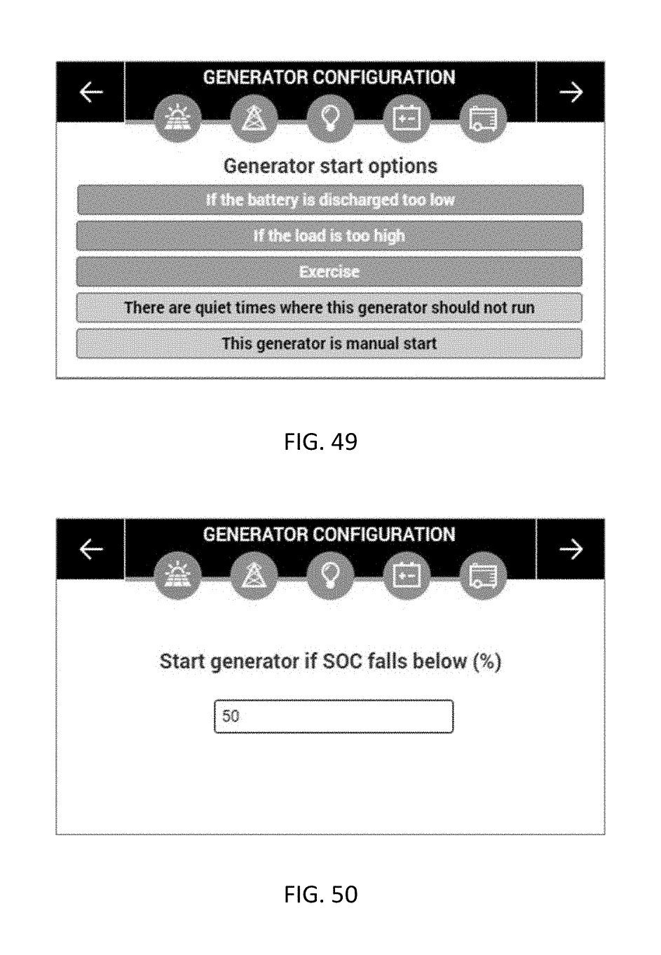

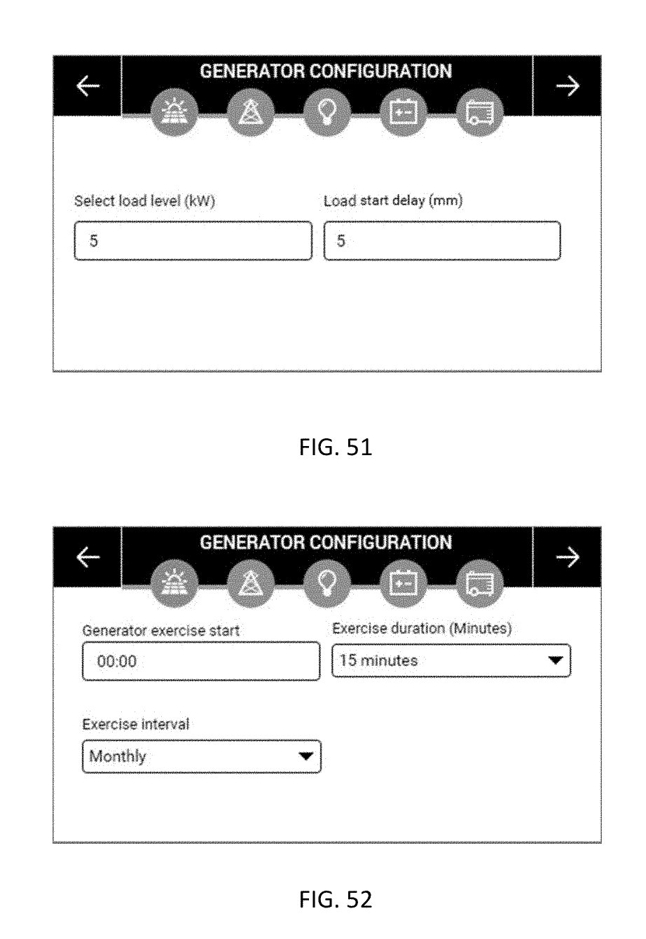

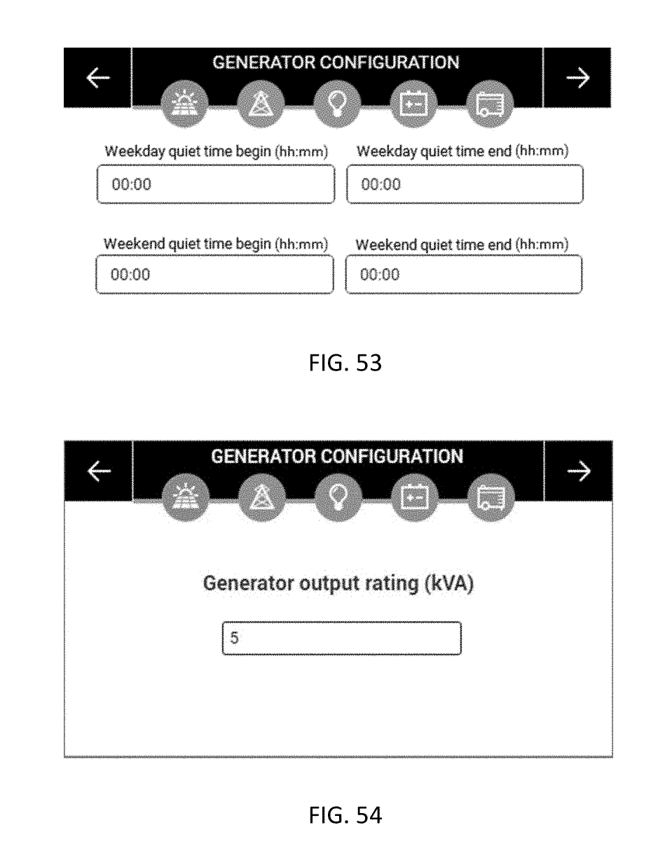

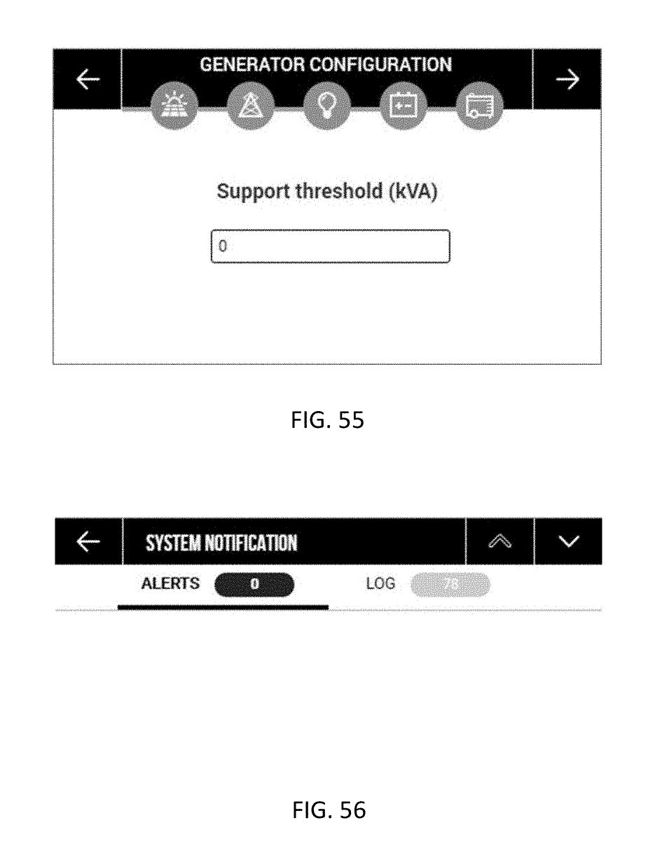

FIGS. 49-55 illustrate screens displayed by the Setup Wizard to allow configuration of the power control system for a particular generator system connected thereto.

In the example web page depicted in FIG. 49, all selections are enabled by default, with the exception of “This generator is manual start”. Multiple selections are allowed. If “manual start” is selected, all other selected items are cleared. If “manual start” is selected and another item is selected, manual start is cleared (ie, system can either be manual start or any and all of the automatic start options, but not both). Active checkbox items should have a green background to indicate that they are “ON”.

The following list explains the effect of selection of each item depicted in FIG. 49:
1. If the battery is discharged too low=ags_start_on_soc_enabled is true.
2. If the load is too high=ags_start_on_load_enabled is true.
3. Exercise=ags_exercise_enabled is true.
4. There are quiet times when this generator should not run=ags_quiet_enabled is true.
5. If any of the above options are selected ags_enabled is also set to true.
6. If This generator is manual start is selected ags_enabled, ags_start_on_soc_enabled, ags_start_on_load_enabled, ags_quiet_enabled, ags_exercise_enabled are all set to false.

The details of the function of the generator configuration web pages depicted in FIGS. 50-55 will be explained in further detail below.

### 4. System Notification

Example system notification web pages will now be described with reference to FIGS. 56 and 57.

The system notification alerts page depicted in FIG. 56 is accessed by pressing the notification icon in the top left corner of the home screen. It contains two tabs: Alerts, and Logs. The button next to the tab name shows a number which indicates the amount of unread notifications in that tab. The Alerts tab is selected in FIG. 56

If the user clicks on this number, a dialog box will appear asking them if they would like to mark all notifications as read. The user also has the ability to mark individual messages as being read by clicking on them. If user is logged in as Public profile, the login prompt shall be provided if they click either unread notifications number. The system may configure such that only certain user profiles are allowed to mark messages as read.

When the Log tab is selected, a log of system notifications is displayed as shown in FIG. 57.

### 5. System Status

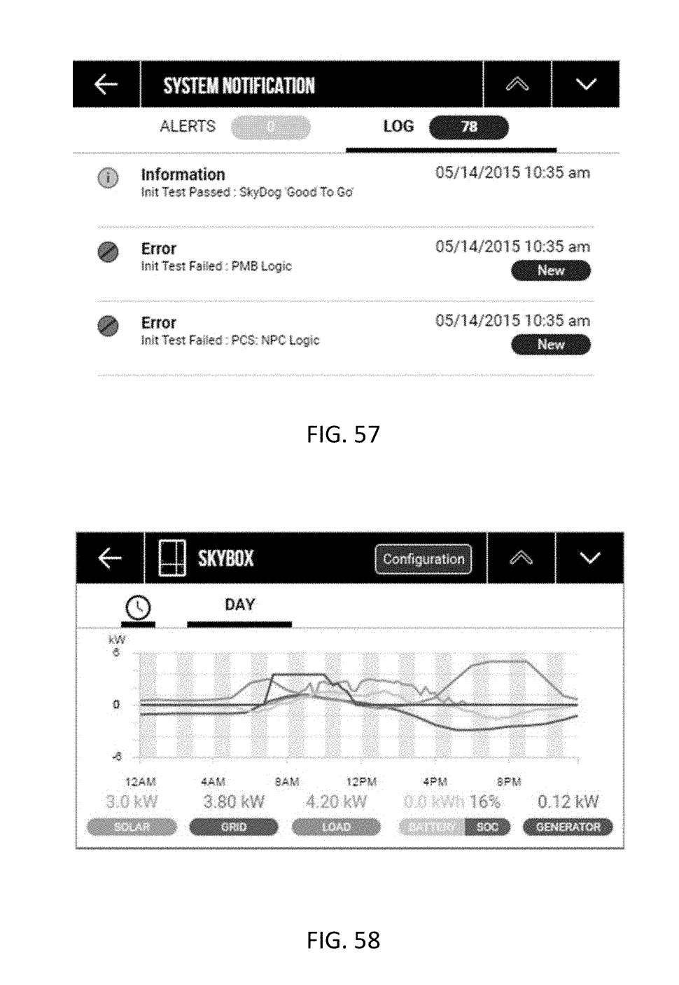

Example system status web pages indicating the status of the power supply system 20 and/or power control system(s) 40 forming a part thereof (referred to in the drawing as SkyBox) will now be described with reference to FIGS. 58-62.

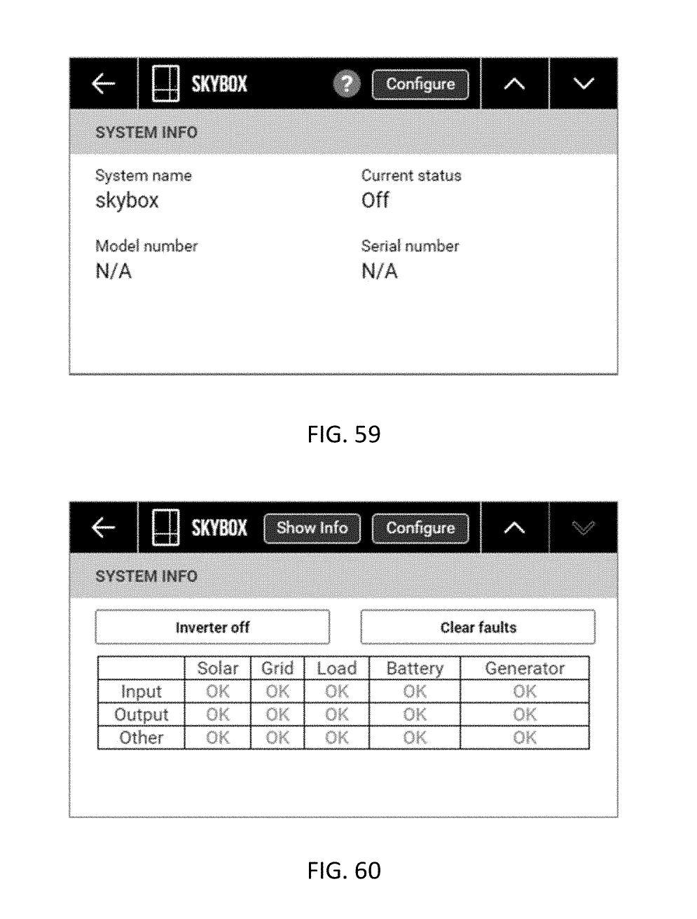

The web page depicted in FIG. 58 contains various graphs related to overall system usage by all major components of the power supply system 20, power control system(s) 40, and/or any auxiliary power nodes 22 operatively connected thereto. The web page depicted in FIG. 58 depicts a first example page of system information, while the web page depicted in FIG. 59 depicts a second example page of system information. In particular, FIG. 59 contains a system name, current status, Model number, and Serial number of the power control system 40.

FIG. 60 depicts a web page illustrating a listing fault status associated with the inverter forming a part of the example power control system 40. The user navigates the screen in FIG. 60 using the up and down arrows. The user may be redirected to this page if there are faults active while the inverter is still on (Partial Operation). The user interface will send the user to this screen if the Home Screen power button is pressed while Yellow.

The screen depicted in FIG. 60 includes a fault table and two buttons: Clear Faults and Inverter Off. These enable
The buttons are:
   ‘Clear Faults’ and ‘Inverter Off’
   Enable/disable states for these 2 buttons are controlled by the master daemon running on the local controller 142
   Clear Faults will send a Reset Faults command to the master daemon
      If faults fail to clear, then master daemon will keep this button enabled and update the table
   Inverter Off will send an Inverter Off command to master daemon
The table consists of 15 uint16 values that master daemon sets to change the cell entries
   values between OK (0) to ddddd (code 1 to 65535)
   code is ORed fault flags for tech service to use
This is an example table:

| | Solar | Grid | Load | Battery | Generator |
|---|---|---|---|---|---|
| Input | OK | OK | OK | OK | OK |
| Output | 880 | OK | OK | OK | OK |
| Other | OK | 64 | OK | OK | OK |

### 6. Configuration of Power Control System

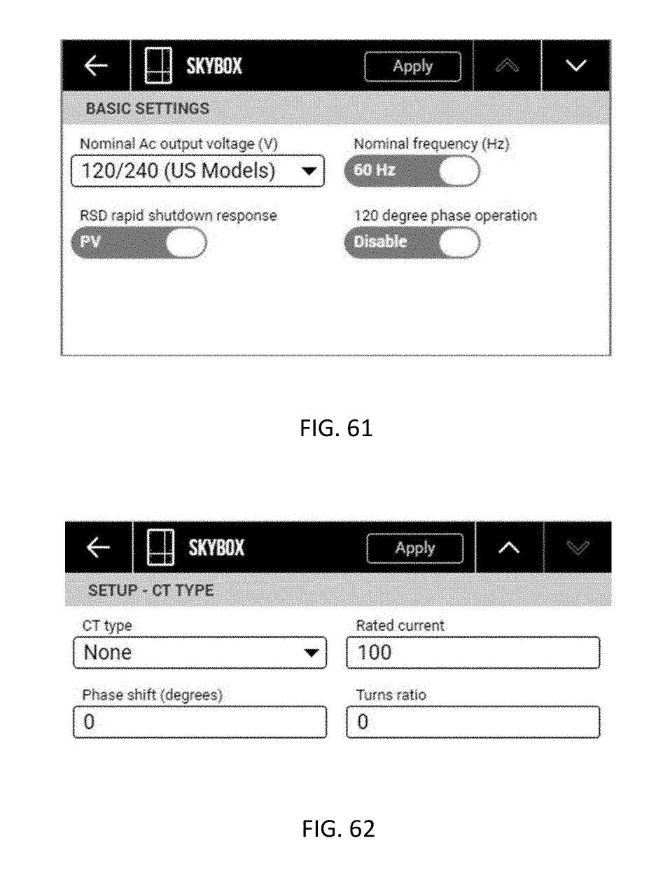

Example web pages that allow the configuration of a power supply 20 and/or power control system 40 of the present invention are depicted in FIGS. 61 and 62. The example page depicted FIG. 61 allows access to a set of basic power control system settings as identified below.

1. Nominal AC output voltage (V)
a. Description: Nominal AC voltage for the SkyBox operation.
b. Range: Dropdown selection
   i. 100/200 (US models)
   ii. 120/240 (US models)
   iii. 127/254 (US models)
   iv. 230 (EU models)
c. Default: 120/240
d. Unit: VAC
e. Behavior: Popup window requiring confirmation
   i. Text: “Please confirm you wish to change the operating voltage”
      1. “OK” sets change to the selected value
      2. “CANCEL” Reverts value to its current setting.

2. Nominal frequency (Hz)
a. Description: (Toggle) Allows the user to select the AC output frequency at which their inverter operate.
b. Input type: Toggle
c. Toggle options:
   i. 50 Hz
   ii. 60 Hz
d. Default: 60 Hz (A models)
e. Unit: Hertz (Hz)
f. Behavior: Popup window requiring confirmation
   i. Text: “Please confirm you wish to change the operating frequency”

3. RSD rapid shutdown response
a. Description: Area for installers to select which connections are controlled by RSD signal
b. Help Tip: PV enabled is required for areas complying with NEC 2014.
c. Input Type: Toggle
d. Toggle options:
   i. PV
   ii. PV and AC
e. Default: PV

4. 120 degree phase operation
a. Description: Selection to allow operation across two phases of a three phase electrical source
b. Help Tip: Allows operation across two phases of a three phase electrical source.
c. Input Type: Toggle
d. Toggle (options):
   i. Enable
   ii. Disable
e. Default: Disable
f. Behavior: Popup window requiring confirmation
   i. Text: “Please confirm you wish to change the phasing angle”

FIG. 62 illustrates an example of a Setup—CT Type page that forms a part of the power control system configuration process. This web page allows definition of the type of current transformer use in association with the power control system 40 as follows.

1. CT type
a. Description: Allows user to specify a connected current transformer.
b. Input Type: Dropdown
c. Dropdown (options):
   i. None
   ii. OB CT-500
   iii. OB CT-1000
d. Default: None

2. Rated Current
a. Description: This is the maximum rated current for the CT.
b. Input Type: Numeric
c. Range: 1-1000
d. Default Value: 100
e. Units: Amps

3. Phase shift (degrees)
a. Description: This percentage will determine the phase shift percentage required for each CT in use.
b. Input Type: Numeric
c. Range: −9.0 to 9.0
d. Default: 0.0
e. Units: degrees

4. Turns ratio
a. Description: This is the design turns ratio for the CT in use.
b. Input Type: Numeric
c. Range: ?
d. Default: ?
e. Units: degrees

### 7. Solar System Status

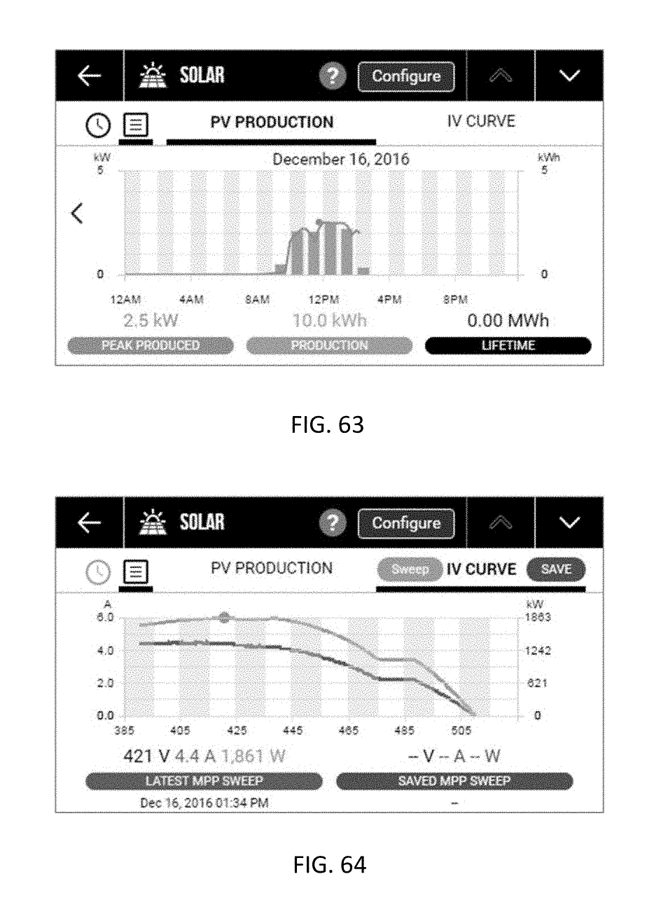

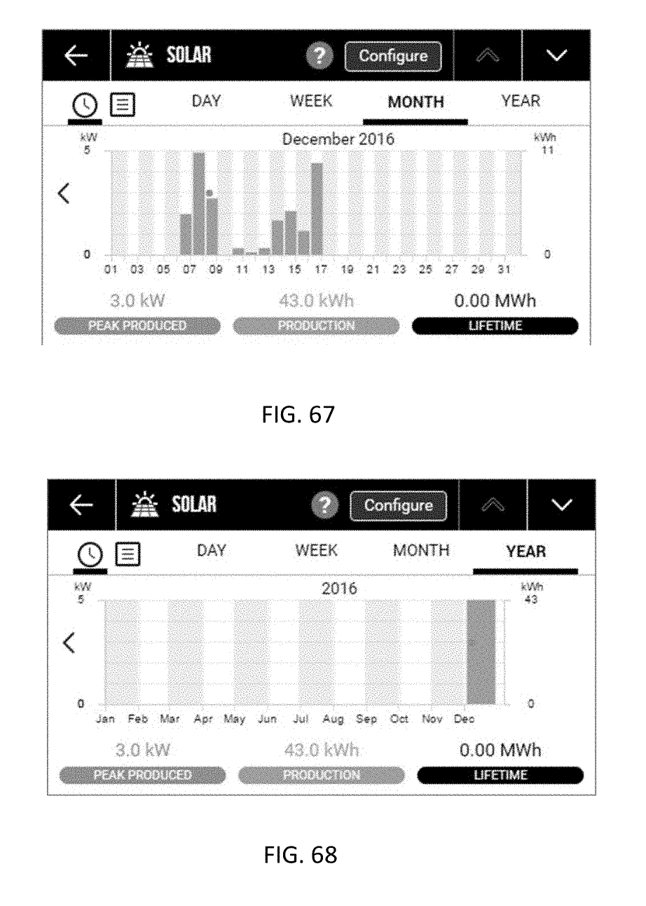

FIGS. 63-70 illustrate example web pages that may be displayed to communicate status of a solar system operatively connected to the power control system 40.

FIG. 63 depicts a solar photovoltaic production screen that may be used to communicate status of the solar system.

FIG. 64 depicts a Solar I-V Curve Screen that functions as follows.

1. Sweep
a. Description: Action button which initiates a MPP sweep, generating a new IV curve
b. Input type: Button
c. Location: to the left of the text IV Curve. Color: orange (please change the color of Save button to blue, to coordinate with the blue Saved MPP Sweep)
d. Behavior: Upon initiation, SkyBox will initiate a MPP sweep, and display the results as the Latest MPP Sweep.
   i. User can initiate any number of sweeps, and each sweep will replace the Latest sweep.

2. Save:
a. Description: User can, at any time, save the latest sweep, at which point it becomes the Saved MPP sweep.
   1. Only one sweep can be saved at any one time.
   2. A popup window will require confirmation.
   3. Text: “Do you want to replace the previous saved sweep?”
   4. “Yes” (Green button), or “Cancel”
   ii. Sweep and Save are available to Admin and Installer
   iii. Sweep is also available to Owner
iv. Sweep and Save buttons should only be visible while on the IV CURVE tab to avoid confusion
   v. If the user doesn't have permission to perform a sweep or save, the button should be disabled and change to a gray color with white text.

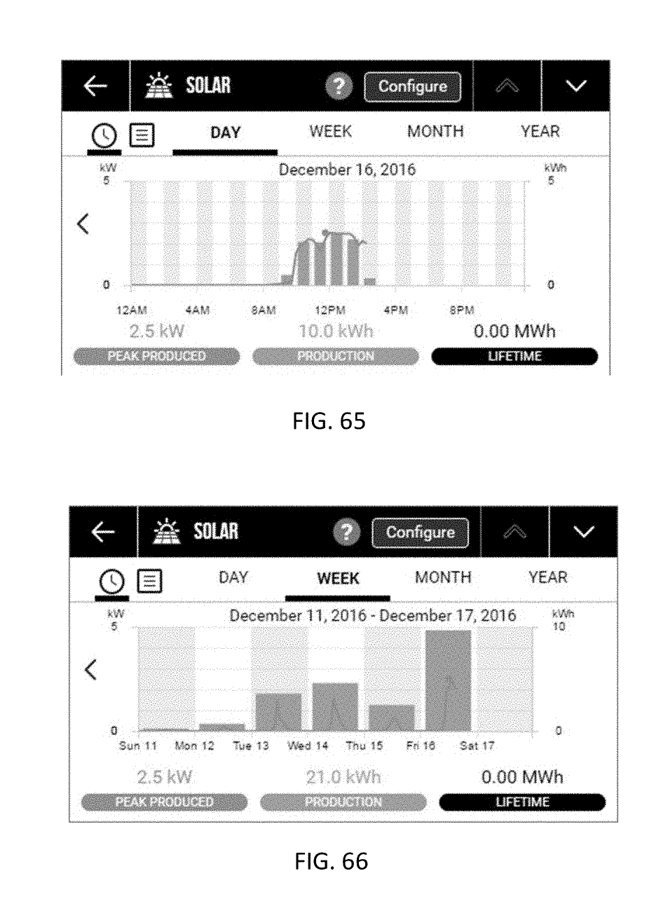

FIGS. 65-68 illustrate a solar production graph page in Day, Week, Month, and Year modes of display, respectively.

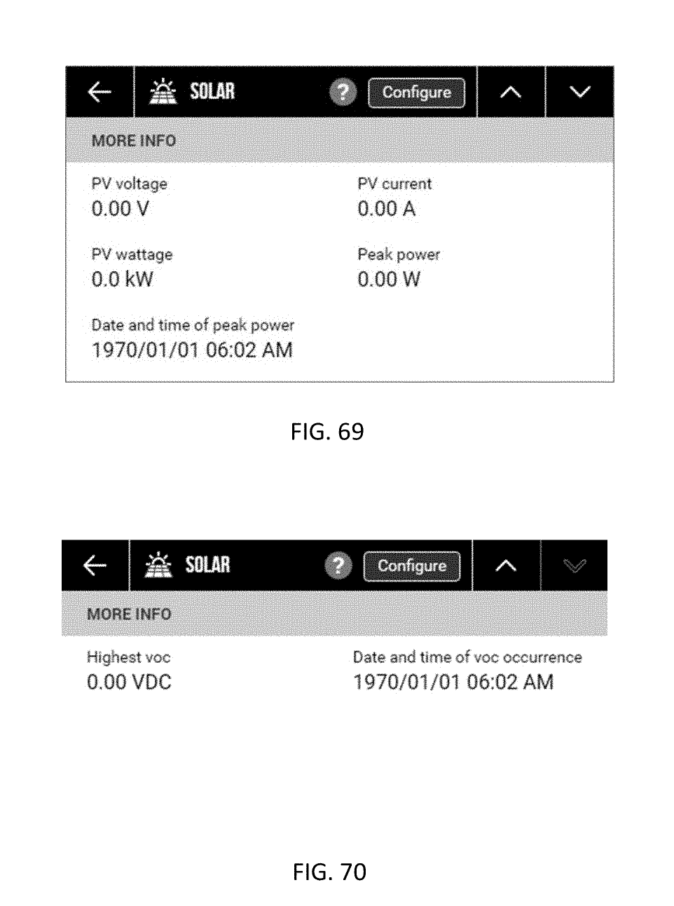

FIGS. 69 and 70 illustrate first and second More Information pages that communicate the following information.

The first More Information screen in FIG. 69 contains five passive components as follows:

1. PV voltage
Description: A reading of the system's photovoltaic voltage at that moment.
Units: Volt (V)

2. PV current
Description: A reading of the system's photovoltaic current at that moment.
Units: Ampere (A)

3. PV wattage
Description: A reading of the system's photovoltaic power at that moment.
Units: Kilowatts (kW)

4. Peak power
Description: A record of the system's highest PV wattage reading.
Units: Watts (W)

5. Date and time of peak power
Description: The date and time that the last peak power reading was recorded.
Format: General date and time format ‘YYYY-MM-DD HH:mm’ (Or other format based on currently desired user time format.)

The second More Information screen in FIG. 70 contains two passive components as follows:

1. Highest Voc
Description: The system's highest open circuit voltage (Voc) reading.
Units: Voltage DC (VDC)

2. Date and time of Voc occurrence
Description: The date and time that the last highest Voc reading was recorded.
Format: General date and time format ‘YYYY-MM-DD HH:mm’ (Or other format based on currently desired user time format.)

### 8. Solar System Configuration

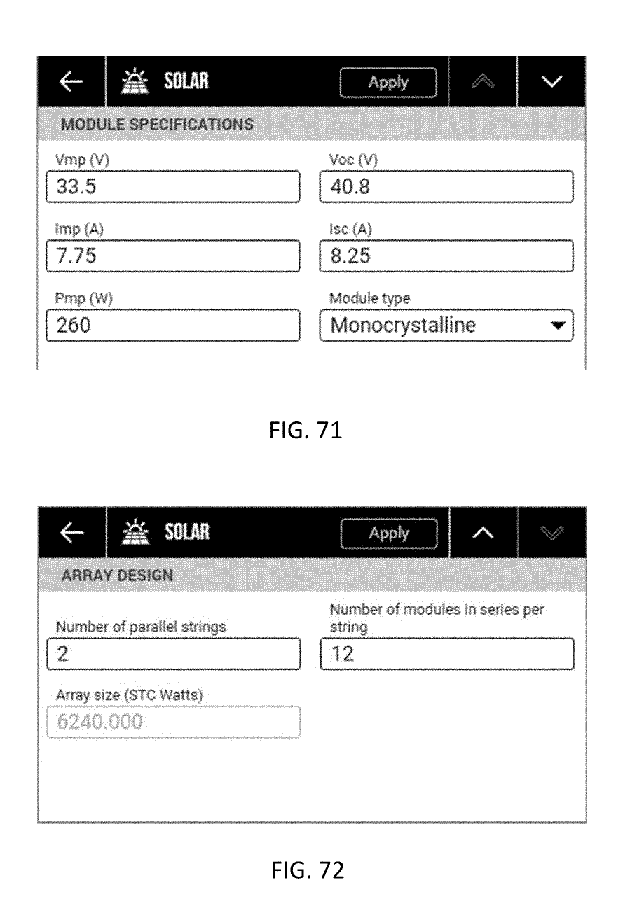

FIGS. 71 and 72 illustrate example web pages that may be displayed to allow configuration of a solar system operatively connected to the power control system 40.

FIG. 71 allows users to view and modify the module specifications of the solar system connected to the power control system 40 and functions as follows.

1. Vmp (V)
Description: Voltage maximum power (Vmp) represents the voltage at which a single solar module will be able to produce its maximum power output.
Range: 24 to 100
Default: 33.5
Units: V (Volts)

2. Voc (V)
Description: Voltage open circuit (Voc) represents the output voltage across a single module when no current is flowing. This measurement is typically taken under controlled temperatures in full sunlight.
Range: 25 to 100
Default: 40.8
Units: V (Volts)

3. Imp (A)
Description: Current maximum power (Imp) represents the maximum amount of current a solar module will produce under Standard Test Conditions.
Range: 0 to 30
Default: 7.75
Units: A (Amperes)

4. Isc (A)
Description: Current short circuit (Isc) represents the peak current a single solar module can produce with its output shorted.
Range: 0 to 30
Default: 8.25
Units: A (Amperes)

5. Pmp (VV)
Description: Power maximum power (Pmp) is the maximum power rating of a single module during peak sun conditions.
Range: 0 to 500
Default: 260
Units: W (Watts)

6. Module Type
Description: (Dropdown) Solar panel type selection.
   Monocrystalline
   Polycrystalline
   Thin film
Default: Monocrystalline

FIG. 72 depicts an example web page that allows the user to specify the array design of the overall solar array. The web page of FIG. 72 contains two active and one passive items and functions as follows.

1. Number of parallel strings
Description: Total number of strings that make up the array.
Default: 2

2. Number of modules in series per string
Description: Number of modules per each string section in the array.
Default: 12

3. Array size (STC Watts)
Description: A passive calculation of the total size of the solar array.
   i. Calculation is Number of Strings*Number of modules per string*Pmp
   ii. This field should not be editable by the user

### 9. Grid Status

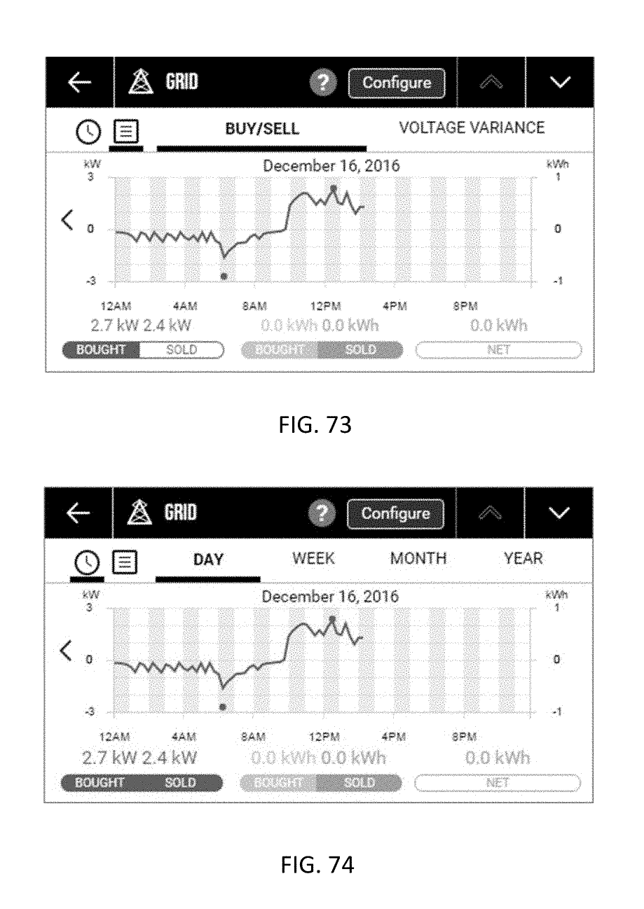

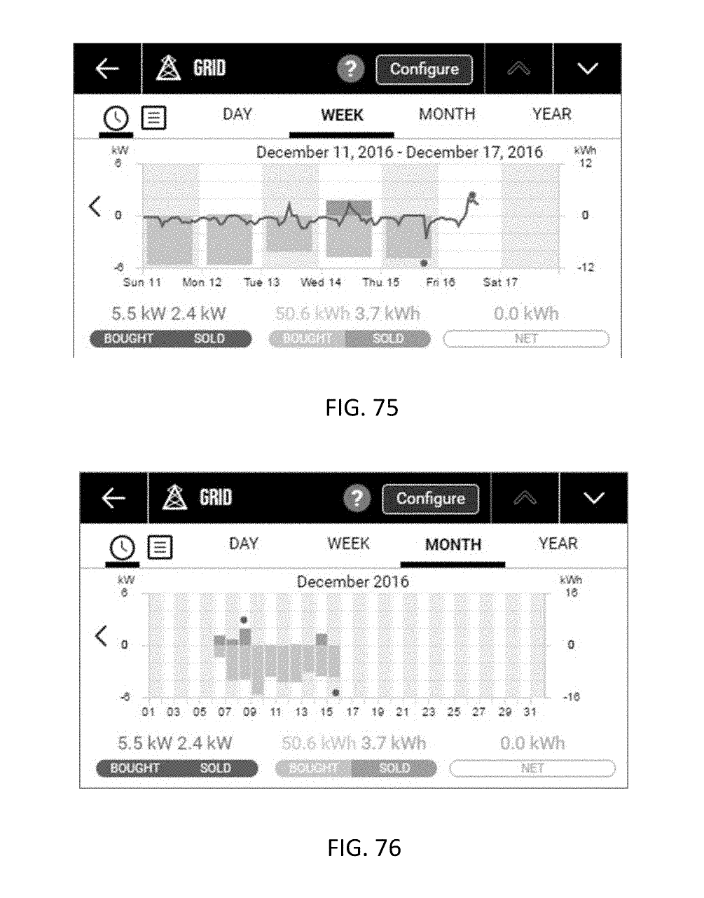

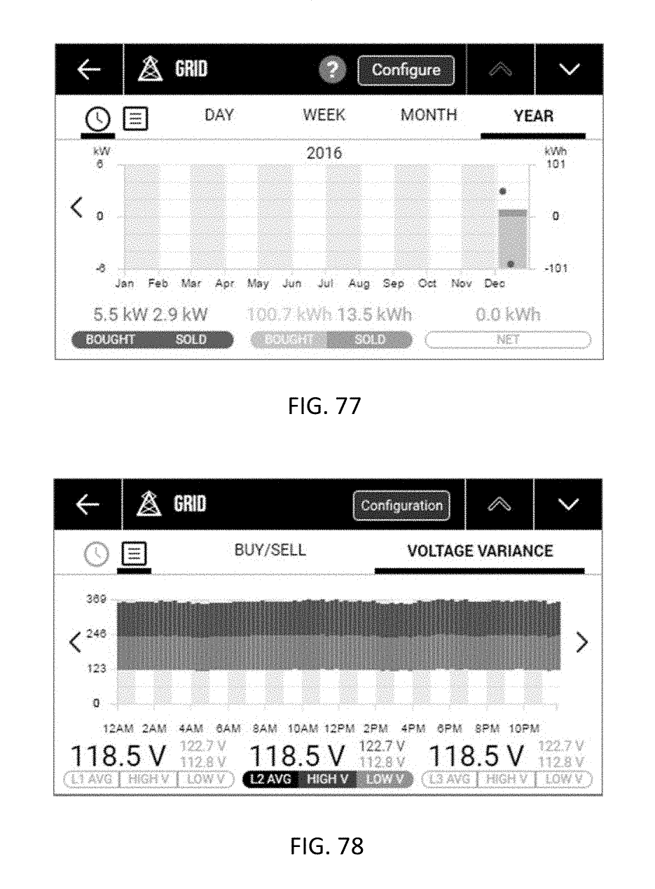

FIGS. 73-79 illustrate example web pages that may be displayed to display status of the grid operatively connected to the power control system 40.

The example web page of FIG. 73 illustrates a chart summarizing grid buy/sell information. The example of web page of FIGS. 74-77 illustrates a buy/sell graph page in Day, Week, Month, and Year modes of display, respectively. The example web page of FIG. 78 illustrates a grid voltage variance graph.

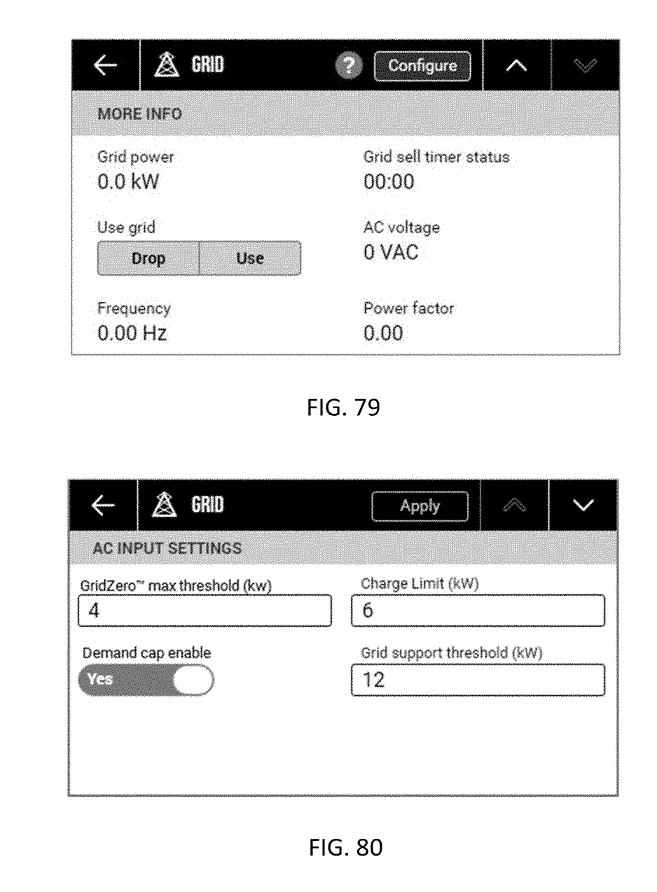

FIG. 79 illustrates a first More Grid Information page that functions as follows:

1. Grid power
Description: Represents the immediate power being drawn from or sold to the grid.
Units: Kilowatts (kW)

2. Grid sell timer status
Description: Reconnect timer, displays time remaining before selling can commence.
Units: MM:ss

3. Use grid
Description: Represents two mutually exclusive actions that can be performed to connect or disconnect the grid.
Input type: toggle
Options:
   Use: When pressed, sends a command to the system controller so that the grid connection is used. The system will connect under appropriate circumstances if possible.
   Drop: When pressed, sends a command to the system controller to not use the grid, opening the grid relay.
Behavior:
   Only one item will be allowed to be active at a time. This behavior will be controlled by SkyMaster.

4. AC Voltage
Description: The immediate AC Voltage reading of the grid connection.
Units: Volts (V)

5. Frequency
Description: The immediate frequency reading of the grid connection.
Units: Hertz (Hz)

6. Power factor
Description: Represents the immediate power factor reading presented to the grid, across all phases
Units: Power factor
Range: 0.80 to 1.00

### 10. Grid Configuration

FIGS. 80-95 illustrate example web pages that may be displayed to allow configuration of the connection of the power control system 40 to the grid. The grid connection configuration process allows the user to select the desired mode of operation when interfacing with the Grid. The example grid connection configuration process allows the user to select among Net Metering with backup, Self-consumption, Non-export, and Maximum independence, with Non export being selected as the default.

FIG. 80 illustrates an example AC Input Settings web page that displays and allows the user to modify general settings related to modifying AC input from the grid. The example AC Input Settings web page operates as follows:

Attribute Label 1: GridZero™ max threshold (kW)
Description: The maximum AC capacity boundary for GridZero™ operation. Loads that exceed this threshold will be supported by the grid. GridZero™ max threshold is used in combination with Minimum reserve (% SOC) to determine self supply portion.
Range: 1.0 to 50.0
Default: 4.0
Units: Kilowatt (kW)
   Attribute Label 2: Charge limit (kW)
Description: This value is used to limit the use of grid power for charging the battery
Numeric Input: numeric value to the tenths
Default Value: 6.0
Range: 0.0-10.0
Units: kW.
Behavior: If set to zero, the power control system will never charge the battery from grid power.
   Attribute Label 3: Demand cap enable
Description: This field captures the result of Wizard question “Demand charges apply to maximum kW peaks”
Button toggle: Yes, No
Default Value: No
Behavior: If the user selects Yes in the Wizard, then demand charge management will be enabled. When enabled, the power control system will use energy from the PV and battery to support loads that exceed the Grid support threshold (kW) value.
   Attribute Label 4: Grid support threshold (kW)
Description: This field is used to limit the demand or draw on the utility source.
Numeric Input: numeric value to the tenths
Default Value: 12.0
Range: 0.0-20.0
Units: kW.
Behavior: When load drawn from the grid, including any battery charging, exceed this value, the power control system will first curtail battery charging in order to not exceed this limit, and if necessary use PV and battery power to reduce the draw on the grid. Loads being served by PV do not count against this value.

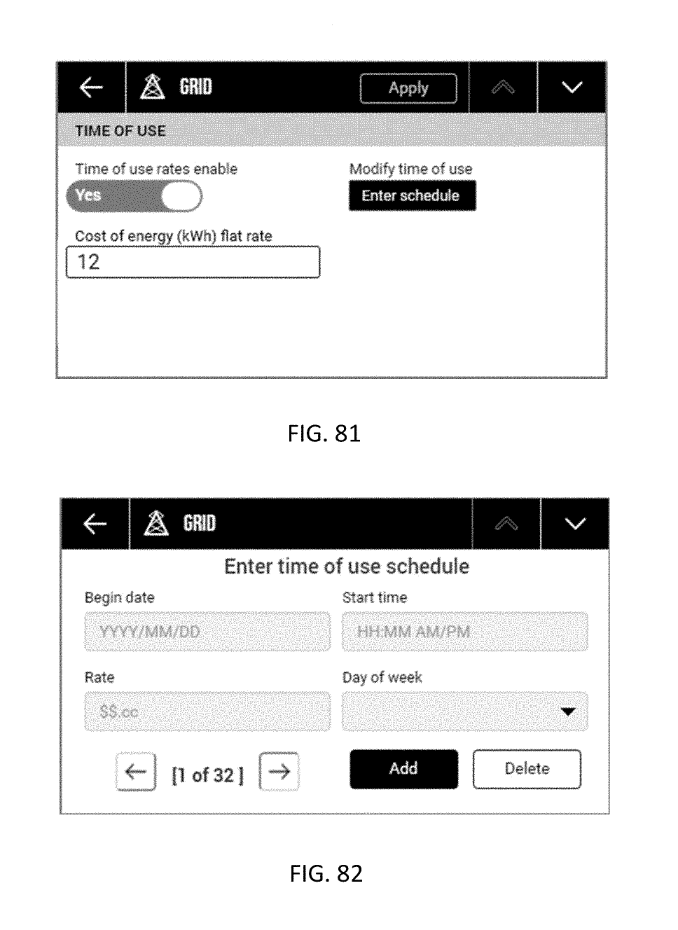

FIG. 81 illustrates an example web page screen that contains settings related to setting specific schedules for grid interaction. The web page depicted in FIG. 81 operates basically as follows:

Attribute Label 1: Time of use rates
Description: This field captures the result of Wizard question “Cost of Energy (kWh) varies throughout the day”
Button toggle: Yes, No
Default Value: No
Behavior: If the user selects Yes in the Wizard, then Time of use will be enabled. Whenever the cost of grid energy exceeds the cost of energy from the battery, the power control system will use the GridZero™ function to displace expensive grid power with the customer's own PV and storage. When the user presses the Modify Time of Use button, display the new Time of Use entry page detailed in the Wizard.
   Attribute label 2: Modify time of use [action button]
Description: Enables or disables time of use scheduling.
Behavior: If Time of use is disabled, the power control system will use the value in Flat rate for any applicable calculations or decisions that need to be made when buying or selling to the grid. If Time of use is enabled the power control system will use the user defined schedule for rate values, with the flat rate as a fallback if no schedule entries are present.
   Attribute label 2: Cost of energy (kWh) flat rate [input field]
Description: Baseline cost of energy to fall back on when no other data is available.
Default: 0.0

FIG. 82 illustrates an example Time of use schedule entry web page screen that allows the user to define the schedule for use of time of use rates. The Time of use screens will be described in more detail below.

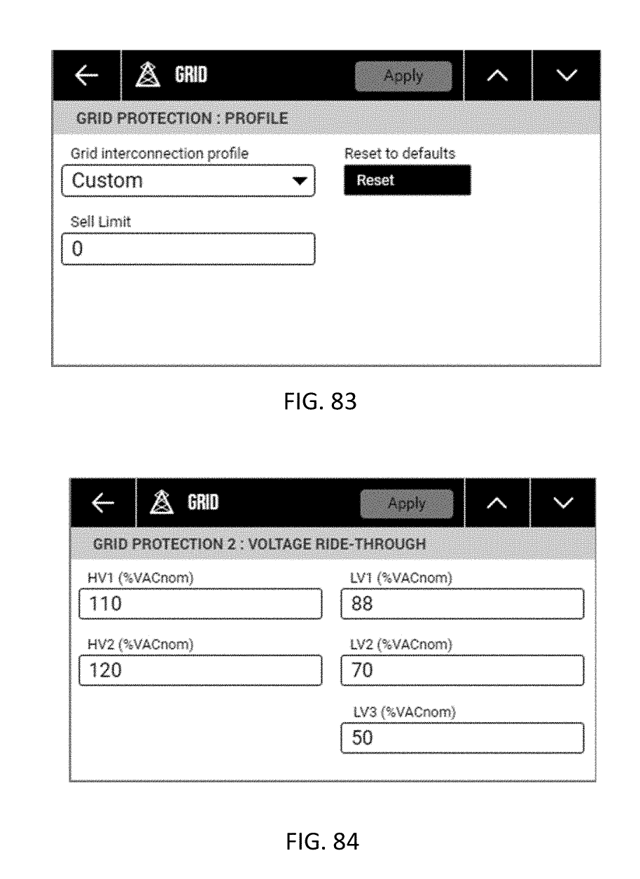

FIG. 83 illustrates an example Grid Protection Profile web page screen that operates basically as follows:

1. Grid interconnection profile
Description: Allows an Installer or Administrator to select which standard the power control system should follow when connecting to the grid.
Behavior: Upon selecting a value for the Grid interconnection profile a dialog box will appear asking, “Change grid interconnect profile? Changes are not saved until “Apply” action is performed”.
   i. “YES”: Set all grid interconnection parameters to their default values based on the selected profile.
   ii. “NO”: Don't change any values. Don't change the value of the Grid interconnect profile setting.
Access level: Installer, Administrator.

2. Reset to defaults
Description: Upon pressing this button a dialog box will appear asking, “Would you like to load default values for the selected profile?”.
   i. “YES”: Set all grid interconnection parameters to their default values based on the selected profile.
   ii. “NO”: Don't change any values.
Access level: Installer, Administrator

3. Sell limit
Description: System will only sell up to indicated amount to the grid. If set to 0, sell limit is ignored.
Units: kW
Range: 0.0-5.0

In the example power control system 40, individual grid protection settings can only be changed by an Administrator

FIGS. 84-93 illustrate example Grid Protection web page screens that allow definition of grid protection parameters for a particular grid connection. The following Table A describes example Grid Modes of Operation.

TABLE A
Grid Mode of Operation

| Mode | Action | Priority | Definition |
|---|---|---|---|
| CONT | Normal Operation | 5 | |
| MANH | Go to charge with Charger current | 2 | Mandatory Operation (high V or f): |
| | limit and Absorb voltage as targets | | The inverter shall accept full rated |
| | | | current from the grid in an attempt |
| | | | to reduce the grid voltage or |
| | | | frequency. |
| MANL | Go to offset with Sell current limit | 2 | Mandatory Operation (low V or f): |
| | and Sell Voltage as targets | | The inverter shall provide full rated |
| | | | current to the grid in an attempt to |
| | | | increase the grid voltage or |
| | | | frequency. |
| PERH | If offsetting, stop offsetting | 4 | Permissive Operation (high V or f): |
| | | | The inverter may continue to accept |
| | | | current from the grid in an attempt |
| | | | to reduce destabilization of the grid. |
| PERL | If charging, stop charging | 4 | Permissive Operation (low V or f): |
| | | | The inverter may continue to provide |
| | | | current to the grid in an attempt to |
| | | | reduce destabilization of the grid. |
| MOMH | If offsetting, reduce to % of max Sell | 3 | Momentary Cessation (high V or f): |
| | current Limit with Sell Voltage as | | The inverter shall continue to provide |
| | limit | | current to the grid but at a reduced |
| | | | value in an attempt to limit the |
| | | | current added to the grid. |
| MOML | If charging, reduce to % of max | 3 | Momentary Cessation (low V or f): |
| | Charger current Limit with Absorb | | The inverter shall continue to accept |
| | voltage as limit | | current from the grid but at a |
| | | | reduced value in an attempt to limit |
| | | | the current taken from the grid. |
| CEAS | Go silent and/or disconnect from | 1 | Cease to Energize: The inverter shall |
| | grid. | | cease to provide, or accept, real and |
| | | | reactive current to the grid. |

### 11. Load Status

FIGS. 94-102 depict example web page screens that may be used to display status of the load connected to the power control system 40. FIG. 94 illustrates a web page screen displaying a web status total chart. FIGS. 95-98 illustrate load status charts for Day, Week, Month, and Year date ranges, respectively.

FIGS. 99 and 100 illustrate an example Load Status screen in L1 and L2 display configurations, respectively. The L2 tab would not display when the power control system 40 is used in a single-phase configuration.

The example web page screen depicted in FIGS. 101 and 102 contain actions that can be performed on the load connection, as well as general status information. The example web page screen depicted in FIG. 100 contains five passive components as follows:

1. Percent of the power control system capacity
Description: Amount of power in use vs what can be supported by the system

2. L1 total load
Description: Instantaneous display of total power in kW going to the load port on leg 1.

3. L1 self supply
Description: Instantaneous display of the portion of load supplied by

PV and battery on leg 1.

4. L2 total load
Description: Instantaneous display of the total power in kW going to the load port on leg 2.
Behavior: This item should not appear on single-phase E models

5. L2 self supply
Description: Instantaneous display of the portion of load supplied by

PV and battery on leg 2.
Behavior: This item should not appear on single-phase E models

The example web page screen depicted in FIG. 102 contains four passive components as follows:

1. L3 total load
Description: Instantaneous display of the total power in kW going to the load port on leg 3.
Behavior: This item should not appear on single-phase E models or on split-phase A models.

2. L3 self supply
Description: Instantaneous display of the portion of load supplied by PV and battery on leg 3.
Behavior: This item should not appear on single-phase E models or on split-phase A models.

3. Today's Self supply
Description: Total self-supply across all 3 legs for today.

4. Lifetime self supply
Description: Total self-supply since first use in mega-watt hours.

### 12. Load Configuration

FIG. 103 depicts an example web page screen that may be used to configure connection of the power control system 40 to the load. In particular, FIG. 103 illustrates an example web page screen that allows a user to set values related to AC load and load management and contains four active components as follows.

1. Enable Off-grid AC load management
I. Description: Controls use of Off-grid AC load management.

2. Load management threshold (% SOC)
I. Description: Defines the threshold where Off-grid AC load management will engage.
   i. Default % SOC shall be 50%
II. Hysteresis shall be 20%

3. Drop 240 v on grid disconnect
I. Description: Yes/No toggle indicating if the power control system should de-energize 240 v loads when the system disconnects from grid.
II. Button toggle: Options: Yes, No
III. Default Value: No
IV. Behavior: If Yes, the power control system will “Fold” the phases by operating L1 and L2 at zero phase angle reference when disconnected from an AC source, thereby shedding any 240 v loads

4. Drop 240 v on low SOC
I. Description: Yes/No toggle indicating if loads should be dropped when battery SOC is low.
II. Button toggle: Options: Yes, No
III. Default Value: No
IV. Behavior: If Yes, the power control system will “Fold” the phases by operating L1 and L2 at zero phase angle reference when the battery is below the Load management threshold (% SOC), thereby shedding any 240 v loads. This function is only possible when the system is disconnected from any AC source.

5. Drop L2 on low SOC
I. Description: True/False toggle for AC load management which de-energizes L2 when the battery SOC is low.
Button toggle: Options: Yes, No
Default Value: No
Behavior: If Yes, the power control system will cease to energize the L2 terminals when the batteries are below the Load management threshold (% SOC), thereby shedding any loads on L2. This function is only possible when operating disconnected from an AC source.

### 13. Battery Status

FIGS. 104-111 illustrate example web page screens that display battery status data to the user.

FIGS. 104-107 depict an example web page screen that displays historical information about kilowatt hour amounts charged or discharged to the battery as well as overall battery health on Day, Week, Month, and Year time frames, respectively. FIG. 108 depicts an example Voltage Graph web page screen that displays voltage associated with the battery in chart form.

FIG. 108 depicts an example web page screen that allows the user to view overall battery information and issue specific battery related charging commands.

FIG. 109 depicts an example Battery Status—Details pg. 1 web page screen that contains six passive components and one active component that function as follows:

1. State of charge
Description: Estimated charge of the battery
Range: 0 to 100%

2. Reset battery SOC %
Description: provides ability to reset battery SOC % in case it has lost sync with the battery actual state of charge.
Behavior: Upon Reset, the battery SOC shall show as a blank field, and the power control system will give operational priority to recharging the battery to full. Upon reaching charged parameters, the value shall show as 100%. Reset function is accessible only by Installer and Administrator which resets the value to zero. A warning popup requiring confirmation should be presented.

3. Charge status
Description: Summary readout describing the power control system charger status.
Range of displayed options:
   1. Charger off
   2. Bulk
   3. Absorb
   4. Float
   5. Float Constant Current
   6. Float Constant Voltage
   7. Equalize
   8. Silent

4. Remaining run time
Description: Estimated remaining run time using only battery power.
Format: dd:hh:mm

5. Battery temperature
Description: The current battery temperature.
Units: C or F depending on user preferences.

6. Battery voltage
Description: The current battery voltage.
Units: Volts (V)

7. Temperature compensation offset
Description: Voltage offset being applied to adjust for temperature difference from 25 C.
Units: Volts (V)

FIG. 110 depicts an example Battery Status—Details pg. 2 web page screen that functions as follows:

1. Initiate charge
a. Description: Initiates a bulk charge of the battery or cancels an ongoing bulk charge of the battery.
b. Toggle:
   i. Start: Start a bulk charge if possible.
   ii. Cancel: Cancel a bulk charge.

2. Initiate equalization
a. Description: Allows a user to start or cancel an equalization charge on the battery if the system determines it can be performed.
b. Toggle:
   i. Start: Start an EQ charge if possible.
   ii. Cancel: Cancel an EQ charge.

3. Cumulative discharge
a. Description: Reading of the cumulative kWh of energy discharged by the battery since the battery was last replaced.
b. Units: kWh

4. Reset cumulative discharge
a. Description: Action button which allows an owner, installer or admin to reset the cumulative discharge value during battery replacement
b. Text: “Reset”
c. Behavior: Popup window requiring confirmation
   ii. Text: “Please confirm you wish to reset the cumulative discharge record”
   iii. Reset function is restricted to minimum of Owner, Installer or Admin level: “YES”/“CANCEL” options

FIG. 111 depicts an example Battery—Historical Performance web page screen that has five active components and five passive components which function as follows:

1. Lifetime MWh discharged
c. Description: The total kWh discharged from the batteries over their lifetime, divided by 1000
d. Units: Megawatt-hours
e. Behavior: Reset function is accessible only by Installer and Administrator which resets the value to zero. A warning popup requiring confirmation should be presented.

2. Days since charged parameters met
a. Description: reading of the number of days since the battery charged parameters were met.
b. Units: Days (DDD)
c. Behavior: Reset function is accessible only by Installer and Administrator which resets the value to zero. A warning popup requiring confirmation should be presented

3. Lowest battery SOC %
a. Description: Reading of the lowest battery state of charge in percent
b. Units: %
c. Behavior: Reset function is accessible only by Installer and Administrator which resets the value to zero. A warning popup requiring confirmation should be presented

4. Lowest battery voltage
a. Description: Reading of the lowest battery voltage recorded over a reasonable interval (specific interval TBD but the intent is to eliminate nuisance readings). Any value less than 5 v shall be discarded.
b. Units: Volts
c. Behavior: Reset function is accessible only by Installer and Administrator which resets the value to zero. A warning popup requiring confirmation should be presented.

5. Highest battery voltage
a. Description: Reading of the highest battery voltage recorded over a time interval TBD.
b. Units: Volts
c. Behavior: Reset function is accessible only by Installer and Administrator which resets the value to zero. A warning popup requiring confirmation should be presented.

### 14. Battery Configuration

FIGS. 112-116 illustrate example web page screens that allow configuration of a battery connected to the power control system 40.

FIGS. 112 and 113 depict example Battery Settings web page screens displaying basic information about the installed battery.

FIG. 112 depicts an example Battery Settings pg. 1 web page screen containing six active components that function as follows:

1. Battery series
a. Description: A dropdown containing common battery series.
b. Behavior: All options will always be available. Picking a particular option filters the list for Battery model.
c. Options:
   i. EnergyCell NC
   ii. EnergyCell NC High Capacity
   iii. EnergyCell RE
   iv. EnergyCell RE High Capacity
   v. EnergyCell GH
   vi. EnergyCell OPzV
   vii. Lithium
   viii. Custom

2. Battery model
a. Description: A dropdown for specific battery model based on series.
b. Options
   i. Series: EnergyCell NC
      1. 200NC
      2. 170NC
      3. 106NC
   ii. Series: EnergyCell NC High Capacity
      1. 2200NC
      2. 2000NC
      3. 1600NC
      4. 1100NC
   iii. Series: EnergyCell RE
      1. 200RE
      2. 170RE
      3. 106RE
   iv. Series: EnergyCell RE High Capacity
      1. 2700RE
      2. 2200RE
      3. 2000RE
      4. 1600RE
      5. 1300RE
      6. 1100RE
      7. 800RE
   v. Series: EnergyCell GH
      1. 2200GH
      2. 200GH
   vi. Series: EnergyCell OPzV
      1. OPzV-3000
      2. OPzV-2000
      3. OPzV-750
      4. OPzV-450
   vii. Series: Lithium
      1. LG RESU
c. Behavior:
   i. The options available will be filtered by the current selection in battery series. E.g. if Battery series EnergyCell NC is selected, the only options available will be 200NC, 170NC, and 106NC.
   ii. If Battery Series ‘Custom’ is selected this option is automatically set to ‘Custom’.
   iii. This choice will determine which battery settings get automatically adjusted. The UI should display a confirmation dialog which asks the user “Would you like to load default values for this battery type?” if the user selects “Yes” the appropriate default values should automatically be set for all applicable variables.
   iv. See Assembla software tickets 500 and 501 for more information behind the implementation.

3. Battery description
a. Description: String representing the user's current battery model.
b. Behavior:
   i. If “Custom” is selected in Battery series the user should be able to enter any string they desire.
   ii. If any other option in Battery series and Battery model number is used this box should automatically populate with the translated information from Battery model number. The box should not be editable.
c. Max Size: 60 characters.

4. Battery total amp-hours (Ah)
a. Description: Amp hour capacity of the attached battery bank
b. Range: 0 to 20000
c. Default: 200 (Varies based on selected Battery Model)
d. Unit: Amp hour (Ah)

5. Battery installation date
a. Description: Date the battery was installed.
b. Format: General date format ‘YYYY-MM” (Or other format based on currently desired user time format.)

6. Battery manufacture date
a. Description: Date the battery was manufactured.
b. Format: General date format ‘YYYY-MM” (Or other format based on currently desired user time format.)

FIG. 113 illustrates an example Battery Settings pg. 2 web page screen that has six active components that function as follows:

1. Charge efficiency factor (%)
a. Description:
b. Range: 80 to 100
c. Default: 95

2. Absorb end (A)
a. Description:
b. Range: Varies based on battery type. Custom and most high capacity batteries=0.0 to 50.0.
c. Default: Varies based on battery type.

3. Max charge (A)
a. Description:
b. Range: Varies based on battery type.
c. Default: Varies based on battery type.

4. Temperature compensation slope (−mv/° C./cell)
a. Description:
b. Default: Varies based on battery type.

5. Battery levelized cost of energy:
a. Description: User input to set the cost of each kWh of energy provided by the battery.
b. Help Tip: (TODO: add representative formula for calculating value. Ken should repeat same formula in the user manual.)
c. Default Value: 0.00
d. Range:
         $$=0-99
   Cc=0-99
e. Units: Determined by Customer regionalization preference. We can worry about this setting after production tasks are complete.
   Typically, Dollars and cents, (or Euros for the E model)
f. Behavior:
   When the value of Rate is greater than the value of the Battery $/kWh (IE, grid power is more expensive than battery power) Skybox shall give preference to self supply (GridZero), powering loads from PV and battery up to the GridZero max threshold (kW) and down to the Minimum reserve (% SOC)
   When the value if Rate is less than or equal the value of the battery $/kWh, Skybox shall give preference to Selling excess PV production.

6. Minimum reserve (% SOC)
a. Description: Estimated charge of the battery to hold in reserve during GridZero™ functions
b. Default: 50%
c. Range: 0 to 100%

The example Battery Charge Settings web page screen depicted in FIG. 114 allows the user to modify battery charging parameters. The example screen depicted in FIG. 114 has six active components that function as follows:

1. Absorb charge
Description: Currently active Absorb charge mode
Options:
   Timed: Absorb charge until Absorb end amps at Absorb Voltage is reached or Max Absorb Time has elapsed.
   Disabled: Do not absorb charge.
      1. If Disabled is selected, Absorb voltage and Absorb time should be greyed out and not selectable

2. Float charge
Description: Currently active Float charge mode.
Options:
   Timed: Float charge until Float Time has elapsed.
   Continuous: Causes the charger to remain in Float continuously so that the Float Time no longer applies. Also skips Silent charging phases.
      1. If Continuous is selected, the Float time should display “24/7”.
         a. Implementation Note: The value currently stored in float time should not be changed! If a user goes back to the ‘Timed’ setting, they should see the previous value that was saved.
      2. Absorb charge phase will be triggered if battery voltage falls below Rebulk voltage, unless Absorb charge is disabled
   Disabled: Do not float charge.
      1. If Disabled is selected, Float voltage and Float time should be greyed out and not selectable

3. Absorb voltage (V)
Description: Absorb target voltage.
Range: Rebulk Voltage to EQ Voltage
Default: 56.5
Unit: Volts (V)

4. Float voltage (V)
Description: Float target voltage.
Range: Refloat Voltage to EQ Voltage
Default: 54.5
Unit: Volts (V)

5. Max absorb time (HH:mm)
Description: Timer counts down from the beginning of the absorption stage until it reaches zero. Resets to maximum amount when the absorption stage ends, or a bulk charge is canceled.
Range: 00:00 to 09:59
Default: 02:00
Format: HH:mm
Behavior:
   Enabled: If Absorb Charge is set to Timed.
   Disabled: If Absorb Charge is set to Disabled.

6. Float time (HH:mm)
Description: Timer controls how long the system float charges. The float timer is reset to its maximum amount whenever the batteries voltage falls below the Re-Float Voltage setting.
Range: 00:00 to 23:59
Default: 02:00
Format: HH:mm
Behavior:
   Enabled: if Float Charge is set to Timed.
   Disabled: if Float Charge is set to Disabled.
   Disabled and displays ‘24/7’: if Float Charge is set to Continuous.

FIG. 115 depicts an example Battery Recharge Settings screen that contains settings for specifying equalization, re-bulk, and re-float voltages. The example screen depicted in FIG. 115 contains four active components that function as follows:

1. Rebulk voltage (V)
Description: An Absorb Charge is triggered if battery voltage falls below this value.
Range: 36.0 to Absorb Voltage
Default: 48.0
Units: Volts (V)

2. Refloat voltage (V)
Description: A Float Charge is triggered if battery voltage falls below this value.
Range: 36.0 to Float Voltage
Default: 50.0
Units: Volts (V)

3. Equalize voltage (V)
Description: Voltage set point to reach instead of Absorption when an equalize charge is performed.
Range: 58.0 to 68.0
Default: 58.8
Units: Volts (V)

4. Minimum equalize time (hh:mm)
Description: Minimum amount of time an equalization charge must be held until the next stage of the charging cycle can take place.
   i. Initiating an Equalization cycle results first in an Absorb charge, which must be completed before the EQ timer begins to count down.
Range: 0:00 to 24:00
Default: 00:00
Format: HH:mm

FIG. 116 illustrates an example Battery Protection web page screen that functions as follows:

1. Low battery cut-out LBCO (V)
Description: LBCO is the point at which the power control system stops drawing power from the battery, in order to prevent further discharge of the battery. Charging will still occur if a source is available.
Range: 36.0 to 68.0
Default: 42.0
Units: Volts (V)

2. LBCO time delay (mm:ss)
Description: The time delay (hysteresis) that the voltage must be below LBCO before taking action.
Default: 01:00

3. High battery cut-out HBCO (V)
Description: the power control system will turn off the BB, DAB or otherwise take action to prevent the battery from continuing to rise.
Range: 36.0 to 68.0
Default: 68.0
Units: Volts (V)

4. HBCO time delay (mm:ss)
Description: The time delay (hysteresis) that the voltage must be above HBCO before taking action.
Default: 00:30

5. Low battery restart (V)
Description: Low battery cut-in voltage
Range: 36.0 to 68.0
Default: 45.6
Units: Volts (V)

6. High battery restart (V)
Description: High battery cut-in voltage
Range: 36.0 to 68.0
Default: 64
Units: Volts (V)

The power control system may be used with an external battery management system, in which case the user interface will allow the user to select which external battery management system they have installed on their unit. The user may be presented with choices of external battery management choices, such as None, LG Resu, Sony ‘X’, or Toshiba ‘X’.

Alternatively, integration with the external battery management system may not be shown as a choice in the user interface. Instead, the connection to an external battery management system may be tied to the Battery model selection dropdown. The default will be “None” if no selection is made by the user or programmatically.

### 15. Generator Status

FIGS. 117-122 illustrate example generator status web page screens that may be displayed to show the status of any generator connected to the power control system 20.

FIGS. 117-120 illustrates an example web page screen showing historical information about kilowatt hour amounts produced by an attached generator. FIGS. 117, 118, 119, and 120, depict a generator production web page screen in Day, Week, Month, and Year modes, respectively. FIG. 121 depicts a Generator Status—Voltage Variance Graph indicating voltage variance of the generator.

The example Generator—More Info web page screen depicted in FIG. 122 lists basic generator information and allows a user to turn the generator on, off, or indicate it should use automatic generator start. The example web page screen depicted in FIG. 122 contains five passive and three active components that function as follows:

1. Generator status
Description: A textual representation of the generators current status.
Options:
   OFF: Generator is powered down and disconnected.
   STARTING: Generator is online and preparing to start.
   WARMUP: Generator is on and going through a warmup cycle.
   EXERCISING: Generator is running due to exercise timer, but the relay is not closed.
   COOLDOWN: Relay open, generator is preparing to shut down.
   CONNECTED: Generator is running and the relay is closed. Power can be drawn from the generator.
   WAITING: Source is within input range but hasn't met connection timer
   OUT OF SPEC: Waiting for the voltage/frequency to reach acceptable levels.

2. AGS Status
Description
Options:
   Disabled: AGS is off.
   Enabled: AGS is on.
   Exercise deferred: AGS exercise is on, but this exercise period was manually stopped. The next exercise period will start normally.
   Quiet time deferred: AGS quiet time is on, but the function was aborted because of critically low battery charge. The next quiet time will occur at its regularly scheduled interval.

3. Manual Control
Description: Action buttons to select one of two mutually exclusive commands for determining how a generator operates.
Options:
   Start: Manual override, command to start the generator
   Stop: Disable the generator and prevent it from starting.
Behavior: If input is not received within 60 seconds after initiating a start command, the Skybox will repeat the start command. If input is not received after the second start command, Skybox will signal a generator start error and cease further start attempts until the Generator Action is cycled to OFF and back to ON.

4. Frequency
Description: The current operating frequency reading of the generator
Units: Hertz (Hz)

5. Last start reason
Description: A textual representation of why the generator was last started.
Options:
   None: No records of the generator running exist.
   Manual: The generator was started manually
      1. Note: this condition can be considered true if either the ON state was selected under Generator action, or if the AC input became active without the power control system intervention.
   Battery Voltage: The generator was started because of low battery voltage.
   SOC: The generator was started because of low battery state of charge.
   Load: The generator was started because load exceeded a certain threshold.
   Exercise: The generator was started as a scheduled event

6. Total runtime
Description: The total cumulative run-time the generator has been active.
Format: Hours (hhhh)
Behavior: Can be reset with the Reset Generator Runtime action.
Implementation note: Data is saved in minutes but converted to hours and rounded down by the UI for display.

7. Reset generator runtime
Description: A button that resets total generator runtime.
Text: “Reset”
Behavior: A Yes/No screen shall be presented to prevent inadvertent clearing of the runtime value.
   i. Text: “Do you want to reset the generator runtime to 0 hours?”
   ii. If “Yes” is selected. Total runtime is set to zero.
   iii. Reset function is available to Owner, Installer or Admin level

### 16. Generator Configuration

FIGS. 123-129 depict web page screens that allow the user to set and change Generator Settings defining general operational limits for an attached generator.

FIG. 123 depicts an example of a Generator Settings Screen 1 web page screen that has six active components that function as follows:

1. Generator max input current limit (A)
Description: Maximum current limit of the attached generator (A)—the power control system will limit current draw to this value
Range: 15.0 to 60.0
Default: 60.0
Units: Amperes (A)

2. High voltage limit L-N (V)
Description: Generator voltage high limit to trigger a disconnect from the generator.
Range: 85.0 to 140.0
Default: 130.0
Units: Volts (V)

3. Low voltage limit L-N (V)
Description: Generator voltage low limit to trigger a disconnect from the generator.
Range: 85.0 to 140.0
Default: 105.0.0
Units: Volts (V)

4. High frequency limit (Hz)
Description: Generator frequency high limit to trigger a disconnect from the generator.
Range: 55 to 65
Default: 63
Units: Volts (V)

5. Low frequency limit (Hz)
Description: Generator frequency low limit to trigger a disconnect from the generator.
Range: 55 to 65
Default: 57
Units: Volts (V)

FIG. 124 depicts an example of a Generator Settings Screen 2 web page screen that has six active components that function as follows:

1. Generator type
Description: Instructs the power control system whether to expect generator input to be received on the AC input, or via a DC input.
Options:
   AC: Alternating current generator
   DC: Direct current generator
Default: AC

2. Generator output rating (kVA)
Description: The generator capacity rating
Range: 0-100
Default: 5
Units: kilo-volt-ampere (kVa)

3. Connect delay (mm:ss)
Description: Time the AC input voltage and frequency must be within limits before the inverter connects.
Range: 00:05 to 25:00
Default: 00:30
Units: Minutes & Seconds (mm:ss)

4. Disconnect delay (s)
Description: Time the AC input voltage or frequency may exceed limits before the inverter disconnects.
Range: 0.12 to 4.00 seconds
Default: 1.0 seconds
Units: Seconds (ss.ss)

5. Warmup time (mm:ss)
Description: Time the generator should run unloaded in order to warm up before the power control system connects.
Range: 00:00 to 30:00
Default: 00:00
Units: Minutes & Seconds (mm:ss)

6. Cooldown time (mm:ss)
Description: After Skybox disconnects, the time the generator should run unloaded in order to cool down
Range: 00:00 to 30:00
Default: 05:00
Units: Minutes & Seconds (mm:ss)

FIG. 125 depicts an example of an Advanced Generator Start web page screen that allows the user to change features that control AGS system. The example Advanced Generator Start web page screen has six active items that function as follows:

1. Enable AGS
Description: Instructs the power control system whether to enable Advanced Generator Start settings
   If Yes, then let the user enter data. If No, disable corresponding AGS input fields.
Options:
   Yes: Enable AGS settings
   No: Disable AGS settings
Default: Yes (We decided to auto-populate all AGS options in Wiz)

2. SOC level to start (%)
Description: Generator is started once the battery reaches this state of charge, when necessary to support loads or charge batteries.
Range: 0 to 80
Default: 50%
Units: Percent (%)

3. SOC level to stop (%)
Description: Generator is stopped once the battery reaches this state of charge.
Range: 0 to 100
Default: 80%
Units: Percent (%)

4. 24 hour battery voltage start level (V)
Description: A twenty-four-hour timer begins counting down once battery voltage drops below the level set here. When the timer reaches zero the unit attempts to start the generator. Quiet time will defer a 24-hour start.
Range: 36.0 to 68.0
Default: 48.8
Units: Volts (V)

5. 2 hour battery voltage start level (V)
Description: A two-hour timer begins counting down once voltage drops below the level set here. When the timer reaches zero the unit attempts to start the generator. Quiet time will defer a two-hour start.
Range: 36.0 to 68.0
Default: 47.2
Units: Volts (V)

6. 2 minute battery voltage start level (V)
Description: A two-minute timer begins counting down once voltage drops below the level set here. When the timer reaches zero the unit attempts to start the generator.
Range: 36.0 to 68.0
Default: 44
Units: Volts (V)
Behavior:
   Overrides Quiet Time: This 2-minute timer is considered an emergency start set point and will ignore any quiet time settings.

FIG. 126 depicts an example of an Advanced Generator Start: Load web page screen that has five active items that function as follows:
1. Enable AGS start on load
   Description: Instructs the power control system whether to enable AGS start based on load conditions
If ‘Yes’, then let the user enter data or else disable corresponding AGS load input fields.
   Options:
      i. Yes: Enable AGS start on load settings
      ii. No: Disable AGS start on load settings
   Default: Yes
2. Load start (kW)
   Description: Will start a generator whenever the total system AC load kilowatts exceeds the start set point and the duration in Load start delay has elapsed.
   Range: 1 to 50
   Default: 5
   Units: Kilowatts (kW)
3. Load start delay
   Description: the load must be above Load start threshold for this duration before the generator will start.
   Range: 1 to 90 minutes
   Default: 5
   Units: Minutes (mm)
4. Load stop (kW)
   Description: Will stop the generator whenever the total system AC load wattage falls below this set point.
   Range: 0 to 50
   Default: 5
   Units: Kilowatts (kW)
5. Load stop delay
   Description: the load must be below Load stop threshold for this duration
   Range: 1 to 90 minutes
   Default: 1
   Units: Minutes (mm)

FIG. 127 depicts an example of an Advanced Generator Start: Quite Time web page screen that has five active items that function as follows:
1. Enable AGS quiet time
   Description: Instructs the power control system whether to enable AGS quiet time
If ‘Yes’, then let the user enter data or else disable corresponding AGS quiet time input fields.
   Options:
      i. Yes: Enable AGS quiet time settings
      ii. No: Disable AGS quiet time settings
   Default: No
2. Weekday quiet time begin (hh:mm)
   Description: Quiet time is a period when the generator should not run due to noise or other reasons. Weekday quiet time begin is the time of day that the Quiet time starts on weekdays.
   Range: 00:00 to 23:59
   Default: 00:00
   Units: Time (Expressed according to user local time preferences for 12 or 24-hour time)
3. Weekday quiet time end (hh:mm)
   Description: the time that Weekday quiet time ends.
   Range: 00:00 to 23:59
   Default: 00:00
   Units: Time (Expressed according to user local time preferences for 12 or 24-hour time)
4. Weekend quiet time begin (hh:mm)
   Description: Quiet time is a period when the generator should not run due to noise or other reasons. Weekend quiet time begin is the time of day that the Quiet time starts on weekends.
   Range: 00:00 to 23:59
   Default: 00:00
   Units: Time (Expressed according to user local time preferences for 12 or 24-hour time)
5. Weekend quiet time end (hh:mm)
   Description: the time that Weekend quiet time ends.
   Range: 00:00 to 23:59
   Default: 00:00
   Units: Time (Expressed according to user local time preferences for 12 or 24-hour time)

FIGS. 128 and 129 depicts an example of an Advanced Generator Start: Exercise web page screen that operates in a Monthly or Weekly display configuration. The example of an Advanced Generator Start: Exercise web page screen contains five active items that function as follows:
1. Enable AGS exercise
   Description: Instructs the power control system whether to enable AGS exercise. Runs the generator on a regular schedule to keep engine components lubricated and ensure nominal operation. Consult the generator owner's manual for the appropriate length and frequency of exercise periods and what load to run during the exercise period.
If Yes, then let the user enters data or else disable corresponding AGS exercise input fields.
   Options:
      i. Yes: Enable AGS exercise settings
      ii. No: Disable AGS exercise settings
   Default: Yes
2. Exercise interval
   Description: Dropdown selection for the amount of time that will elapse between generator exercise cycles.
   Range:
      i. Daily
      ii. Weekly
      iii. Monthly
   Default: Monthly
3. Exercise day of week (or Day of month)
   Description:
      i. If Exercise interval is set to weekly, this is a dropdown selection for a specific day of the week that the generator will start.
      ii. If Exercise interval is set to monthly, this is an input box for the day of the month when the generator will start.
   Range (day of the week):
      i. Sunday
      ii. Monday
      iii. Tuesday
      iv. Wednesday
      v. Thursday
      vi. Friday
      vii. Saturday
   Range (day of the month): 1 to 31.
4. Generator exercise start (hh:mm)
   Description: The hour and minute when the generator should start the exercise cycle.
   Range: 00:00 to 23:59
   Default: 12:00
   Units: Hours & Minutes (hh:mm) expressed according to user local time preferences for 12 hour or 24-hour clock
5. Exercise duration
   Description: Dropdown selection for the run period duration.
   Range:
      i. 10 minutes
      ii. 15 minutes
      iii. 20 minutes
   Default: 15 minutes

What is claimed is:

1. A power supply system operatively connected to a grid, a load, and at least one auxiliary power node, the power supply system comprising:
at least one power control system comprising:
a device controller;
a power integration system operatively connected to the at least one auxiliary power node;
a power management board; and
a user interface device operatively connected to the device controller; whereby
the device controller is configured to run software that displays a user interface on the user interface device that allows
entry of configuration data associated with at least one of the grid, the load, and the at least one auxiliary power node;
access to status data associated with at least one of the grid, the load, and the at least on auxiliary power node; and
the device controller controls operation of the power integration system and power management board using the configuration data.

2. A power supply system as recited in claim 1, in which:
the power supply system comprises a plurality of power control systems;
one of the power control systems is a master power control system;
at least one of the power control systems is a slave power control system; and
the master power control system stores configuration data associated with the at least one slave power control system.

3. A power supply system as recited in claim 2, in which the software running on the device controllers causes the user interface devices to control the user interface devices to operate in:
at least one configuration mode in which the software of a given device controller causes the user interface device associated with that given device controller to allow the given device controller to be identified as forming part of the master power control system; and
at least one status mode in which the software of the given device controller causes the user interface device associated with that given device controller to display status information.

4. A power supply system as recited in claim 1, in which:
the power supply system comprises a plurality of power control systems; and
the software running on the device controllers causes the user interface devices of the device controllers to operate in:
a local status mode in which the software of a given device controller causes the user interface device associated with that given device controller to display status information associated with the power control system comprising the given device controller; and
a system status mode in which the software of the given device controller causes the user interface device associated with that given device controller to display status information associated with the plurality of power control systems.

5. A power supply system as recited in claim 1, in which:
the power integration system of the at least one power control system is operatively connected to a plurality of auxiliary power nodes; and
the software running on the device controllers causes the user interface devices to control the user interface devices to display
information identifying each of the plurality of auxiliary power nodes, and
auxiliary power node status information indicative of a status of each of each of the plurality of auxiliary power nodes.

6. A power supply system as recited in claim 5, in which the auxiliary power node status information is represented by at least one of color, alpha-numeric characters, graphics, and icons.

7. A power supply system as recited in claim 1, in which each power control system comprises a communications system comprising a cable assembly that allows communication of:
a first set of data among power control systems, where the first set of data is non-time critical; and
a second set of data among power control systems, where the second set of data is time critical.

8. A power supply system as recited in claim 7, in which the cable assembly is configured to allow communication of the first set of data to a remote status monitoring and control system.

9. A method of operatively connecting a grid, a load, and at least one auxiliary power node, the method comprising the steps of:
providing at least one power control system comprising a device controller, a power integration system, a power management board, and a user interface device;
operatively connecting the power integration system to the at least one auxiliary power node;
operatively connecting the user interface device to the device controller;
configuring the device controller to run software that causes the user interface device to display a user interface that allows
entry of configuration data associated with at least one of the grid, the load, and the at least one auxiliary power node, and
access to status data associated with at least one of the grid, the load, and the at least on auxiliary power node; and
causing the device controller to control operation of the power integration system and power management board using the configuration data.

10. A method as recited in claim 9, in which the step of providing at least one power control system comprises the steps of providing a plurality of power control systems, the method further comprising the steps of:
identifying one of the plurality of power control systems as a master power control system;
identifying at least one of the plurality of power control systems as a slave power control system; and
storing configuration data associated with the at least one slave power control system in the master power control system.

11. A method as recited in claim 10, in which the software running on the device controllers causes the user interface devices to control the user interface devices to operate in:
at least one configuration mode in which the software of a given device controller causes the user interface device associated with that given device controller to allow the given device controller to be identified as forming part of the master power control system; and
at least one status mode in which the software of the given device controller causes the user interface device associated with that given device controller to display status information.

12. A method as recited in claim 9, in which:
the step of providing at least one power control system comprises the steps of providing a plurality of power control systems; and
the software running on the device controllers causes the user interface devices of the device controllers to operate in:
a local status mode in which the software of a given device controller causes the user interface device associated with that given device controller to display status information associated with the power control system comprising the given device controller, and
a system status mode in which the software of the given device controller causes the user interface device associated with that given device controller to display status information associated with the plurality of power control systems.

13. A method as recited in claim 9, in which:
the step of operatively connecting the power integration system to the at least one auxiliary power node comprises the step of operatively connecting the power integration system of the at least one power control system to a plurality of auxiliary power nodes; and
the software running on the device controllers causes the user interface devices to control the user interface devices to display
information identifying each of the plurality of auxiliary power nodes, and
auxiliary power node status information indicative of a status of each of each of the plurality of auxiliary power nodes.

14. A method as recited in claim 13, in which the step of displaying the auxiliary power nodes status information comprise the step of representing the auxiliary power node status information by at least one of color, alpha-numeric characters, graphics, and icons.

15. A method as recited in claim 9, in which the step of providing the at least one power control system comprises the step of providing a communications system comprising a cable assembly that allows communication of first and second sets of data, the method further comprising the steps of:
configuring the cable assembly such that the first set of data communicates non-time critical data; and
configuring the cable assembly such that the second set of data communicates time critical data.

16. A method as recited in claim 15, further comprising the step of configuring the cable assembly to allow communication of the first set of data to a remote status monitoring and control system.

17. A power supply system operatively connected to a grid, a load, and at least one auxiliary power node, the power supply system comprising:
a plurality of power control systems each comprising:
a device controller,
a power integration system operatively connected to the at least one auxiliary power node,
a power management board, and
a user interface device operatively connected to the device controller; wherein
the device controllers are configured to run software that displays a user interface on the user interface device operatively connected thereto that allows
entry of configuration data associated with at least one of the grid, the load, and the at least one auxiliary power node for each of the plurality of power control systems,
identification of one of the power control systems as a master power control system,
identification of at least one of the power control systems as a slave power control system,
storage in the master power control system configuration data associated with the at least one slave power control system, and
access to status data associated with at least one of the grid, the load, and the at least on auxiliary power node; and
the device controllers of the plurality of power control systems control operation of the power integration system and power management board using the configuration data.

18. A power supply system as recited in claim 17, in which the software running on the device controllers causes the user interface devices to control the user interface devices to operate in:
at least one configuration mode in which the software of a given device controller causes the user interface device associated with that given device controller to allow the given device controller to be identified as forming part of the master power control system; and
at least one status mode in which the software of the given device controller causes the user interface device associated with that given device controller to display status information.

19. A power supply system as recited in claim 17, in which:
at least one of the power integration systems is operatively connected to a plurality of auxiliary power nodes; and
the software running on the device controllers causes the user interface devices to control the user interface devices to display
information identifying each of the plurality of auxiliary power nodes, and
auxiliary power node status information indicative of a status of each of each of the plurality of auxiliary power nodes.

20. A power supply system as recited in claim 17, in which each power control system comprises a communications system comprising a cable assembly that allows communication of:
a first set of data among the plurality of power control systems, where the first set of data is non-time critical; and
a second set of data among the plurality of power control systems, where the second set of data is time critical.

21. A power supply system as recited in claim 20, in which the cable assembly is configured to allow communication of the first set of data to a remote status monitoring and control system.
